(19) United States
(12) Patent Application Publication
(10) Pub. No.: US 2012/0014722 A1
(43) Pub. Date: Jan. 19, 2012

(54) DEVELOPER SUPPLY CONTAINER AND DEVELOPER SUPPLYING SYSTEM

(75) Inventors: Ayatomo Okino, Moriya-shi (JP); Toshiaki Nagashima, Moriya-shi (JP); Katsuya Murakami, Toride-shi (JP); Fumio Tazawa, Kashiwa-shi (JP); Yusuke Yamada, Toride-shi (JP)

(73) Assignee: CANON KABUSHIKI KAISHA, Tokyo (JP)

(21) Appl. No.: 13/246,293

(22) Filed: Sep. 27, 2011

Related U.S. Application Data
(63) Continuation of application No. PCT/JP2010/056134, filed on Mar. 30, 2010.

(30) Foreign Application Priority Data
Mar. 30, 2009 (JP) 2009-082077

(51) Int. Cl. G03G 15/08

(52) U.S. Cl. 399/262

(57) ABSTRACT

Conventionally, the developer in the developer supply container is discharged by an air-supply pump and a suction pump which are provided in the main assembly side of the image forming apparatus, and therefore, the developer is compacted by the increase of the internal pressure of the developer supply container resulting from the air-supply. Therefore, the proper suction of the developer from the developer supply container becomes difficult with the result of shortage of the developer amount to be supplied.

A bellow-like pump is provided on the side of the developer supply container, and the pump alternately repeats the suction operation and the discharging operation through the discharge opening by a driving force inputted from the image forming apparatus side. By this, the developer can be sufficiently loosened, thus properly discharging the developer.

### FIELD OF THE INVENTION

The present invention relates to a developer supply container detachably mountable to a developer replenishing apparatus and to a developer supplying system including them. The developer supply container and the developer supplying system are used with an image forming apparatus such as a copying machine, a facsimile machine, a printer or a complex machine having functions of a plurality of such machines.

### BACKGROUND ART

Conventionally, an image forming apparatus of an electrophotographic type such as an electrophotographic copying machine uses a developer of fine particles. In such an image forming apparatus, the developer is supplied from the developer supply container in response to consumption thereof resulting from image forming operation.

As for the conventional developer supply container, an example is disclosed in Japanese Laid-Open Utility Model Application Sho 63-6464.

In the apparatus disclosed in Japanese Laid-Open Utility Model Application Sho 63-6464, the developer is let fall all together into the image forming apparatus from the developer supply container. More particularly, in the apparatus disclosed in Japanese Laid-Open Utility Model Application Sho 63-6464, a part of the developer supply container is formed into a bellow-like portion so as to permit all of the developer can be supplied into the image forming apparatus from the developer supply container even when the developer in the developer supply container is caked. More particularly, in order to discharge the developer caked in the developer supply container into the image forming apparatus side, the user pushes the developer supply container several times to expand and contract (reciprocation) the bellow-like portion.

Thus, with the apparatus disclosed in Japanese Laid-Open Utility Model Application Sho 63-6464, the user has to manually operate the bellow-like portion of the developer supply container.

On the other hand, Japanese Laid-open Patent Application 2002-72649 employs a system in which the developer is automatically sucked from the developer supply container into the image forming apparatus using a pump. More particularly, a suction pump and an air-supply pump are provided in the main assembly side of the image forming apparatus, and nozzles having a suction opening and an air-supply opening, respectively are connected with the pumps and are inserted into the developer supply container (Japanese Laid-open Patent Application 2002-72649, FIG. 5). Through the nozzles inserted into the developer supply container, an air-supply operation into the developer supply container and a suction operation from the developer supply container are alternately carried out. Japanese Laid-open Patent Application 2002-72649 states that when the air fed into the developer supply container by the air-supply pump passes through the developer layer in the developer supply container, the developer is fluidized.

Thus, in the device disclosed in Japanese Laid-open Patent Application 2002-72649, the developer is automatically discharged, and therefore, the load in operation imparted to the user is reduced, but the following problems may arise.

More particularly, in the device disclosed in Japanese Laid-open Patent Application 2002-72649, the air is fed into the developer supply container by the air-supply pump, and therefore, the pressure (internal pressure) in the developer supply container rises.

With such a structure, even if the developer is temporarily scattered when the air fed into the developer supply container passes through the developer layer, the developer layer results in being packed again by the rise of the internal pressure of the developer supply container by the air-supply.

Therefore, the flowability of the developer in the developer supply container decreases, and in the subsequent suction step, the developer is not easily discharged from the developer supply container, with the result of shortage of the developer amount supplied.

### DISCLOSURE OF THE INVENTION

Accordingly, it is an object of the present invention to provide a developer supply container and a developer supplying system in which an internal pressure of a developer supply container is made negative, so that the developer in the developer supply container is appropriately loosened.

It is another object of the present invention to provide a developer supply container and a developer supplying system in which the developer in a developer supply container can be loosened properly by a suction operation through a discharge opening of the developer supply container by a pump portion

It is a further object of the present invention to provide a developer supply container and a developer supplying system in which a air flow generating mechanism alternately and repeatedly producing a inward air flow through a pin hole and an outward air flow by which the developer in the developer supply container can be properly loosened

According to an aspect of the present invention (first invention), there is provided a developer supply container detachably mountable to a developer replenishing apparatus, said developer supply container comprising a developer accommodating portion for accommodating a developer; a discharge opening for permitting discharging of the developer from said developer accommodating portion; a drive inputting portion for receiving a driving force from said developer replenishing apparatus; and a pump portion capable of being driven by the driving force received by said drive inputting portion to alternating an internal pressure of said developer accommodating portion between a pressure lower than an ambient pressure and a pressure higher than the ambient pressure.

According to another aspect of the present invention (second invention), there is provided a developer supplying system comprising a developer replenishing apparatus, a developer supply container detachably mountable to said developer replenishing apparatus, said developer supplying system comprising said developer replenishing apparatus including a mounting portion for demountably mounting said developer supply container, a developer receiving portion for receiving the developer from said developer supply container, a driver for applying a driving force to said developer supply container; said developer supply container including a developer accommodating portion accommodating developer, a discharge opening for permitting discharging of the developer from said developer accommodating portion toward said developer receiving portion, a drive inputting portion, engageable with said driver, for receiving the driving force, a pump portion for alternately changing an internal pressure of said developer accommodating portion between a pressure higher than an ambient pressure and a pressure lower than the ambient pressure.

According to a further aspect of the present invention (third invention), there is provided a developer supply container detachably mountable to a developer replenishing apparatus, said developer supply container comprising a developer accommodating portion for accommodating a developer; a discharge opening for permitting discharging of the developer from said developer accommodating portion; a drive inputting portion for receiving a driving force from said developer replenishing apparatus; and a pump portion capable of being driven by the driving force received by said drive inputting portion to alternately repeat suction and delivery actions through said discharge opening.

According to a further aspect of the present invention (fourth invention), there is provided a developer supplying system comprising a developer replenishing apparatus, a developer supply container detachably mountable to said developer replenishing apparatus, said developer supplying system comprising said developer replenishing apparatus including a mounting portion for demountably mounting said developer supply container, a developer receiving portion for receiving a developer from said developer supply container, a driver for applying a driving force to said developer supply container; said developer supply container including a developer accommodating portion for accommodating the developer, a discharge opening for permitting discharging of the developer from said developer accommodating portion toward said developer receiving portion, a drive inputting portion for receiving the driving force, a pump portion for alternately repeating suction and delivery actions through said discharge opening.

According to a further aspect of the present invention (fifth invention), there is provided a developer supply container detachably mountable to a developer replenishing apparatus, said developer supply container comprising a developer accommodating portion for accommodating a developer having a fluidity energy of not less than 4.3×10⁻⁴ kg·cm²/s² and not more than 4.14×10⁻³ kg·cm²/s²; a pin hole for permitting discharge of the developer out of said developer accommodating portion, said discharge opening having an area not more than 12.6 mm²; a drive inputting portion for receiving a driving force from said developer replenishing apparatus; an air flow generating mechanism for generating repeated and alternating inward and outward air flow through the pin hole.

According to a further aspect of the present invention (sixth invention), there is provided a developer supplying system comprising a developer replenishing apparatus, a developer supply container detachably mountable to said developer replenishing apparatus, said developer supplying system comprising said developer replenishing apparatus including a mounting portion for demountably mounting said developer supply container, a developer receiving portion for receiving a developer from said developer supply container, a driver for applying a driving force to said developer supply container; said developer supply container including a developer accommodating portion for accommodating the developer having a fluidity energy of not less than 4.3×10⁻⁴ kg·cm²/s² and not more than 4.14×10⁻³ kg·cm²/s²; a pin hole for permitting discharge of the developer out of said developer accommodating portion, said discharge opening having an area not more than 12.6 mm²; a drive inputting portion for receiving a driving force from said developer replenishing apparatus; an air flow generating mechanism for generating repeated and alternating inward and outward air flow through the pin hole.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of an example of an image forming apparatus.

FIG. 2 is a perspective view of the image forming apparatus.

FIG. 3 is a perspective view of a developer replenishing apparatus according to an embodiment of the present invention.

FIG. 4 is a perspective view of the developer replenishing apparatus of FIG. 3 as seen in a different direction.

FIG. 5 is a sectional view of the developer replenishing apparatus of FIG. 3.

FIG. 6 is a block diagram illustrating a function and a structure of a control device.

FIG. 7 is a flow chart illustrating a flow of a supplying operation.

FIG. 8 is a sectional view illustrating a developer replenishing apparatus without a hopper and a mounting state of the developer supply container.

FIG. 9 is a perspective view illustrating a developer supply container according to an embodiment of the present invention

FIG. 10 is a sectional view illustrating a developer supply container according to an embodiment of the present invention.

FIG. 11 is a sectional view illustrating the developer supply container in which a discharge opening and an inclined surface are connected with each other.

Part (a) of FIG. 12 is a perspective view of a blade used in a device for measuring flowability energy, and (b) is a schematic view of a measuring device.

FIG. 13 is a graph showing a relation between a diameter of the discharge opening and a discharge amount.

FIG. 14 is a graph showing a relation between an amount filled in the container and a discharge amount.

FIG. 15 is a perspective view illustrating parts of operation states of the developer supply container and the developer replenishing apparatus.

FIG. 16 is a perspective view illustrating the developer supply container and the developer replenishing apparatus.

FIG. 17 is a sectional view illustrating the developer supply container and the developer replenishing apparatus.

FIG. 18 is a sectional view illustrating the developer supply container and the developer replenishing apparatus.

FIG. 19 illustrates a change of an internal pressure of the developer accommodating portion in the apparatus and the system of the present invention.

Part (a) of FIG. 20 is a block diagram illustrating a developer supplying system (Embodiment 1) using in the verification experiment, and (b) is a schematic view illustrating phenomenon-in the developer supply container.

Part (a) of FIG. 21 is a block diagram illustrating a developer supplying system the comparison example) used in the verification experiment, and (b) is a schematic view illustrating phenomenon-in the developer supply container.

FIG. 22 is a perspective view illustrating a developer supply container according to Embodiment 2.

FIG. 23 is a sectional view of the developer supply container of FIG. 22.

FIG. 24 is a perspective view illustrating a developer supply container according to Embodiment 3.

FIG. 25 is a perspective view illustrating a developer supply container according to Embodiment 3.

FIG. 26 is a perspective view illustrating a developer supply container according to Embodiment 3.

FIG. 27 is a perspective view illustrating a developer supply container according to Embodiment 4.

FIG. 28 is a sectional perspective view showing a developer supply container.

FIG. 29 is a partially sectional view illustrating a developer supply container according to Embodiment 4

FIG. 30 is a sectional view illustrating another embodiment.

Part (a) of the FIG. 31 is a front view of a mounting portion the (b) is a partial enlarged perspective view of an inside of the mounting portion.

Part (a) of FIG. 32 is a perspective view illustrating a developer supply container according to Embodiment 1, (b) is a perspective view illustrating a state around a discharge opening, (c) and (d) are a front view and a sectional view illustrating a state in which the developer supply container is mounted to the mounting portion of the developer replenishing apparatus.

Part (a) of FIG. 33 is a perspective view of a developer accommodating portion, (b) is a perspective sectional view of the developer supply container, (c) the sectional view of an inner surface of a flange portion, and (d) is a sectional view of the developer supply container.

Part (a) and part (b) of FIG. 34 are sectional views showing of suction and discharging operations of a pump portion of the developer supply container according to the developer supply container according to Embodiment 5.

FIG. 35 is an extended elevation illustrating a cam groove configuration of the developer supply container.

FIG. 36 is an extended elevation of an example of the cam groove configuration of the developer supply container.

FIG. 37 is an extended elevation of an example of the cam groove configuration of the developer supply container.

FIG. 38 is an extended elevation of an example of the cam groove configuration of the developer supply container.

FIG. 39 is an extended elevation of an example of the cam groove configuration of the developer supply container.

FIG. 40 is an extended elevation of an example of the cam groove configuration of the developer supply container.

FIG. 41 is an extended elevation illustrating an example of a cam groove configuration of the developer supply container.

FIG. 42 is a graph showing a change of an internal pressure of the developer supply container.

Part (a) of FIG. 43 is a perspective view showing a structure of a developer supply container according to Embodiment 6, and (b) is a sectional view showing a structure of the developer supply container.

FIG. 44 is a sectional view showing a structure of a developer supply container according to Embodiment 7.

Part (a) of FIG. 45 is a perspective view illustrating a structure of a developer supply container according to Embodiment 8, (b) is a sectional view of the developer supply container, (c) is a perspective view illustrating a cam gear, and (d) is an enlarged view of a rotational engaging portion of the cam gear.

Part (a) of FIG. 46 is a perspective view showing a structure of a developer supply container according to Embodiment 9, and (b) is a sectional view showing a structure of the developer supply container.

Part (a) of FIG. 47 is a perspective view showing a structure of a developer supply container according to Embodiment 10, and (b) is a sectional view showing a structure of the developer supply container.

Parts (a)-(d) of FIG. 48 illustrate an operation of a drive converting mechanism.

Part (a) of FIG. 49 illustrates a perspective view illustrating a structure of a according to Embodiment 11, (b) and (c) illustrate an operation of a drive converting mechanism.

Part (a) of FIG. 50 is a sectional perspective view illustrating a structure of a developer supply container according to Embodiment 12, (b) and (c) are sectional views illustrating suction and discharging operations of a pump portion.

Part (a) of FIG. 51 is a perspective view illustrating another example of a developer supply container according to Embodiment 12, and (b) illustrates a coupling portion of the developer supply container.

Part (a) of FIG. 52 is a sectional perspective view illustrating a developer supply container according to Embodiment 13, and (b) and (c) are sectional views illustrating suction and discharging operations of a pump portion.

Part (a) of FIG. 53 is a perspective view illustrating a structure of a developer supply container according to Embodiment 14, (b) is a sectional perspective view illustrating a structure of the developer supply container, (c) illustrates a structure of an end of the developer accommodating portion, and (d) and (e) illustrate suction and discharging operations of a pump portion.

Part (a) of FIG. 54 is a perspective view illustrating a structure of a developer supply container according to Embodiment 15, (b) is a perspective view illustrating a structure of a flange portion, and (c) is a perspective view illustrating a structure of the cylindrical portion.

Parts (a) and (b) of FIG. 55 are sectional views illustrating suction and discharging operations of a pump portion of the developer supply container according to Embodiment 15.

FIG. 56 illustrate a structure of the pump portion of the developer supply container according to Embodiment 15.

Parts (a) and (b) of FIG. 57 are sectional views schematically illustrating a structure of a developer supply container according to Embodiment 16.

Parts (a) and (b) of FIG. 58 are perspective views illustrating a cylindrical portion and a flange portion of a developer supply container according to Embodiment 13.

Parts (a) and (b) of FIG. 59 are partially sectional perspective views of a developer supply container according to Embodiment 13.

FIG. 60 is a time chart illustrating a relation between an operation state of a pump according to Embodiment 17 and opening and closing timing of a rotatable shutter.

FIG. 61 is a partly sectional perspective view illustrating a developer supply container according to Embodiment 18.

Parts (a)-(c) of FIG. 62 are partially sectional views illustrating operation state of a pump portion according to Embodiment 18.

FIG. 63 is a time chart illustrating a relation between an operation state of a pump according to Embodiment 18 and opening and closing timing of a stop valve.

Part (a) of FIG. 64 is a partial perspective view of a developer supply container according to Embodiment 19, (b) is a perspective view of a flange portion, and (c) is a sectional view of the developer supply container.

Part (a) of FIG. 65 is a perspective view illustrating a structure of a developer supply container according to Embodiment 20, and (b) is a sectional perspective view of the developer supply container.

FIG. 66 is a partly sectional perspective view illustrating a structure of a developer supply container according to Embodiment 20.

Part (a)-(d) of FIG. 67 are sectional views of the developer supply container and the developer replenishing apparatus of a comparison example, and illustrate a flow of the developer supplying steps.

FIG. 68 is a sectional view of a developer supply container and a developer replenishing apparatus of another comparison example.

### PREFERRED EMBODIMENTS OF THE INVENTION

In the following, the description will be made as to a developer supply container and a developer supplying system according to the present invention in detail. In the following description, various structures of the developer supply container may be replaced with other known structures having similar functions within the scope of the concept of invention unless otherwise stated. In other words, the present invention is not limited to the specific structures of the embodiments which will be described hereinafter, unless otherwise stated.

### Embodiment 1

First, basic structures of an image forming apparatus will be described, and then, a developer replenishing apparatus and a developer supply container constituting a developer supplying system used in the image forming apparatus will be described.

### (Image Forming Apparatus)

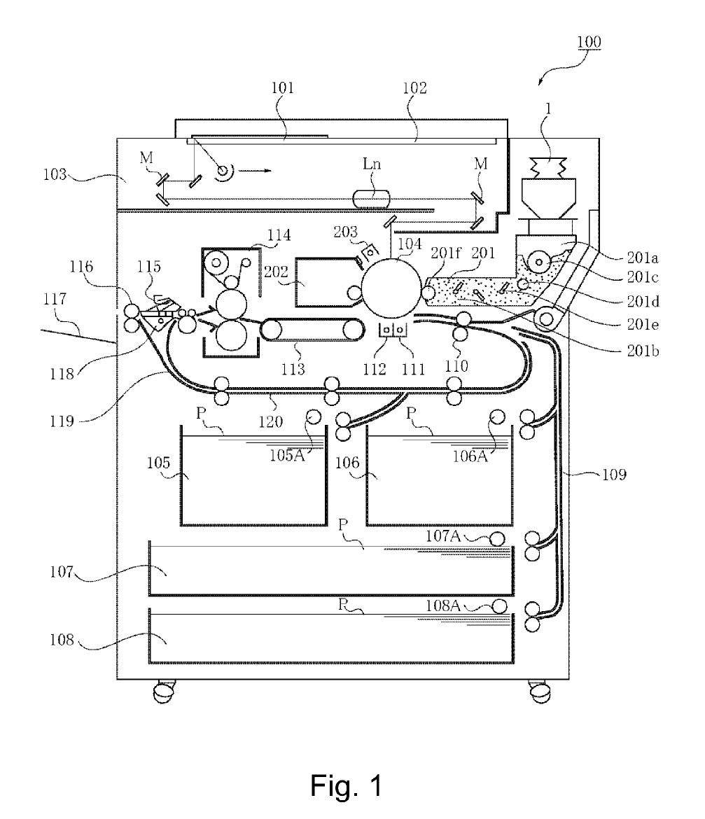

Referring to FIG. 1, the description will be made as to structures of a copying machine (electrophotographic image forming apparatus) employing an electrophotographic type process as an example of an image forming apparatus using a developer replenishing apparatus to which a developer supply container (so-called toner cartridge) is detachably mountable.

In the Figure, designated by 100 is a main assembly of the copying machine (main assembly of the image forming apparatus or main assembly of the apparatus). Designated by 101 is an original which is placed on an original supporting platen glass 102. A light image corresponding to image information of the original is imaged on an electrophotographic photosensitive member 104 (photosensitive member) by way of a plurality of mirrors M of an optical portion 103 and a lens Ln, so that an electrostatic latent image is formed. The electrostatic latent image is visualized with toner (one component magnetic toner) as a developer (dry powder) by a dry type developing device (one component developing device) 201a.

In this embodiment, the one component magnetic toner is used as the developer to be supplied from a developer supply container 1, but the present invention is not limited to the example and includes other examples which will be described hereinafter.

Specifically, in the case that a one component developing device using the one component non-magnetic toner is employed, the one component non-magnetic toner is supplied as the developer. In addition, in the case that a two component developing device using a two component developer containing mixed magnetic carrier and non-magnetic toner is employed, the non-magnetic toner is supplied as the developer. In such a case, both of the non-magnetic toner and the magnetic carrier may be supplied as the developer.

Designated by 105-108 are cassettes accommodating recording materials (sheets) S. Of the sheet S stacked in the cassettes 105-108, an optimum cassette is selected on the basis of a sheet size of the original 101 or information inputted by the operator (user) from a liquid crystal operating portion of the copying machine. The recording material is not limited to a sheet of paper, but OHP sheet or another material can be used as desired.

One sheet S supplied by a separation and feeding device 105A-108A is fed to registration rollers 110 along a feeding portion 109, and is fed at timing synchronized with rotation of a photosensitive member 104 and with scanning of an optical portion 103.

Designated by 111, 112 are a transfer charger and a separation charger. An image of the developer formed on the photosensitive member 104 is transferred onto the sheet S by a transfer charger 111. Then, the sheet S carrying the developed image (toner image) transferred thereonto is separated from the photosensitive member 104 by the separation charger 112.

Thereafter, the sheet S fed by the feeding portion 113 is subjected to heat and pressure in a fixing portion 114 so that the developed image on the sheet is fixed, and then passes through a discharging/reversing portion 115, in the case of one-sided copy mode, and subsequently the sheet S is discharged to a discharging tray 117 by discharging rollers 116.

In the case of a duplex copy mode, the sheet S enters the discharging/reversing portion 115 and a part thereof is ejected once to an outside of the apparatus by the discharging roller 116. The trailing end thereof passes through a flapper 118, and a flapper 118 is controlled when it is still nipped by the discharging rollers 116, and the discharging rollers 116 are rotated reversely, so that the sheet S is refed into the apparatus. Then, the sheet S is fed to the registration rollers 110 by way of re-feeding portions 119, 120, and then conveyed along the path similarly to the case of the one-sided copy mode and is discharged to the discharging tray 117.

In the main assembly of the apparatus 100, around the photosensitive member 104, there are provided image forming process equipment such as a developing device 201a as the developing means a cleaner portion 202 as a cleaning means, a primary charger 203 as charging means. The developing device 201a develops the electrostatic latent image formed on the photosensitive member 104 by the optical portion 103 in accordance with image information of the 101, by depositing the developer onto the latent image. The primary charger 203 uniformly charges a surface of the photosensitive member for the purpose of forming a desired electrostatic image on the photosensitive member 104. The cleaner portion 202 removes the developer remaining on the photosensitive member 104.

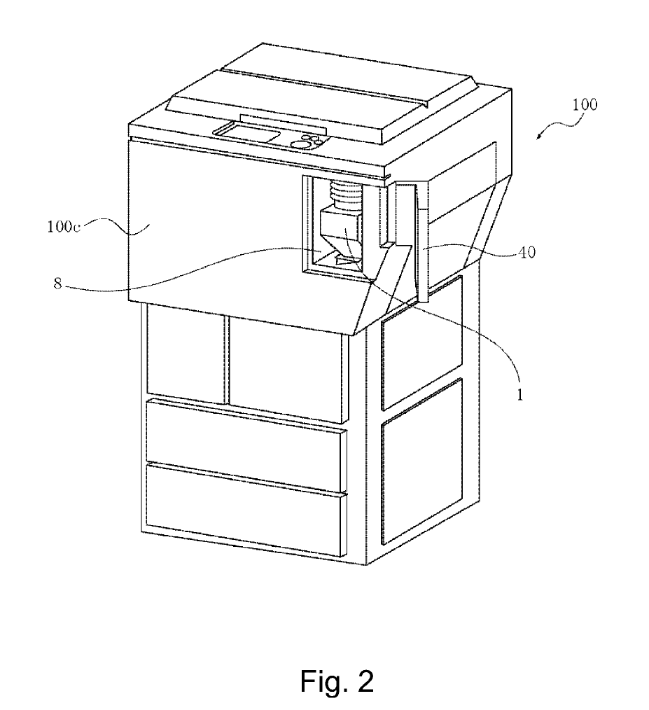

FIG. 2 is an outer appearance of the image forming apparatus. When an operator opens an exchange front cover 40 which is a part of an outer casing of the image forming apparatus, a part of a developer replenishing apparatus 8 which will be described hereinafter appears.

By inserting the developer supply container 1 into the developer replenishing apparatus 8, the developer supply container 1 is set into a state of supplying the developer into the developer replenishing apparatus 8. On the other hand, when the operator exchanges the developer supply container 1, the operation opposite to that for the mounting is carried out, by which the developer supply container 1 is taken out of the developer replenishing apparatus 8, and a new developer supply container 1 is set. The front cover 40 for the exchange is a cover exclusively for mounting and demounting (exchanging) the developer supply container 1 and is opened and closed only for mounting and demounting the developer supply container 1. In the maintenance operation for the main assembly of the device 100, a front cover 100c is opened and closed.

### (Developer Replenishing Apparatus)

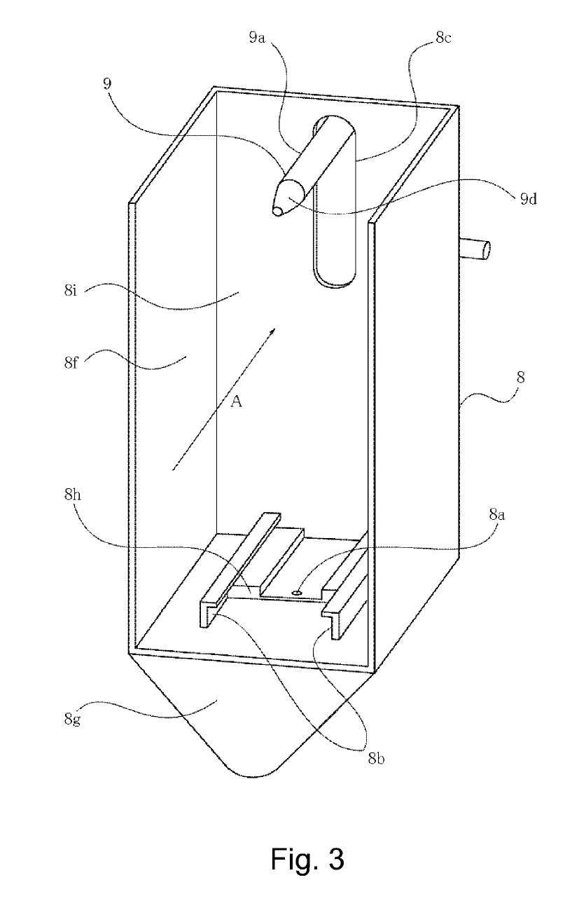

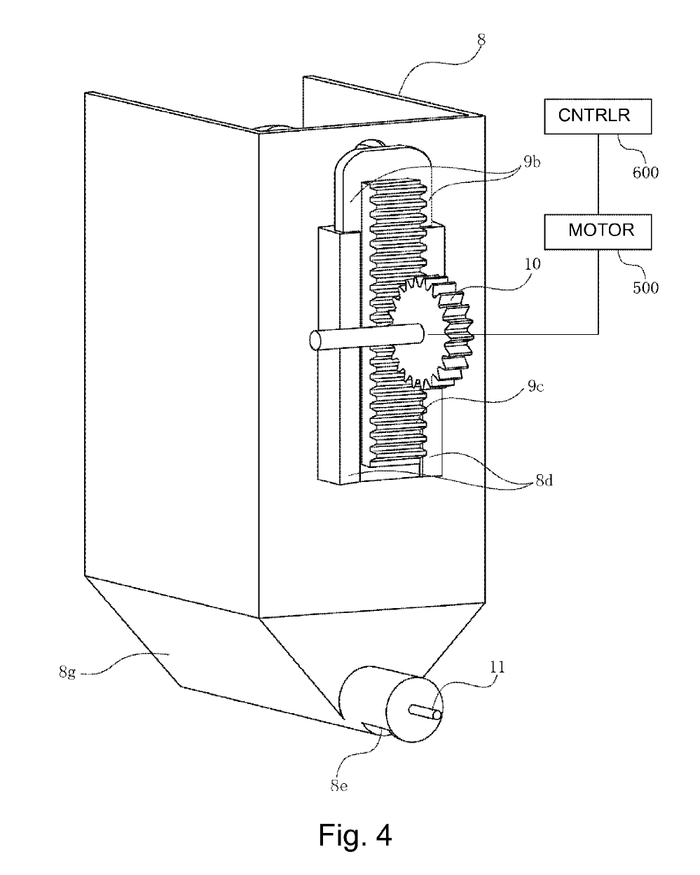

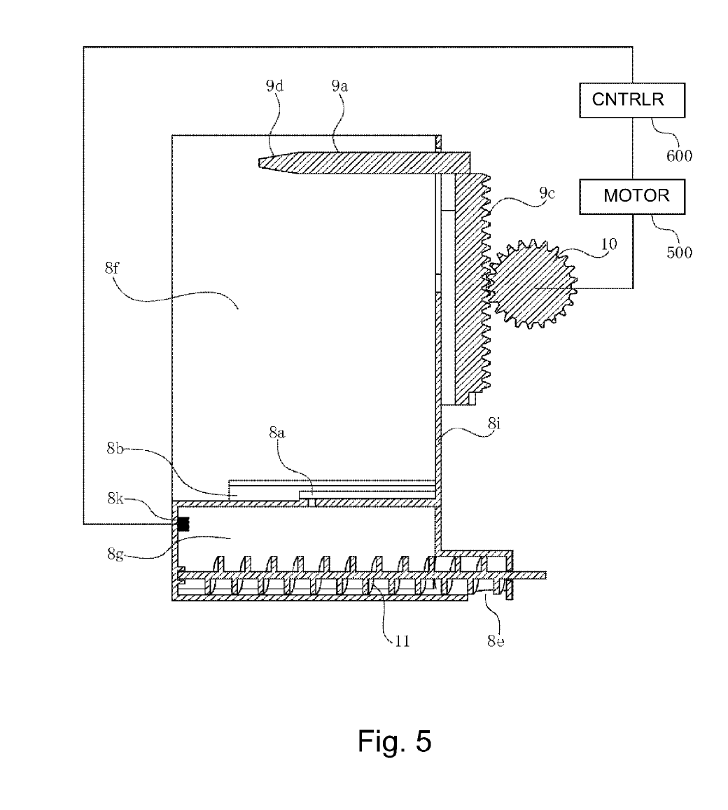

Referring to FIGS. 3, 4 and 5, the developer replenishing apparatus 8 will be described. FIG. 3 is a schematic perspective view of the developer replenishing apparatus 8. FIG. 4 is a schematic perspective view of the developer replenishing apparatus 8 as seen from the backside. FIG. 5 is a schematic sectional view of the developer replenishing apparatus 8.

The developer replenishing apparatus 8 is provided with a mounting portion (mounting space) to which the developer supply container 1 is demountable (detachably mountable). It is provided also with a developer receiving port (developer receiving hole) for receiving the developer discharged from a discharge opening (discharging port) 1c of the developer supply container 1 which will be described hereinafter. A diameter of the developer receiving port 8a is desirably substantially the same as that of the discharge opening 1c of the developer supply container 1 from the standpoint of preventing as much as possible contamination of the inside of a mounting portion 8f with the developer. When the diameters of the developer receiving port 8a and the discharge opening 1c are the same, the deposition of the developer to and the resulting contamination of the inner surface other than the port and the opening can be avoided.

In this example, the developer receiving port 8a is a minute opening (pin hole) correspondingly to the discharge opening 1c of the developer supply container 1, and the diameter is approx. 2 mmφ. There is provided a L-shaped positioning guide (holding member) 8b for fixing a position of the developer supply container 1, so that the mounting direction of the developer supply container 1 to the mounting portion 8f is the direction indicated by an arrow A. The removing direction of the developer supply container 1 from the mounting portion 8f is opposite to the direction A.

The developer replenishing apparatus 8 is provided in the lower portion with a hopper 8g for temporarily accumulates the developer As shown in FIG. 5, in the hopper 8g, there are provided a feeding screw 11 for feeding the developer into the developer hopper portion 201a which is a part of the developing device 201, and an opening 8e in fluid communication with the developer hopper portion 201a. In this embodiment, a volume of the hopper 8g is 130 cm³.

As described hereinbefore, the developing device 201 of FIG. 1 develops, using the developer, the electrostatic latent image formed on the photosensitive member 104 on the basis of image information of the original 101. The developing device 201 is provided with a developing roller 201f in addition to the developer hopper portion 201a.

The developer hopper portion 201a is provided with a stirring member 201c for stirring the developer supplied from the developer supply container 1. The developer stirred by the stirring member 201c is fed to the feeding member 201e by a feeding member 201d.

The developer fed sequentially by the feeding members 201e, 201b is carried on the developing roller 201f, and is finally to the photosensitive member 104. As shown in FIGS. 3, 4, the developer replenishing apparatus 8 is further provided with a locking member 9 and a gear 10 which constitute a driving mechanism for driving the developer supply container 1 which will be described hereinafter.

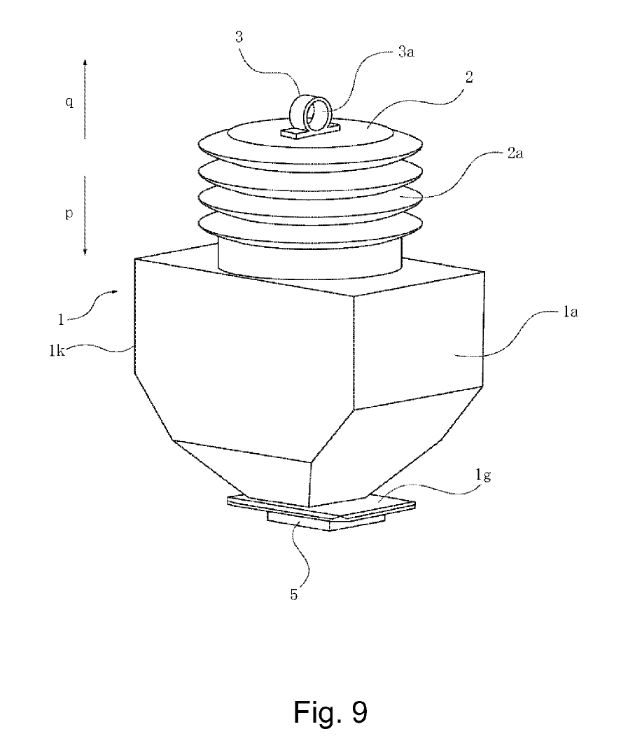

The locking member 9 is locked with a locking portion 3 functioning as a drive inputting portion for the developer supply container 1 when the developer supply container 1 is mounted to the mounting portion 8f for the developer replenishing apparatus 8. The locking member 9 is loosely fitted in an elongate hole portion 8c formed in the mounting portion 8f of the developer replenishing apparatus 8, and movable up and down directions in the Figure relative to the mounting portion 8f. The locking member 9 is in the form of a round bar configuration and is provided at the free end with a tapered portion 9d in consideration of easy insertion into a locking portion 3 (FIG. 9) of the developer supply container 1 which will be described hereinafter.

The locking portion 9a (engaging portion engageable with locking portion 3) of the locking member 9 is connected with a rail portion 9b shown in FIG. 4, and the sides of the rail portion 9b are held by a guide portion 8d of the developer replenishing apparatus 8 and is movable in the up and down direction in the Figure.

The rail portion 9b is provided with a gear portion 9c which is engaged with a gear 10. The gear 10 is connected with a driving motor 500. By a control device 600 effecting such a control that the rotational moving direction of a driving motor 500 provided in the image forming apparatus 100 is periodically reversed, the locking member 9 reciprocates in the up and down directions in the Figure along the elongated hole 8c.

### (Developer Supply Control of Developer Replenishing Apparatus)

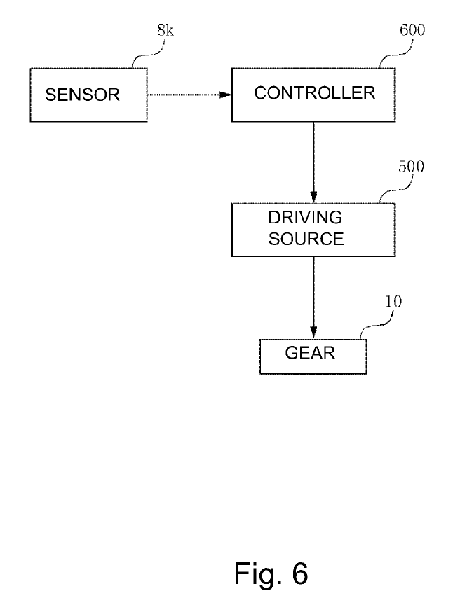

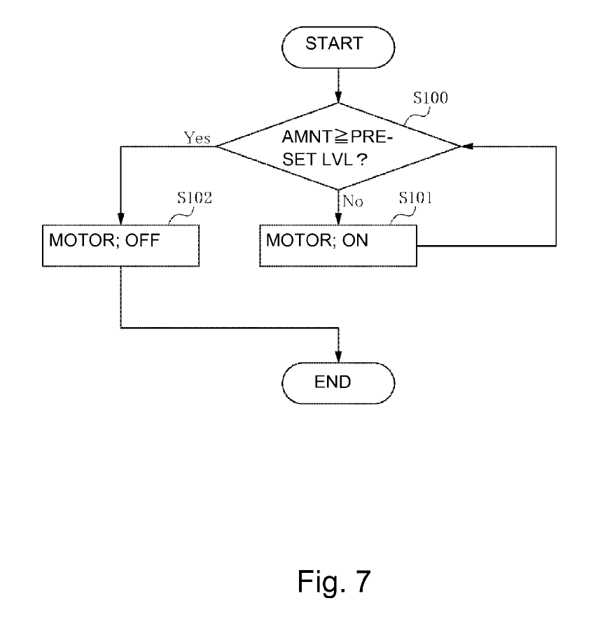

Referring to FIGS. 6, 7, a developer supply control by the developer replenishing apparatus 8 will be described. FIG. 6 is a block diagram illustrating the function and the structure of the control device 600, and FIG. 7 is a flow chart illustrating a flow of the supplying operation.

In this example, an amount of the developer temporarily accumulated in the hopper 8g (height of the developer level) is limited so that the developer does not flow reversely into the developer supply container 1 from the developer replenishing apparatus 8 by the suction operation of the developer supply container 1 which will be described hereinafter. For this purpose, in this example, a developer sensor 8k (FIG. 5) is provided to detect the amount of the developer accommodated in the hopper 8g.

As shown in FIG. 6, the control device 600 controls the operation/non-operation of the driving motor 500 in accordance with an output of the developer sensor 8k by which the developer is not accommodated in the hopper 8g beyond a predetermined amount.

A flow of a control sequence therefor will be described. First, as shown in FIG. 7, the developer sensor 8k checks the accommodated developer amount in the hopper 8g. When the accommodated developer amount detected by the developer sensor 8k is discriminated as being less than a predetermined amount, that is, when no developer is detected by the developer sensor 8k, the driving motor 500 is actuated to execute a developer supplying operation for a predetermined time period (S101).

The accommodated developer amount detected with developer sensor 8k is discriminated as having reached the predetermined amount, that is, when the developer is detected by the developer sensor 8k, as a result of the developer supplying operation, the driving motor 500 is deactuated to stop the developer supplying operation (S102). By the stop of the supplying operation, a series of developer supplying steps is completed.

Such developer supplying steps are carried out repeatedly whenever the accommodated developer amount in the hopper 8g becomes less than a predetermined amount as a result of consumption of the developer by the image forming operations.

In this example, the developer discharged from the developer supply container 1 is stored temporarily in the hopper 8g, and then is supplied into the developing device, but the following structure of the developer replenishing apparatus can be employed.

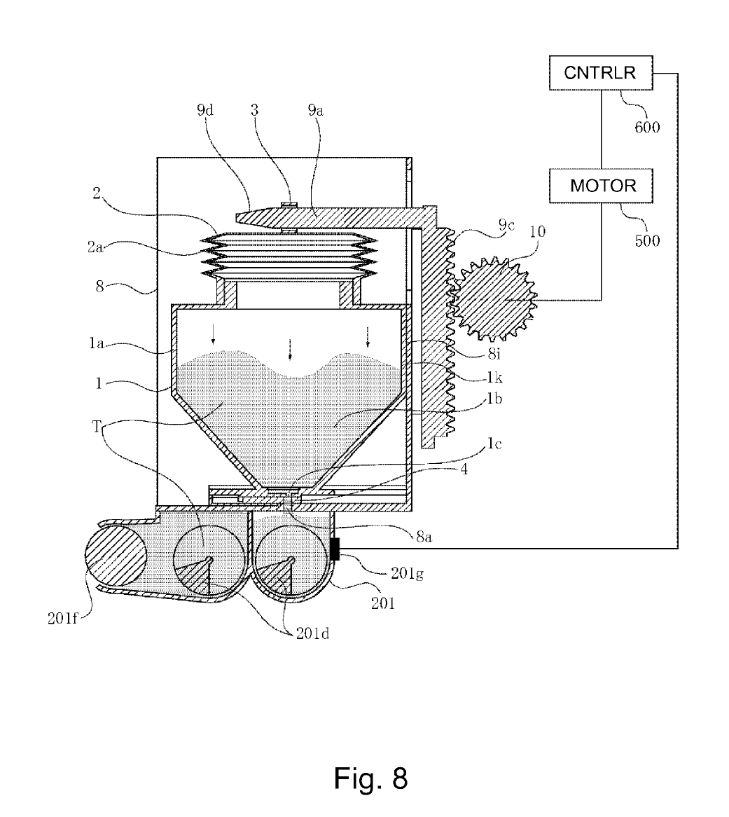

Particularly in the case of a low speed image forming apparatus, the main assembly is required to be compact and low in cost. In such a case, it is desirable that the developer is supplied directly to the developing device 201, as shown in FIG. 8.

More particularly, the above-described hopper 8g is omitted, and the developer is supplied directly into the developing device 201a from the developer supply container 1. FIG. 8 shows an example using a two component developing device 201a developer replenishing apparatus. The developing device 201 comprises a stirring chamber into which the developer is supplied, and a developer chamber for supplying the developer to the developing roller 201f, wherein the stirring chamber and the developer chamber are provided with screws 201d rotatable in such directions that the developer is fed in the opposite directions from each other. The stirring chamber and the developer chamber are communicated with each other in the opposite longitudinal end portions, and the two component developer are circulated the two chambers. The stirring chamber is provided with a magnetometric sensor 201g for detecting a toner content of the developer, and on the basis of the detection result of the magnetometric sensor 201g, the control device 600 controls the operation of the driving motor 500. In such a case, the developer supplied from the developer supply container is non-magnetic toner or non-magnetic toner plus magnetic carrier.

In this example, as will be described hereinafter, the developer in the developer supply container 1 is hardly discharged through the discharge opening 1c only by the gravitation, but the developer is by a discharging operation by a pump 2, and therefore, variation in the discharge amount can be suppressed. Therefore, the developer supply container 1 which will be described hereinafter is usable for the example of FIG. 8 lacking the hopper 8g.

### (Developer Supply Container)

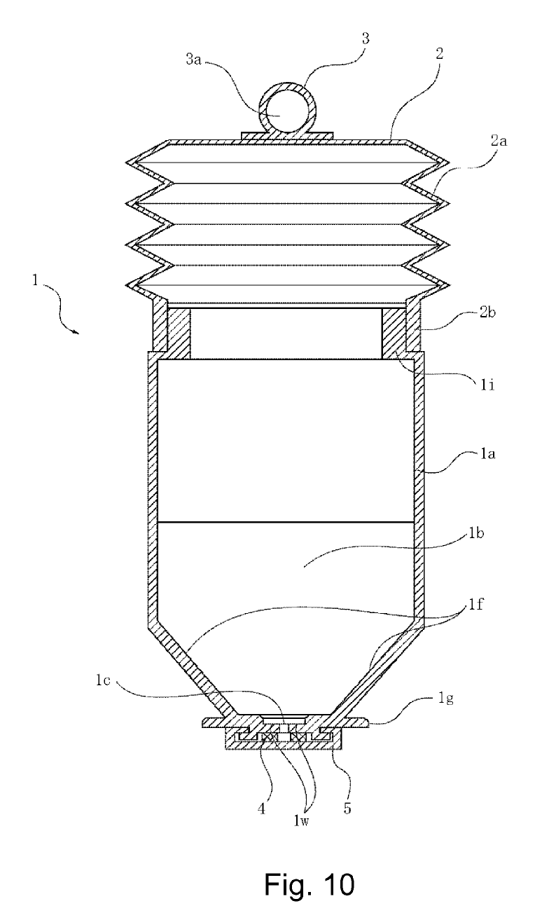

Referring to FIGS. 9 and 10, the structure of the developer supply container 1 according to the embodiment will be described.

FIG. 9 is a schematic perspective view of the developer supply container 1. FIG. 10 is a schematic sectional view of the developer supply container 1.

As shown in FIG. 9, the developer supply container 1 has a container body 1a functioning as a developer accommodating portion for accommodating the developer. Designated by 1b in FIG. 10 is a developer accommodating space in which the developer is accommodated in the container body 1a. In the example, the developer accommodating space 1b functioning as the developer accommodating portion is the space in the container body 1a plus an inside space in the pump 2. In this example, the developer accommodating space 1b accommodates toner which is dry powder having a volume average particle size of 5 μm-6 μm.

In this embodiment, the pump portion is a displacement type pump 2 in which the volume changes. More particularly, the pump 2 has a bellow-like expansion-and-contraction portion 2a (bellow portion, expansion-and-contraction member) which can be contracted and expanded by a driving force received from the developer replenishing apparatus 8.

As shown in FIGS. 9, 10, the bellow-like pump 2 of this example is folded to provide crests and bottoms which are provided alternately and periodically, and is contractable and expandable. When the bellow-like pump 2 as in this example, a variation in the volume change amount relative to the amount of expansion and contraction can be reduced, and therefore, a stable volume change can be accomplished.

In this embodiment, the all volume of the developer accommodating space 1b is 480 cm³, of which the volume of the pump portion 2 is 160 cm³ (in the free state of the expansion-and-contraction portion 2a), and in this example, the pumping operation is effected in the pump portion (2) expansion direction from the length in the free state.

The volume change amount by the expansion and contraction of the expansion-and-contraction portion 2a of the pump portion 2 is 15 cm³, and the total volume at the time of maximum expansion of the pump 2 is 495 cm³.

The developer supply container 1 filled with 240 g of developer.

The driving motor 500 for driving the locking member 9 is controlled by the control device 600 to provide a volume change speed of 90 cm³/s. The volume change amount and the volume change speed may be properly selected in consideration of a required discharge amount of the developer replenishing apparatus 8.

The pump 2 in this example is a bellow-like pump, but another pump is usable if the air amount (pressure) in the developer accommodating space 1b can be changed. For example, the pump portion 2 may be a single-shaft eccentric screw pump. In such a case, an additional opening is required to permit suction and discharging by the single-shaft eccentric screw pump is necessary, and the provision of the opening requires means such as a filter for preventing leakage of the developer around the opening. In addition, a single-shaft eccentric screw pump requires a very high torque to operate, and therefore, the load to the main assembly of the image forming apparatus 100 increases. Therefore, the bellow-like pump is preferable since it is free of such problems.

The developer accommodating space 1b may be only the inside space of the pump portion 2. In such a case, the pump portion 2 functions simultaneously as the developer accommodating portion 1b.

A connecting portion 2b of the pump portion 2 and the connected portion 1i of the container body 1a are unified by welding to prevent leakage of the developer, that is, to keep the hermetical property of the developer accommodating space 1b.

The developer supply container 1 is provided with the locking portion 3 as a drive inputting portion (driving force receiving portion, drive connecting portion, engaging portion) which is engageable with the driving mechanism of the developer replenishing apparatus 8 and which receives a driving force for driving the pump portion 2 from the driving mechanism.

More particularly, the locking portion 3 engageable with the locking member 9 of the developer replenishing apparatus 8 is mounted by an adhesive material to an upper end of the pump portion 2. The locking portion 3 includes a locking hole 3a in the center portion thereof, as shown in FIG. 9. When the developer supply container 1 is mounted to the mounting portion 8f (FIG. 3), the locking member 9 is inserted into the locking hole 3a, so that they are unified (slight play is provided for easy insertion). As shown in FIG. 9, the relative position between the locking portion 3 and the locking member 9 in p direction and q direction which are expansion and contraction directions of the expansion-and-contraction portion 2a. It is preferable that the pump portion 2 and the locking portion 3 are molded integrally using an injection molding method or a blow molding method.

The locking portion 3 unified substantially with the locking member 9 in this manner receives a driving force for expanding and contracting the expansion-and-contraction portion 2a of the pump portion 2 from the locking member 9. As a result, with the vertical movement of the locking member 9, the expansion-and-contraction portion 2a of the pump portion 2 is expanded and contracted.

The pump portion 2 functions as an air flow generating mechanism for producing alternately and repeatedly the air flow into the developer supply container and the air flow to the outside of the developer supply container through the discharge opening 1c by the driving force received by the locking portion 3 functioning as the drive inputting portion.

In this embodiment, the use is made with the round bar locking member 9 and the round hole locking portion 3 to substantially unify them, but another structure is usable if the relative position therebetween can be fixed with respect to the expansion and contraction direction (p direction and q direction) of the expansion-and-contraction portion 2a. For example, the locking portion 3 is a rod-like member, and the locking member 9 is a locking hole; the cross-sectional configurations of the locking portion 3 and the locking member 9 may be triangular, rectangular or another polygonal, or may be ellipse, star shape or another shape. Or, another known locking structure is usable.

In a flange portion 1g at the bottom end portion of the container body 1a, a discharge opening 1c for permitting discharging of the developer in the developer accommodating space 1b to the outside of the developer supply container 1 is provided. The discharge opening 1c will be described in detail hereinafter.

As shown in FIG. 10, an inclined surface 1f is formed toward the discharge opening 1c in a lower portion of the container body 1a, the developer accommodated in the developer accommodating space 1b slides down on the inclined surface if by the gravity toward a neighborhood of the discharge opening 1c. In this embodiment, the inclination angle of the inclined surface if (angle relative to a horizontal surface in the state that the developer supply container 1 is set in the developer replenishing apparatus 8) is larger than an angle of rest of the toner (developer).

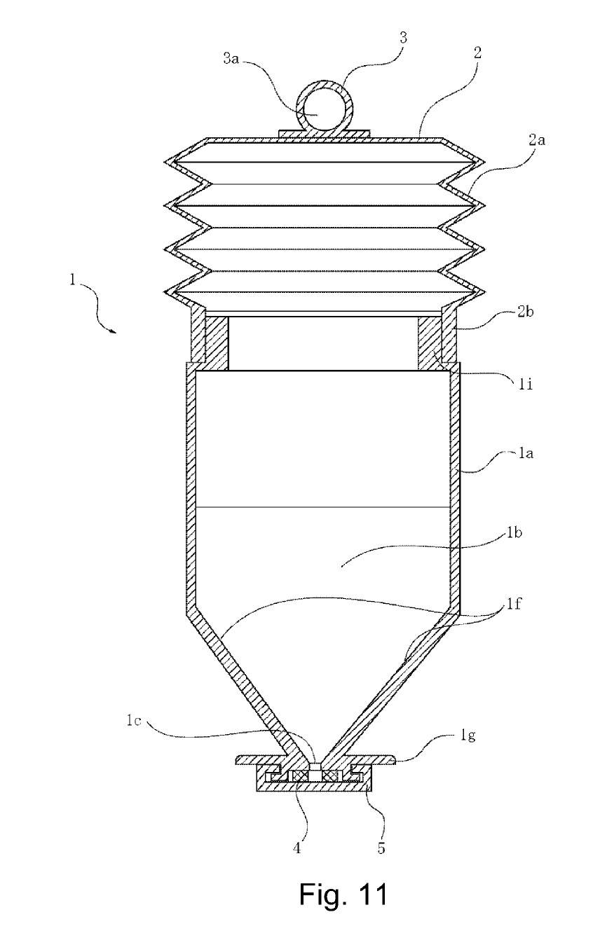

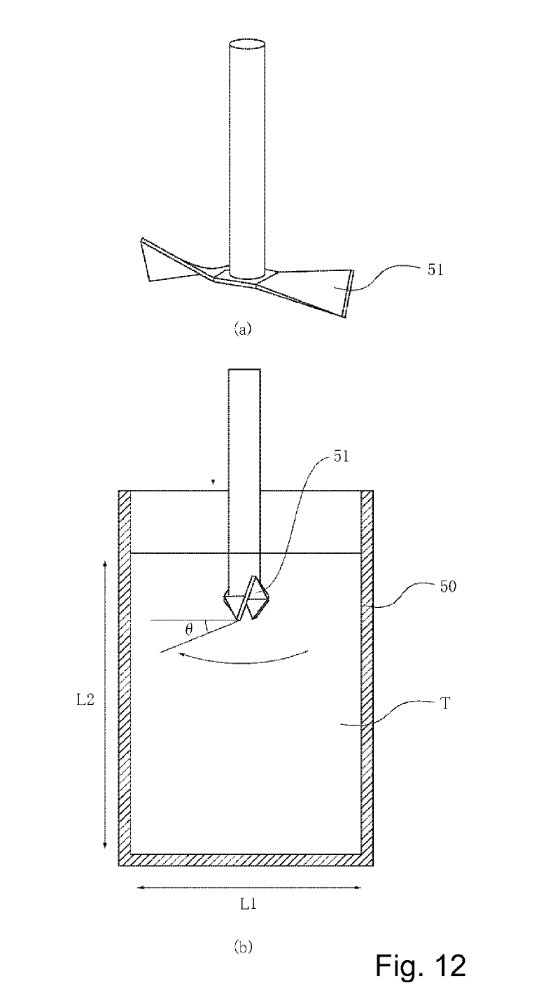

The configuration of the peripheral portion of the discharge opening 1c is not limited to the shape shown in FIG. 10, in which the configuration of the connecting portion between the discharge opening 1c and the inside of the container body 1a is flat (1 W in FIG. 10), but may be as shown in FIG. 11 in which the inclined surface if is extended to the discharge opening 1c.

The flat configuration shown in FIG. 10, a space efficiency is good with respect to the direction of height of the developer supply container 1, and the inclined surface if of FIG. 11 is advantageous in that the remaining amount is small since the developer remaining on the inclined surface 1f is promoted toward the discharge opening 1c. Therefore, the configuration of the peripheral portion of it discharge opening 1c may be selected as desired.

In this embodiment, the flat configuration shown in FIG. 10 is selected.

The developer supply container 1 is in fluid communication with the outside of the developer supply container 1 only through the discharge opening 1c, and is sealed substantially except for the discharge opening 1c.

Referring to FIGS. 3, 10, a shutter mechanism for opening and closing the discharge opening 1c will be described.

A sealing member 4 of an elastic material is fixed by bonding to a lower surface of the flange portion 1g so as to surround the circumference of the discharge opening 1c to prevent developer leakage. A shutter 5 for sealing the discharge opening 1c is provided so as to compress the sealing member 4 between the shutter 5 and a lower surface of the flange portion 1g.

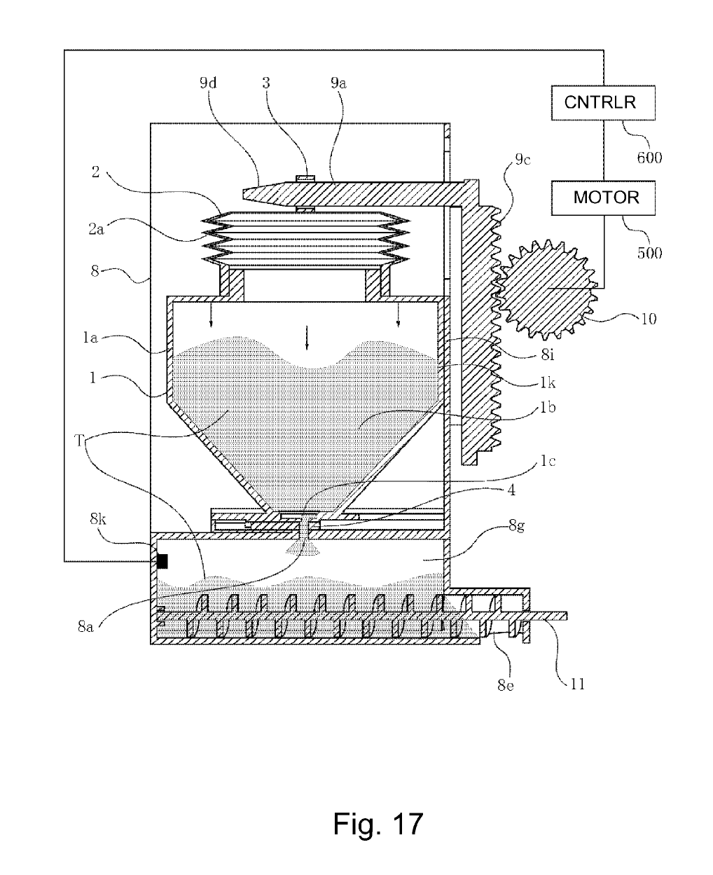

The shutter 5 is normally urged (by expanding force of a spring) in a close direction by a spring (not shown) which is an urging member. The shutter 5 is unsealed in interrelation with mounting operation of the developer supply container 1 by abutting to an end surface of the abutting portion 8h (FIG. 3) formed on the developer replenishing apparatus 8 and contracting the spring. At this time, the flange portion 1g of the developer supply container 1 is inserted between an abutting portion 8h and the positioning guide 8b provided in the developer replenishing apparatus 8, so that a side surface 1k (FIG. 9) of the developer supply container 1 abuts to a stopper portion 8i of the developer replenishing apparatus 8. As a result, the position relative to the developer replenishing apparatus 8 in the mounting direction (A direction) is determined (FIG. 17).

The flange portion 1g is guided by the positioning guide 8b in this manner, and at the time when the inserting operation of the developer supply container 1 is completed, the discharge opening 1c and the developer receiving port 8a are aligned with each other.

In addition, when the inserting operation of the developer supply container 1 is completed, the space between the discharge opening 1c and the receiving port 8a is sealed by the sealing member 4 (FIG. 17) to prevent leakage of the developer to the outside.

With the inserting operation of the developer supply container 1, the locking member 9 is inserted into the locking hole 3a of the locking portion 3 of the developer supply container 1 so that they are unified.

At this time, the position thereof is determined by the L shape portion of the positioning guide 8b in the direction (up and down direction in FIG. 3) perpendicular to the mounting direction (A direction), relative to the developer replenishing apparatus 8, of the developer supply container 1. The flange portion 1g as the positioning portion also functions to prevent movement of the developer supply container 1 in the up and down direction (reciprocation direction of the pump 2).

The operations up to here are the series of mounting steps for the developer supply container 1. By the operator closing the front cover 40, the mounting step is finished.

The steps for dismounting the developer supply container 1 from the developer replenishing apparatus 8 are opposite from those in the mounting step.

More particularly, the exchange front cover 40 is opened, and the developer supply container 1 is dismounted from the mounting portion 8f. At this time, the interfering state by the abutting portion 8h is released, by which the shutter 5 is closed by the spring (not shown).

In this example, the state (decompressed state, negative pressure state) in which the internal pressure of the container body 1a (developer accommodating space 1b) is lower than the ambient pressure (external air pressure) and the state (compressed state, positive pressure state) in which the internal pressure is higher than the ambient pressure are alternately repeated at a predetermined cyclic period. Here, the ambient pressure (external air pressure) is the pressure under the ambient condition in which the developer supply container 1 is placed.

Thus, the developer is discharged through the discharge opening 1c by changing a pressure (internal pressure) of the container body 1a. In this example, it is changed (reciprocated) between 480-495 cm³ at a cyclic period of 0.3 sec. The material of the container body 1 is preferably such that it provides an enough rigidity to avoid collision or extreme expansion.

In view of this, this example employs polystyrene resin material as the materials of the developer container body 1a and employs polypropylene resin material as the material of the pump 2.

As for the material for the container body 1a, other resin materials such as ABS (acrylonitrile, butadiene, styrene copolymer resin material), polyester, polyethylene, polypropylene, for example are usable if they have enough durability against the pressure. Alternatively, they may be metal.

As for the material of the pump 2, any material is usable if it is expansible and contractable enough to change the internal pressure of the space in the developer accommodating space 1b by the volume change. The examples includes thin formed ABS (acrylonitrile, butadiene, styrene copolymer resin material), polystyrene, polyester, polyethylene materials. Alternatively, other expandable-and-contractable materials such as rubber are usable.

They may be integrally molded of the same material through an injection molding method, a blow molding method or the like if the thicknesses are properly adjusted for the pump 2b and the container body 1a.

In this example, the developer supply container 1 is in fluid communication with the outside only through the discharge opening 1c, and therefore, it is substantially sealed from the outside except for the discharge opening 1c. That is, the developer is discharged through discharge opening 1c by compressing and decompressing the inside of the developer supply container 1, and therefore, the hermetical property is desired to maintain the stabilized discharging performance.

On the other hand, there is a liability that during transportation (air transportation) of the developer supply container 1 and/or in long term unused period, the internal pressure of the container may abruptly changes due to abrupt variation of the ambient conditions. For an example, when the apparatus is used in a region having a high altitude, or when the developer supply container 1 kept in a low ambient temperature place is transferred to a high ambient temperature room, the inside of the developer supply container 1 may be pressurized as compared with the ambient air pressure. In such a case, the container may deform, and/or the developer may splash when the container is unsealed.

In view of this, the developer supply container 1 is provided with an opening of a diameter φ3 mm, and the opening is provided with a filter. The filter is TEMISH (registered Trademark) available from Nitto Denko Kabushiki Kaisha, Japan, which is provided with a property preventing developer leakage to the outside but permitting air passage between inside and outside of the container. Here, in this example, despite the fact that such a countermeasurement is taken, the influence thereof to the sucking operation and the discharging operation through the discharge opening 1c by the pump 2 can be ignored, and therefore, the hermetical property of the developer supply container 1 is kept in effect.

### (Discharge Opening of Developer Supply Container)

In this example, the size of the discharge opening 1c of the developer supply container 1 is so selected that in the orientation of the developer supply container 1 for supplying the developer into the developer replenishing apparatus 8, the developer is not discharged to a sufficient extent, only by the gravitation. The opening size of the discharge opening 1c is so small that the discharging of the developer from the developer supply container is insufficient only by the gravitation, and therefore, the opening is called pin hole hereinafter. In other words, the size of the opening is determined such that the discharge opening 1c is substantially clogged. This is expectedly advantageous in the following points.

(1) the developer does not easily leak through the discharge opening 1c.

(2) excessive discharging of the developer at time of opening of the discharge opening 1c can be suppressed.

(3) the discharging of the developer can rely dominantly on the discharging operation by the pump portion.

The inventors have investigated as to the size of the discharge opening 1c not enough to discharge the toner to a sufficient extent only by the gravitation. The verification experiment (measuring method) and criteria will be described.

A rectangular parallelepiped container of a predetermined volume in which a discharge opening (circular) is formed at the center portion of the bottom portion is prepared, and is filled with 200 g of developer; then, the filling port is sealed, and the discharge opening is plugged; in this state, the container is shaken enough to loosen the developer. The rectangular parallelepiped container has a volume of 1000 cm³, 90 mm in length, 92 mm width and 120 mm in height.

Thereafter, as soon as possible the discharge opening is unsealed in the state that the discharge opening is directed downwardly, and the amount of the developer discharged through the discharge opening is measured. At this time, the rectangular parallelepiped container is sealed completely except for the discharge opening. In addition, the verification experiments were carried out under the conditions of the temperature of 24□ and the relative humidity of 55%.

Using these processes, the discharge amounts are measured while changing the kind of the developer and the size of the discharge opening. In this example, when the amount of the discharged developer is not more than 2 g, the amount is negligible, and therefore, the size of the discharge opening at that time is deemed as being not enough to discharge the developer sufficiently only by the gravitation.

The developers used in the verification experiment are shown in Table 1. The kinds of the developer are one component magnetic toner, non-magnetic toner for two component developer developing device and a mixture of the non-magnetic toner and the magnetic carrier.

As for property values indicative of the property of the developer, the measurements are made as to angles of rest indicating flowabilities, and fluidity energy indicating easiness of loosing of the developer layer, which is measured by a powder flowability analyzing device

(Powder Rheometer FT4 Available from Freeman Technology)

TABLE 1

| | Volume | | | |
|---|---|---|---|---|
| | average | | | Fluidity |
| | particle | | Angle | energy |
| | size | | of | (Bulk |
| | of toner | Developer | rest | density of |
| Developers | (μm) | component | (deg.) | 0.5 g/cm³) |
| A | 7 | Two-component | 18 | 2.09 × 10⁻³ J |
| | | non-magnetic | | |
| B | 6.5 | Two-component non- | 22 | 6.80 × 10⁻⁴ J |
| | | magnetic toner + | | |
| | | carrier | | |
| C | 7 | One-component | 35 | 4.30 × 10⁻⁴ J |
| | | magnetic toner | | |
| D | 5.5 | Two-component non- | 40 | 3.51 × 10⁻³ J |
| | | magnetic toner + | | |
| | | carrier | | |
| E | 5 | Two-component non- | 27 | 4.14 × 10⁻³ J |
| | | magnetic toner + | | |
| | | carrier | | |

Referring to FIG. 12 a measuring method for the fluidity energy will be described. Here, FIG. 12 is a schematic view of a device for measuring the fluidity energy.

The principle of the powder flowability analyzing device is that a blade is moved in a powder sample, and the energy required for the blade to move in the powder, that is, the fluidity energy, is measured. The blade is of a propeller type, and when it rotates, it moves in the rotational axis direction simultaneously, and therefore, a free end of the blade moves helically.

The propeller type blade 51 is made of SUS (type=C210) and has a diameter of 48 mm, and is twisted smoothly in the counterclockwise direction. More specifically, from a center of the blade of 48 mm×10 mm, a rotation shaft extends in a normal line direction relative to a rotation plane of the blade, a twist angle of the blade at the opposite outermost edge portions (the positions of 24 mm from the rotation shaft) is 70°, and a twist angle at the positions of 12 mm from the rotation shaft is 35°.

The fluidity energy is total energy provided by integrating with time a total sum of a rotational torque and a vertical load when the helical rotating blade 51 enters the powder layer and advances in the powder layer. The value thus obtained indicates easiness of loosening of the developer powder layer, and large fluidity energy means less easiness and small fluidity energy means greater easiness.

In this measurement, as shown in FIG. 12, the developer T is filled up to a powder surface level of 70 mm (L2 in FIG. 12) into the cylindrical container 53 having a diameter φ of 50 mm (volume=200 cc, L1 (FIG. 12)=50 mm) which is the standard part of the device. The filling amount is adjusted in accordance with a bulk density of the developer to measure. The blade 54 of φ48 mm which is the standard part is advanced into the powder layer, and the energy required to advance from depth 10 mm to depth 30 mm is displayed.

The set conditions at the time of measurement are,

The rotational speed of the blade 51 (tip speed=peripheral speed of the outermost edge portion of the blade) is 60 mm/s:

The blade advancing speed in the vertical direction into the powder layer is such a speed that an angle θ (helix angle) formed between a track of the outermost edge portion of the blade 51 during advancement and the surface of the powder layer is 10°:

The advancing speed into the powder layer in the perpendicular direction is 11 mm/s (blade advancement speed in the powder layer in the vertical direction=(rotational speed of blade)×tan (helix angle×π/180)): and

The measurement is carried out under the condition of temperature of 24□ and relative humidity of 55%.

The bulk density of the developer when the fluidity energy of the developer is measured is close to that when the experiments for verifying the relation between the discharge amount of the developer and the size of the discharge opening, is less changing and is stable, and more particularly is adjusted to be 0.5 g/cm³.

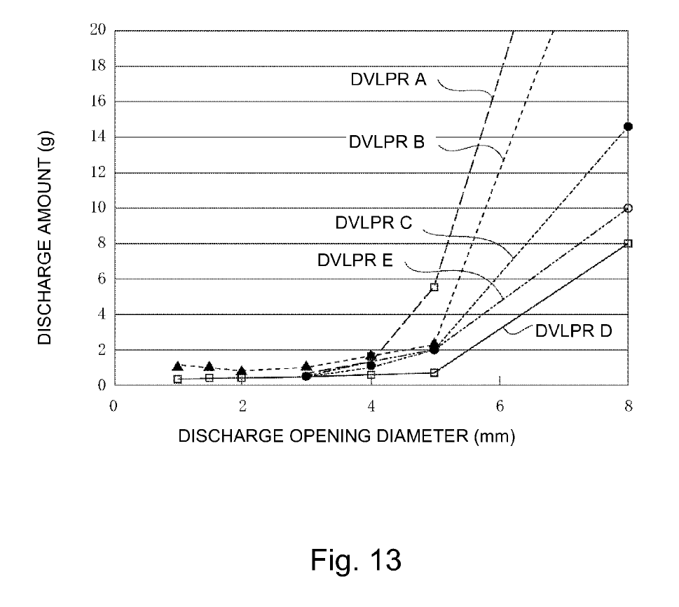

The verification experiments were carried out for the developers (Table 1) with the measurements of the fluidity energy in such a manner. FIG. 13 is a graph showing relations between the diameters of the discharge openings and the discharge amounts with respect to the respective developers.

From the verification results shown in FIG. 13, it has been confirmed that the discharge amount through the discharge opening is not more than 2 g for each of the developers A-E, if the diameter φ of the discharge opening is not more than 4 mm (12.6 mm² in the opening area (circle ratio=3.14)). When the diameter φ discharge opening exceeds 4 mm, the discharge amount increases sharply.

The diameter φ of the discharge opening is preferably not more than 4 mm (12.6 mm² of the opening area) when the fluidity energy of the developer (0.5 g/cm³ of the bulk density) is not less than 4.3×10⁻⁴ kg-m²/s² (J) and not more than 4.14×10⁻³ kg-m²/s² (J).

As for the bulk density of the developer, the developer has been loosened and fluidized sufficiently in the verification experiments, and therefore, the bulk density is lower than that expected in the normal use condition (left state), that is, the measurements are carried out in the condition in which the developer is more easily discharged than in the normal use condition.

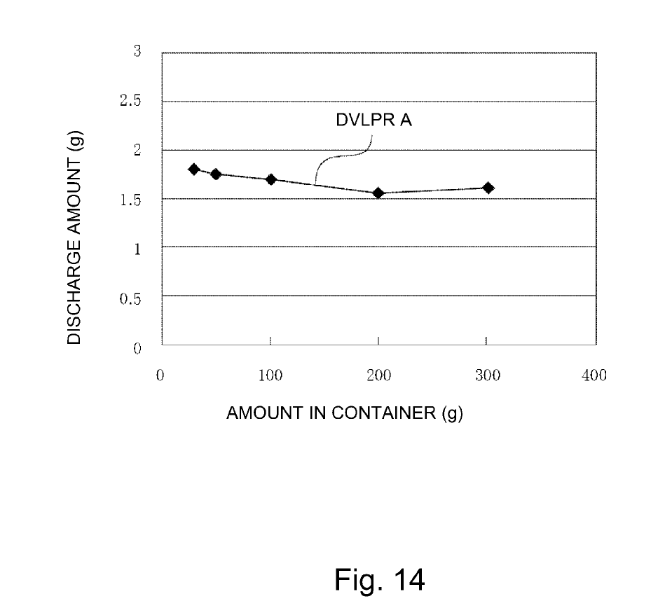

The verification experiments were carries out as to the developer A with which the discharge amount is the largest in the results of FIG. 13, wherein the filling amount in the container were changed in the range of 30-300 g while the diameter φ of the discharge opening is constant at 4 mm. The verification results are shown in FIG. 10. From the results of FIG. 14, it has been confirmed that the discharge amount through the discharge opening hardly changes even if the filling amount of the developer changes.

From the foregoing, it has been confirmed that by making the diameter φ of the discharge opening not more than 4 mm (12.6 mm² in the area), the developer is not discharged sufficiently only by the gravitation through the discharge opening in the state that the discharge opening is directed downwardly (supposed supplying attitude into the developer replenishing apparatus 201) irrespective of the kind of the developer or the bulk density state.

On the other hand, the lower limit value of the size of the discharge opening 1c is preferably such that the developer to be supplied from the developer supply container 1 (one component magnetic toner, one component non-magnetic toner, two component non-magnetic toner or two component magnetic carrier) can at least pass therethrough. More particularly, the discharge opening is preferably larger than a particle size of the developer (volume average particle size in the case of toner, number average particle size in the case of carrier) contained in the developer supply container 1. For example, in the case that the supply developer comprises two component non-magnetic toner and two component magnetic carrier, it is preferable that the discharge opening is larger than a larger particle size, that is, the number average particle size of the two component magnetic carrier.

Specifically, in the case that the supply developer comprises two component non-magnetic toner having a volume average particle size of 5.5 μm and a two component magnetic carrier having a number average particle size of 40 μm, the diameter of the discharge opening 1c is preferably not less than 0.05 mm (0.002 mm² in the opening area).

If, however, the size of the discharge opening 1c is too close to the particle size of the developer, the energy required for discharging a desired amount from the developer supply container 1, that is, the energy required for operating the pump 2 is large. It may be the case that a restriction is imparted to the manufacturing of the developer supply container 1. In order to mold the discharge opening 1c in a resin material part using an injection molding method, a metal mold part for forming the discharge opening 1c is used, and the durability of the metal mold part will be a problem. From the foregoing, the diameter φ of the discharge opening 3a is preferably not less than 0.5 mm.

In this example, the configuration of the discharge opening 1c is circular, but this is not inevitable. A square, a rectangular, an ellipse or a combination of lines and curves or the like are usable if the opening area is not more than 12.6 mm² which is the opening area corresponding to the diameter of 4 mm.

However, a circular discharge opening has a minimum circumferential edge length among the configurations having the same opening area, the edge being contaminated by the deposition of the developer. Therefore, the amount of the developer dispersing with the opening and closing operation of the shutter 5 is small, and therefore, the contamination is decreased. In addition, with the circular discharge opening, a resistance during discharging is also small, and a discharging property is high. Therefore, the configuration of the discharge opening 1c is preferably circular which is excellent in the balance between the discharge amount and the contamination prevention.

From the foregoing, the size of the discharge opening 1c is preferably such that the developer is not discharged sufficiently only by the gravitation in the state that the discharge opening 1c is directed downwardly (supposed supplying attitude into the developer replenishing apparatus 8). More particularly, a diameter φ of the discharge opening 1c is not less than 0.05 mm (0.002 mm² in the opening area) and not more than 4 mm (12.6 mm² in the opening area). Furthermore, the diameter φ of the discharge opening 1c is preferably not less than 0.5 mm (0.2 mm² in the opening area and not more than 4 mm (12.6 mm² in the opening area). In this example, on the basis of the foregoing investigation, the discharge opening 1c is circular, and the diameter φ of the opening is 2 mm.

In this example, the number of discharge openings 1c is one, but this is not inevitable, and a plurality of discharge openings 1c a total opening area of the opening areas satisfies the above-described range. For example, in place of one developer receiving port 8a having a diameter φ of 2 mm, two discharge openings 3a each having a diameter φ of 0.7 mm are employed. However, in this case, the discharge amount of the developer per unit time tends to decrease, and therefore, one discharge opening 1c having a diameter φ of 2 mm is preferable.

### (Developer Supplying Step)

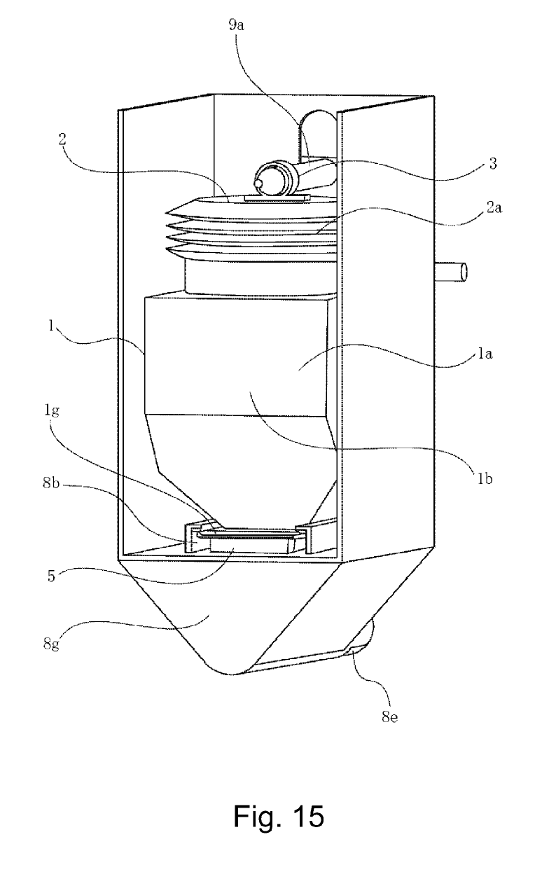

Referring to FIGS. 15-18, a developer supplying step by the pump portion will be described.

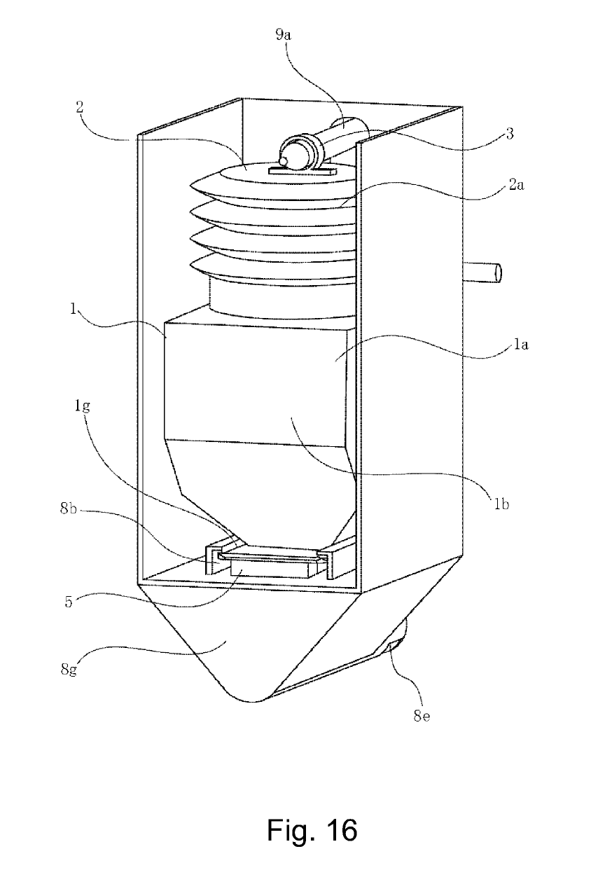

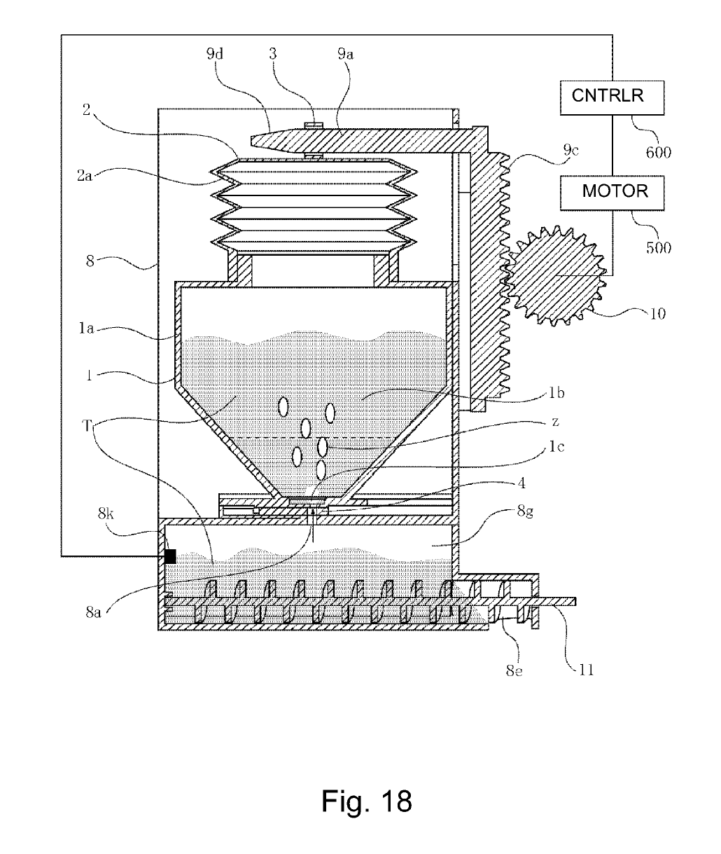

FIG. 15 is a schematic perspective view in which the expansion-and-contraction portion 2a of the pump 2 is contracted. FIG. 16 is a schematic perspective view in which the expansion-and-contraction portion 2a of the pump 2 is expanded. FIG. 17 is a schematic sectional view in which the expansion-and-contraction portion 2a of the pump 2 is contracted. FIG. 18 is a schematic sectional view in which the expansion-and-contraction portion 2a of the pump 2 is expanded.

In this example, as will be described hereinafter, the drive conversion of the rotational force is carries out by the drive converting mechanism so that the suction step (suction operation through discharge opening 3a) and the discharging step (discharging operation through the discharge opening 3a) are repeated alternately. The suction step and the discharging step will be described.

The description will be made as to a developer discharging principle using a pump.

The operation principle of the expansion-and-contraction portion 2a of the pump 2 is as has been in the foregoing. Stating briefly, as shown in FIG. 10, the lower end of the expansion-and-contraction portion 2a is connected to the container body 1a. The container body 1a is prevented in the movement in the p direction and in the q direction (FIG. 9) by the positioning guide 8b of the developer supplying apparatus 8 through the flange portion 1g at the lower end. Therefore, the vertical position of the lower end of the expansion-and-contraction portion 2a connected with the container body 1a is fixed relative to the developer replenishing apparatus 8.

On the other hand, the upper end of the expansion-and-contraction portion 2a is engaged with the locking member 9 through the locking portion 3, and is reciprocated in the p direction and in the q direction by the vertical movement of the locking member 9.

Since the lower end of the expansion-and-contraction portion 2a of the pump 2 is fixed, the portion thereabove expands and contracts.

The description will be made as to expanding-and-contracting operation (discharging operation and suction operation) of the expansion-and-contraction portion 2a of the pump 2 and the developer discharging.

### (Discharging Operation)

First, the discharging operation through the discharge opening 1c will be described.

With the downward movement of the locking member 9, the upper end of the expansion-and-contraction portion 2a displaces in the p direction (contraction of the expansion-and-contraction portion), by which discharging operation is effected. More particularly, with the discharging operation, the volume of the developer accommodating space 1b decreases. At this time, the inside of the container body 1a is sealed except for the discharge opening 1c, and therefore, until the developer is discharged, the discharge opening 1c is substantially clogged or closed by the developer, so that the volume in the developer accommodating space 1b decreases to increase the internal pressure of the developer accommodating space 1b.

At this time, the internal pressure of the developer accommodating space 1b is higher than the pressure in the hopper 8g (equivalent to the ambient pressure), and therefore, as shown in FIG. 17, the developer is discharged by the air pressure, that is, the pressure difference between the developer accommodating space 1b and the hopper 8g. Thus, the developer T is discharged from the developer accommodating space 1b into the hopper 8g. An arrow in FIG. 17 indicates a direction of a force applied to the developer T in the developer accommodating space 1b. Thereafter, the air in the developer accommodating space 1b is also discharged together with the developer, and therefore, the internal pressure of the developer accommodating space 1b decreases

### (Suction Operation)

The suction operation through the discharge opening 1c will be described.

With upward movement of the locking member 9, the upper end of the expansion-and-contraction portion 2a of the pump 2 displaces in the q direction (the expansion-and-contraction portion expands) so that the suction operation is effected. More particularly, the volume of the developer accommodating space 1b increases with the suction operation. At this time, the inside of the container body 1a is sealed except of the discharge opening 1c, and the discharge opening 1c is clogged by the developer and is substantially closed. Therefore, with the increase of the volume in the developer accommodating space 1b, the internal pressure of the developer accommodating space 1b decreases.

The internal pressure of the developer accommodating space 1b at this time becomes lower than the internal pressure in the hopper 8g (equivalent to the ambient pressure). Therefore, as shown in FIG. 18, the air in the upper portion in the hopper 8g enters the developer accommodating space 1b through the discharge opening 1c by the pressure difference between the developer accommodating space 1b and the hopper 8g. An arrow in FIG. 18 indicates a direction of a force applied to the developer T in the developer accommodating space 1b. Ovals Z in FIG. 18 schematically show the air taken in from the hopper 8g.

At this time, the air is taken-in from the outside of the developer supply device 8, and therefore, the developer in the neighborhood of the discharge opening 1c can be loosened. More particularly, the air impregnated into the developer powder existing in the neighborhood of the discharge opening 1c, reduces the bulk density of the developer powder and fluidizing.

In this manner, by the fluidization of the developer T, the developer T does not pack or clog in the discharge opening 3a, so that the developer can be smoothly discharged through the discharge opening 3a in the discharging operation which will be described hereinafter. Therefore, the amount of the developer T (per unit time) discharged through the discharge opening 3a can be maintained substantially at a constant level for a long term.

### (Change of Internal Pressure of Developer Accommodating Portion)

Verification experiments were carried out as to a change of the internal pressure of the developer supply container 1. The verification experiments will be described.

The developer is filled such that the developer accommodating space 1b in the developer supply container 1 is filled with the developer; and the change of the internal pressure of the developer supply container 1 is measured when the pump 2 is expanded and contracted in the range of 15 cm³ of volume change. The internal pressure of the developer supply container 1 is measured using a pressure gauge (AP-C40 available from Kabushiki Kaisha KEYENCE) connected with the developer supply container 1.

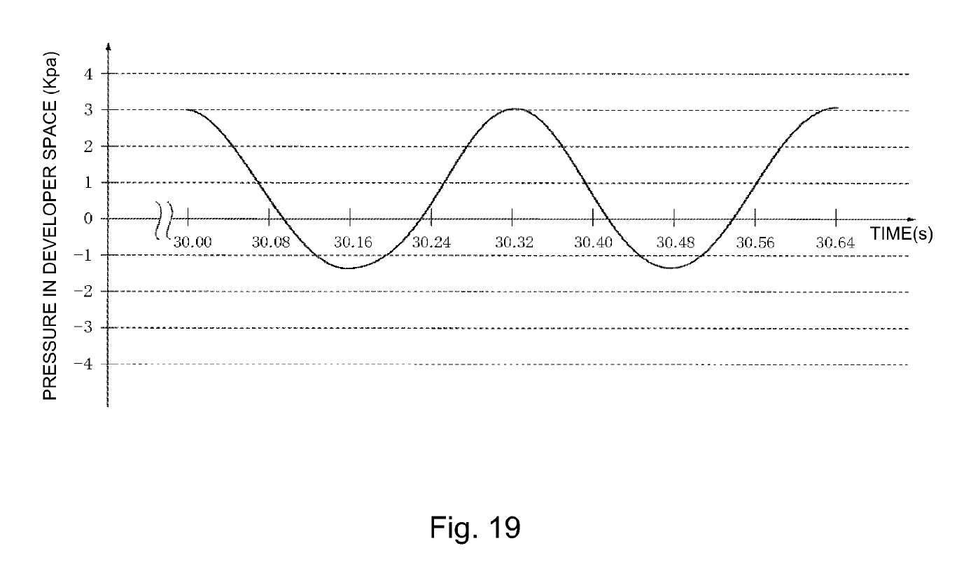

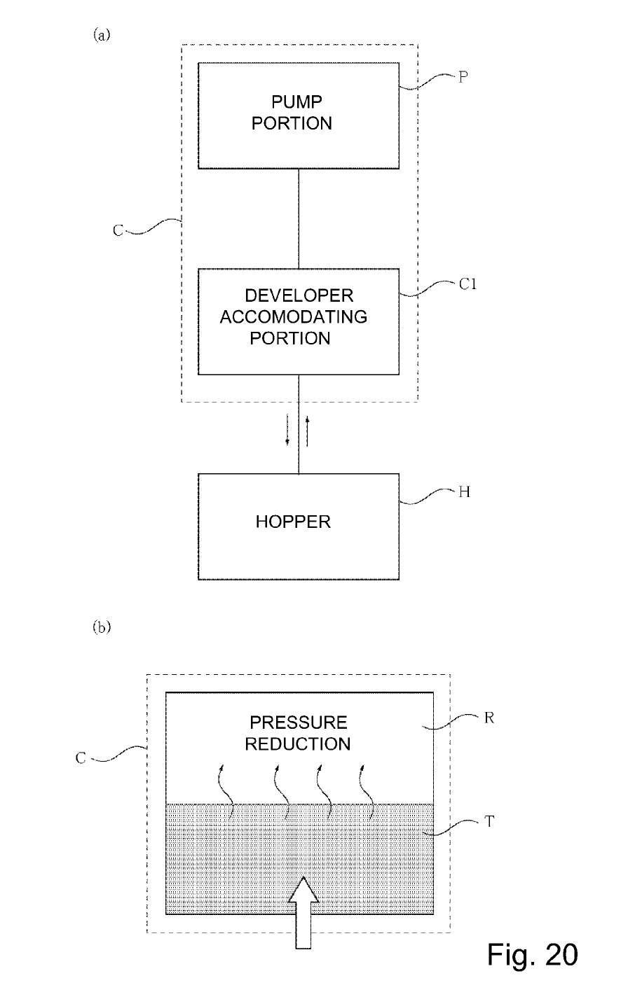

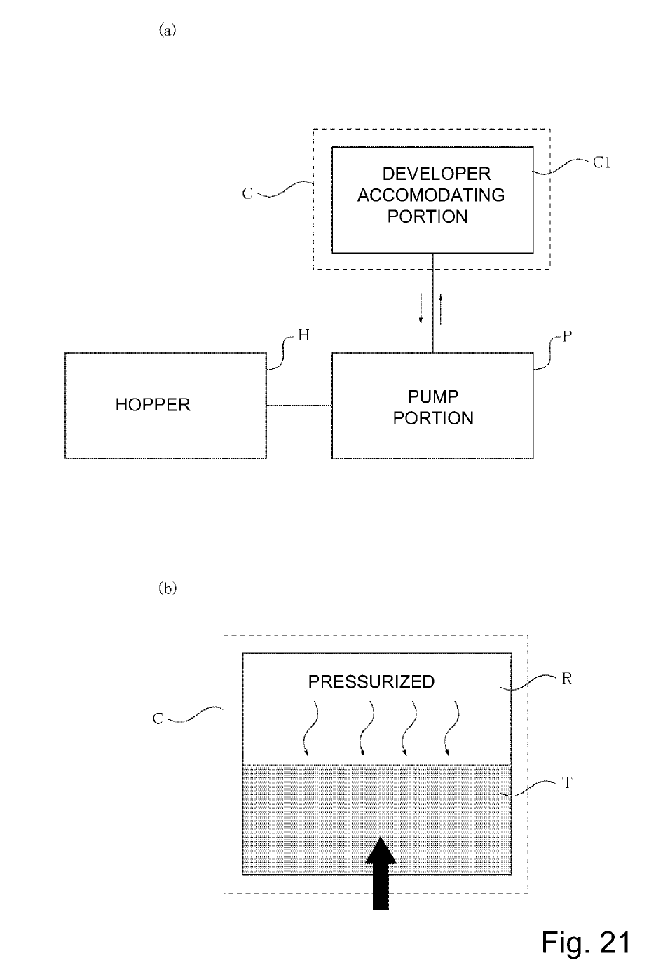

FIG. 19 shows a pressure change when the pump 2 is expanded and contracted in the state that the shutter 5 of the developer supply container 1 filled with the developer is open, and therefore, in the communicatable state with the outside air.

In FIG. 19, the abscissa represents the time, and the ordinate represents a relative pressure in the developer supply container 1 relative to the ambient pressure (reference (0)) (+ is a positive pressure side, and − is a negative pressure side).

When the internal pressure of the developer supply container 1 becomes negative relative to the outside ambient pressure by the increase of the volume of the developer supply container 1, the air is taken in through the discharge opening 1c by the pressure difference. When the internal pressure of the developer supply container 1 becomes positive relative to the outside ambient pressure by the decrease of the volume of the developer supply container 1, a pressure is imparted to the inside developer. At this time, the inside pressure eases corresponding to the discharged developer and air.

By the verification experiments, it has been confirmed that by the increase of the volume of the developer supply container 1, the internal pressure of the developer supply container 1 becomes negative relative to the outside ambient pressure, and the air is taken in by the pressure difference. In addition, it has been confirmed that by the decrease of the volume of the developer supply container 1, the internal pressure of the developer supply container 1 becomes positive relative to the outside ambient pressure, and the pressure is imparted to the inside developer so that the developer is discharged. In the verification experiments, an absolute value of the negative pressure is 1.3 kPa, and an absolute value of the positive pressure is 3.0 kPa.

As described in the foregoing, with the structure of the developer supply container 1 of this example, the internal pressure of the developer supply container 1 switches between the negative pressure and the positive pressure alternately by the suction operation and the discharging operation of the pump portion 2b, and the discharging of the developer is carried out properly.

As described in the foregoing, the example, a simple and easy pump capable of effecting the suction operation and the discharging operation of the developer supply container 1 is provided, by which the discharging of the developer by the air can be carries out stably while providing the developer loosening effect by the air.

In other words, with the structure of the example, even when the size of the discharge opening 1c is extremely small, a high discharging performance can be assured without imparting great stress to the developer since the developer can be passed through the discharge opening 1c in the state that the bulk density is small because of the fluidization.

In addition, in this example, the inside of the displacement type pump 2 is utilized as a developer accommodating space, and therefore, when the internal pressure is reduced by increasing the volume of the pump 2, a additional developer accommodating space can be formed. Therefore, even when the inside of the pump 2 is filled with the developer, the bulk density can be decreased (the developer can be fluidized) by impregnating the air in the developer powder. Therefore, the developer can be filled in the developer supply container 1 with a higher density than in the conventional art.

In the foregoing, the inside space in the pump 2 is used as a developer accommodating space 1b, but in an alternative, a filter which permits passage of the air but prevents passage of the toner may be provided to partition between the pump 2 and the developer accommodating space 1b. However, the embodiment described in the form of is preferable in that when the volume of the pump increases, an additional developer accommodating space can be provided.

### (Developer Loosening Effect in Suction Step)

Verification has been carried out as to the developer loosening effect by the suction operation through the discharge opening 3a in the suction step. When the developer loosening effect by the suction operation through the discharge opening 3a is significant, a low discharge pressure (small volume change of the pump) is enough, in the subsequent discharging step, to start immediately the discharging of the developer from the developer supply container 1. This verification is to demonstrate remarkable enhancement of the developer loosening effect in the structure of this example. This will be described in detail.

Part (a) of FIG. 20 and part (a) of FIG. 21 are block diagrams schematically showing a structure of the developer supplying system used in the verification experiment. Part (b) of FIG. 20 and part (b) of FIG. 21 are schematic views showing a phenomenon-occurring in the developer supply container. The system of FIG. 20 is analogous to this example, and a developer supply container C is provided with a developer accommodating portion C1 and a pump portion P. By the expanding-and-contracting operation of the pump portion P, the suction operation and the discharging operation through a discharge opening (the discharge opening 1c of this example (unshown)) of the developer supply container C are carried out alternately to discharge the developer into a hopper H. On the other hand, the system of FIG. 21 is a comparison example wherein a pump portion P is provided in the developer replenishing apparatus side, and by the expanding-and-contracting operation of the pump portion P, an air-supply operation into the developer accommodating portion C1 and the suction operation from the developer accommodating portion C1 are carried out alternately to discharge the developer into a hopper H. In FIGS. 20, 21, the developer accommodating portions C1 have the same internal volumes, the hoppers H have the same internal volumes, and the pump portions P have the same internal volumes (volume change amounts).

First, 200 g of the developer is filled into the developer supply container C.

Then, the developer supply container C is shaken for 15 minutes in view of the state later transportation, and thereafter, it is connected to the hopper H.

The pump portion P is operated, and a peak value of the internal pressure in the suction operation is measured as a condition of the suction step required for starting the developer discharging immediately in the discharging step. In the case of FIG. 20, the start position of the operation of the pump portion P corresponds to 480 cm³ of the volume of the developer accommodating portion C1, and in the case of FIG. 15, the start position of the operation of the pump portion P corresponds to 480 cm³ of the volume of the hopper H.

In the experiments of the structure of FIG. 15, the hopper H is filled with 200 g of the developer beforehand to make the conditions of the air volume the same as with the structure of FIG. 14. The internal pressures of the developer accommodating portion C1 and the hopper H are measured by the pressure gauge (AP-C40 available from Kabushiki Kaisha KEYENCE) connected to the developer accommodating portion C1.

As a result of the verification, according to the system analogous to this example shown in FIG. 20, if the absolute value of the peak value (negative pressure) of the internal pressure at the time of the suction operation is at least 1.0 kPa, the developer discharging can be immediately started in the subsequent discharging step. In the comparison example system shown in FIG. 21, on the other hand, unless the absolute value of the peak value (positive pressure) of the internal pressure at the time of the suction operation is at least 1.7 kPa, the developer discharging cannot be immediately started in the subsequent discharging step.

It has been confirmed that using the system of FIG. 20 similar to the example, the suction is carries out with the volume increase of the pump portion P, and therefore, the internal pressure of the developer supply container C can be lower (negative pressure side) than the ambient pressure (pressure outside the container), so that the developer solution effect is remarkably high. This is because as shown in part (b) of FIG. 14, the volume increase of the developer accommodating portion C1 with the expansion of the pump portion P provides pressure reduction state (relative to the ambient pressure) of the upper portion air layer of the developer layer T. For this reason, the forces are applied in the directions to increase the volume of the developer layer T due to the decompression (wave line arrows), and therefore, the developer layer can be loosened efficiently. Furthermore, in the system of FIG. 20, the air is taken in from the outside into the developer supply container C1 by the decompression (white arrow), and the developer layer T is solved also when the air reaches the air layer R, and therefore, it is a very good system.

As a proof of the loosening of the developer in the developer supply container C in the, experiments, it has been confirmed that in the suction operation, the apparent volume of the whole developer increases (the level of the developer rises).

In the case of the system of the comparison example shown in FIG. 21, the internal pressure of the developer supply container C is raised by the air-supply operation to the developer supply container C up to a positive pressure (higher than the ambient pressure), and therefore, the developer is agglomerated, and the developer solution effect is not obtained. This is because as shown in part (b) of FIG. 21, the air is fed forcedly from the outside of the developer supply container C, and therefore, the air layer R above the developer layer T becomes positive relative to the ambient pressure. For this reason, the forces are applied in the directions to decrease the volume of the developer layer T due to the pressure (wave line arrows), and therefore, the developer layer T is packed. Actually, a phenomenon has been confirmed that the apparent volume of the whole developer in the developer supply container C increases upon the suction operation in the comparison example. Accordingly, with the system of FIG. 21, there is a liability that the packing of the developer layer T disables subsequent proper developer discharging step.

In order to prevent the packing of the developer layer T by the pressure of the air layer R, it would be considered that an air vent with a filter or the like is provided at a position corresponding to the air layer R thereby reducing the pressure rise. However, in such a case, the flow resistance of the filter or the like leads to a pressure rise of the air layer R. Even if the pressure rise were eliminated, the loosening effect by the pressure reduction state of the air layer R described above cannot be provided.

From the foregoing, the significance of the function of the suction operation a discharge opening with the volume increase of the pump portion by employing the system of this example has been confirmed.

As described above, by the repeated alternate suction operation and the discharging operation of the pump 2, the developer can be discharged through the discharge opening 1c of the developer supply container 1. That is, in this example, the discharging operation and the suction operation are not in parallel or simultaneous, but are alternately repeated, and therefore, the energy required for the discharging of the developer can be minimized.

On the other hand, in the case that the developer replenishing apparatus includes the air-supply pump and the suction pump, separately, it is necessary to control the operations of the two pumps, and in addition it is not easy to rapidly switch the air-supply and the suction alternately.

In this example, one pump is effective to efficiently discharge the developer, and therefore, the structure of the developer discharging mechanism can be simplified.

In the foregoing, the discharging operation and the suction operation of the pump are repeated alternately to efficiently discharge the developer, but in an alternative structure, the discharging operation or the suction operation is temporarily stopped and then resumed.

For example, the discharging operation of the pump is not effected monotonically, but the compressing operation may be once stopped partway and then resumed to discharge. The same applies to the suction operation. Each operation may be made in a multi-stage form as long as the discharge amount and the discharging speed are enough. It is still necessary that after the multi-stage discharging operation, the suction operation is effected, and they are repeated.

In this example, the internal pressure of the developer accommodating space 1b is reduced to take the air through the discharge opening 1c to loosen the developer. On the other hand, in the above-described conventional example, the developer is loosened by feeding the air into the developer accommodating space 1b from the outside of the developer supply container 1, but at this time, the internal pressure of the developer accommodating space 1b is in a compressed state with the result of agglomeration of the developer. This example is preferable since the developer is loosened in the pressure reduced state in which is the developer is not easily agglomerated.

### Embodiment 2

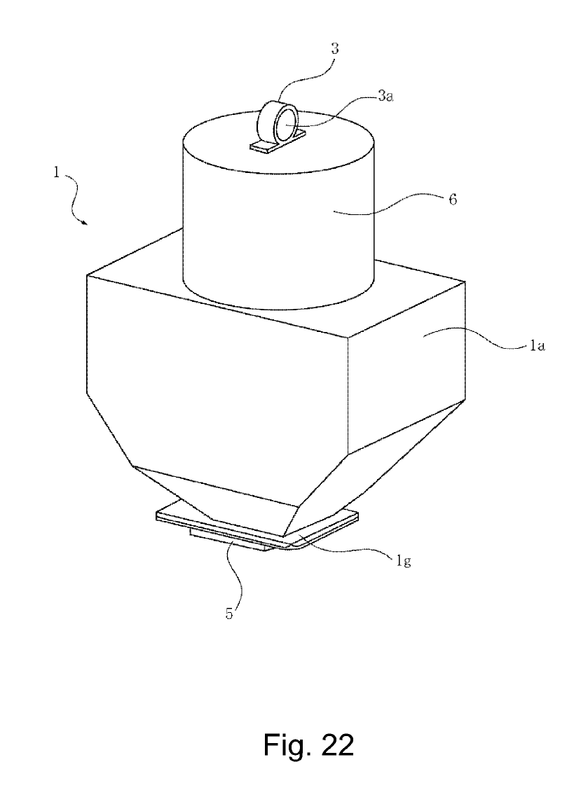

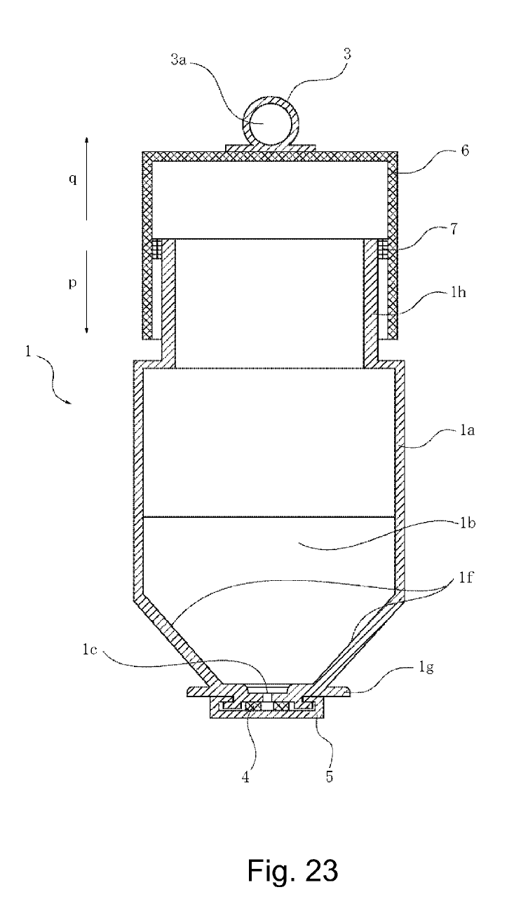

Referring to FIGS. 22, 23, a structure of the Embodiment 2 will be described. FIG. 22 is a schematic perspective view of a developer supply container 1, and FIG. 23 is a schematic sectional view of the developer supply container 1. In this example, the structure of the pump is different from that of Embodiment 1, and the other structures are substantially the same as with Embodiment 1. In the description of this embodiment, the same reference numerals as in Embodiment 1 are assigned to the elements having the corresponding functions in this embodiment, and the detailed description thereof is omitted.

In this example, as shown in FIGS. 22, 23, a plunger type pump is used in place of the bellow-like displacement type pump as in Embodiment 1. The plunger type pump includes an inner cylindrical portion 1h and an outer cylindrical portion 6 extending outside the outer surface of the inner cylindrical portion 1h and movable relative to the inner cylindrical portion 1h. The upper surface of the outer cylindrical portion 6 is provided with locking portion 3 fixed by bonding similarly to Embodiment 1. More particularly, the locking portion 3 fixed to the upper surface of the outer cylindrical portion 6 receives a locking member 9 of the developer replenishing apparatus 8, by which they a substantially unified, the outer cylindrical portion 6 can move in the up and down directions (reciprocation) together with the locking member 9.

The inner cylindrical portion 1h is connected with the container body 1a, and the inside space thereof functions as a developer accommodating space 1b.

In order to prevent leakage of the air through a gap between the inner cylindrical portion 1h and the outer cylindrical portion 6 (to prevent leakage of the developer by keeping the hermetical property), an elastic seal 7 is fixed by bonding on the outer surface of the inner cylindrical portion 1h. The elastic seal 7 is compressed between the inner cylindrical portion 1h and the outer cylindrical portion 6.

Therefore, by reciprocating the outer cylindrical portion 6 in the p direction and the q direction relative to the container body 1a (inner cylindrical portion 1h) fixed non-movably to the developer replenishing apparatus 8, the volume in the developer accommodating space 1b can be changed. That is, the internal pressure of the developer accommodating space 1b can be repeated alternately between the negative pressure state and the positive pressure state.

Thus, also in this example, one pump is enough to effect the suction operation and the discharging operation, and therefore, the structure of the developer discharging mechanism can be simplified. In addition, by the suction operation through the discharge opening, a decompressed state (negative pressure state) can be provided in the developer accommodation supply container, and therefore, the developer can be efficiently loosened.

In this example, the configuration of the outer cylindrical portion 6 is cylindrical, but may be of another form, such as a rectangular section. In such a case, it is preferable that the configuration of the inner cylindrical portion 1h meets the configuration of the outer cylindrical portion 6. The pump is not limited to the plunger type pump, but may be a piston pump.

When the pump of this example is used, the seal structure is required to prevent developer leakage through the gap between the inner cylinder and the outer cylinder, resulting in a complicated structure and necessity for a large driving force for driving the pump portion, and therefore, Embodiment 1 is preferable.

### Embodiment 3

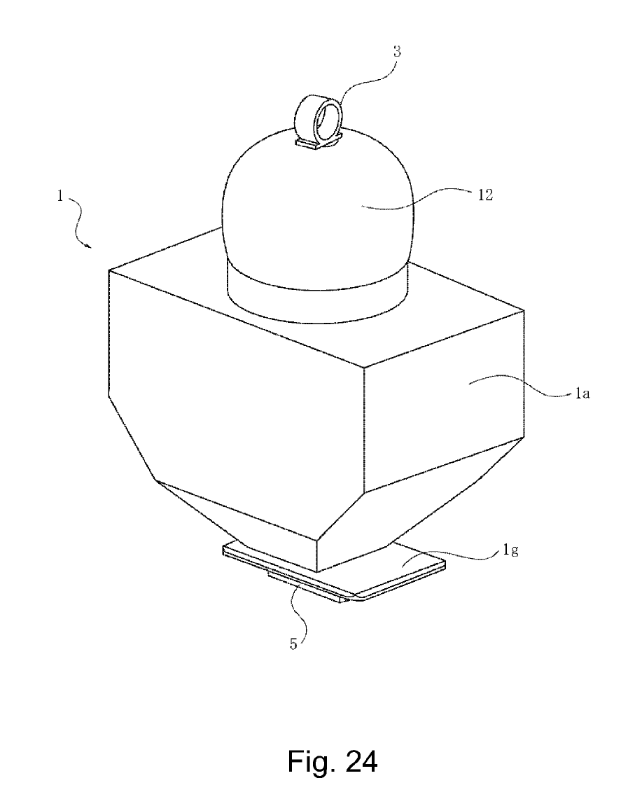

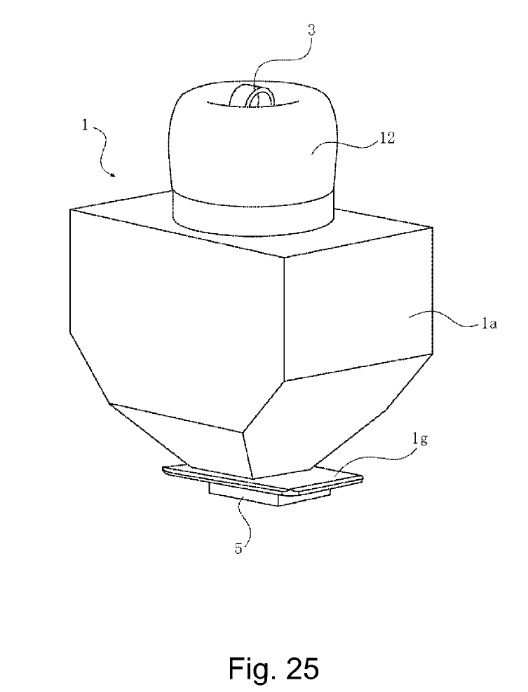

Referring to FIGS. 24, 25, a structure of Embodiment 3 will be described. FIG. 24 is a perspective view of an outer appearance in which a pump 12 of a developer supply container 1 according to this embodiment is in an expanded state, and FIG. 25 is a perspective view of an outer appearance in which the pump 12 of the developer supply container 1 is in a contracted state. In this example, the structure of the pump is different from that of Embodiment 1, and the other structures are substantially the same as with Embodiment 1. In the description of this embodiment, the same reference numerals as in Embodiment 1 are assigned to the elements having the corresponding functions in this embodiment, and the detailed description thereof is omitted.

In this example, as shown in FIGS. 24, 25, in place of a bellow-like pump having folded portions of Embodiment 1, a film-like pump 12 capable of expansion and contraction not having a folded portion is used. The film-like portion of the pump 12 is made of rubber. The material of the film-like portion of the pump 12 may be a flexible material such as resin film rather than the rubber.

The film-like pump 12 is connected with the container body 1a, and the inside space thereof functions as a developer accommodating space 1b. The upper portion of the film-like pump 12 is provided with a locking portion 3 fixed thereto by bonding, similarly to the foregoing embodiments. Therefore, the pump 12 can alternately repeat the expansion and the contraction by the vertical movement of the locking member 9.

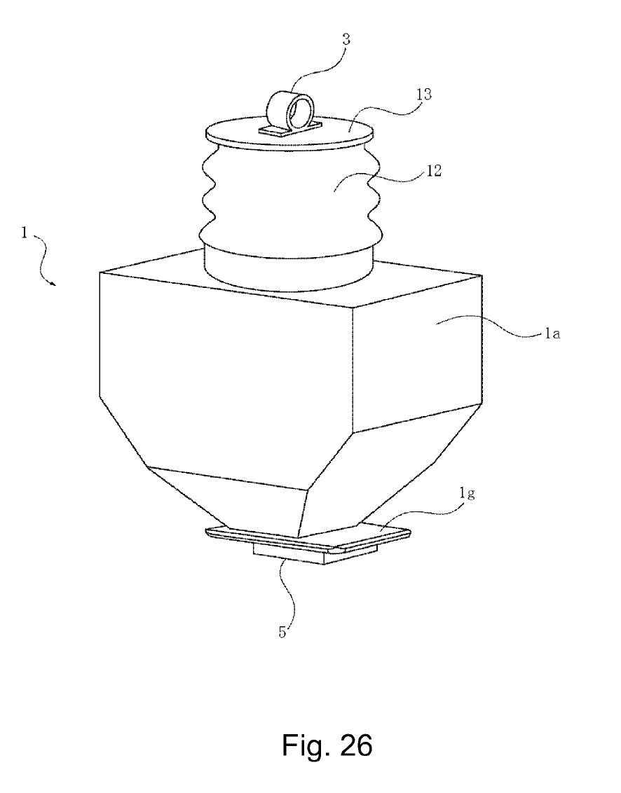

In this manner, also in this example, one pump is enough to effect both of the suction operation and the discharging operation, and therefore, the structure of the developer discharging mechanism can be simplified. In addition, by the suction operation through the discharge opening, a pressure reduction state (negative pressure state) can be provided in the developer supply container, and therefore, the developer can be efficiently loosened. In the case of this example, as shown in FIG. 26, it is preferable that a plate-like member 13 having a higher rigid than the film-like portion is mounted to the upper surface of the film-like portion of the pump 12, and the locking portion 3 is provided on the plate-like member 13. With such a structure, it can be suppressed that the amount of the volume change of the pump 12 decreases due to deformation of only the neighborhood of the locking portion 3 of the pump 12. That is, the followability of the pump 12 to the vertical movement of the locking member 9 can be improved, and therefore, the expansion and the contraction of the pump 12 can be effected efficiently. Thus, the discharging property of the developer can be improved.

### Embodiment 4

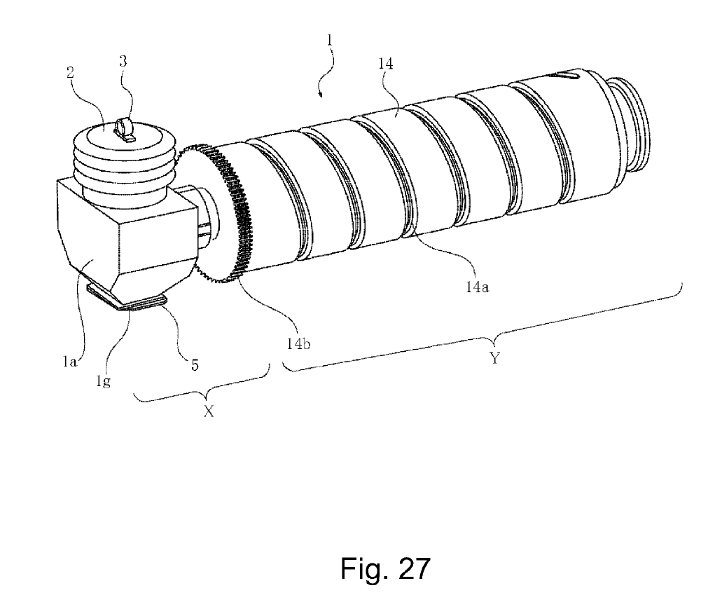

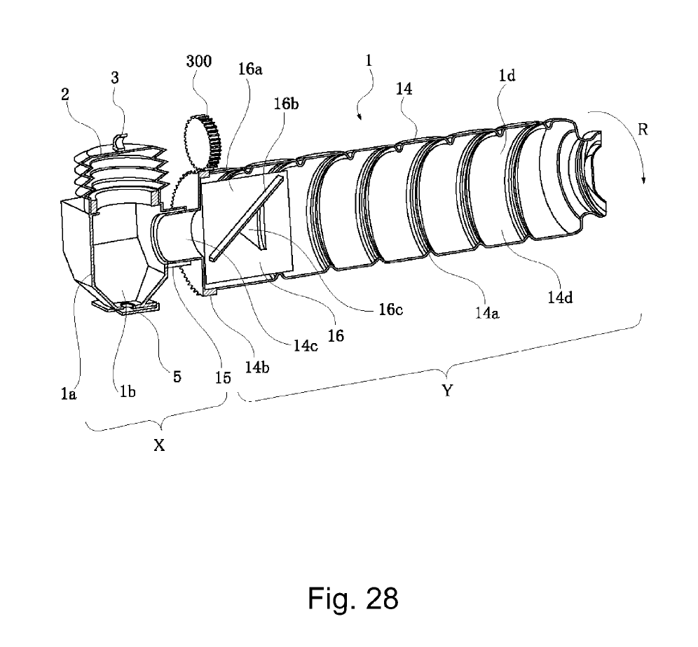

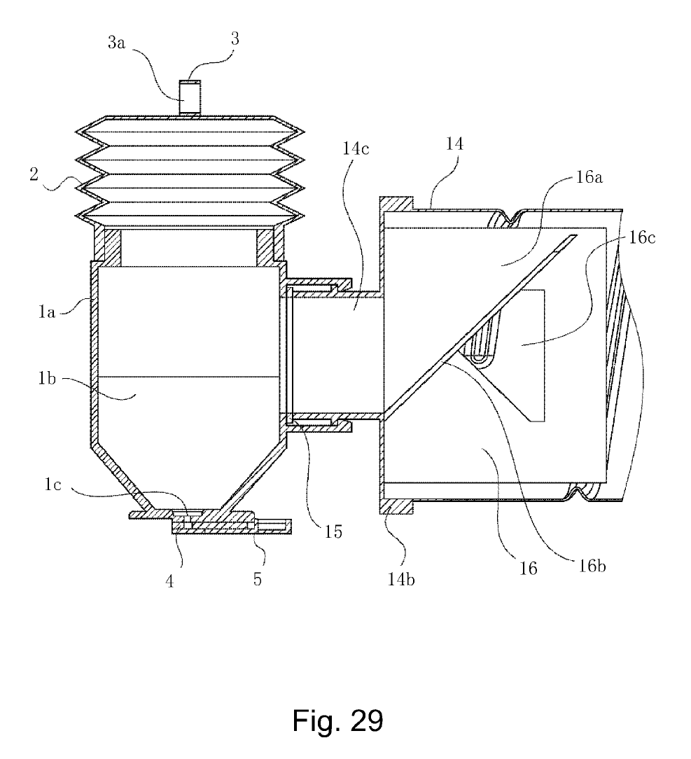

Referring to FIGS. 27-29, a structure of the Embodiment 4 will be described. FIG. 27 is a perspective view of an outer appearance of a developer supply container 1, FIG. 28 is a sectional perspective view of the developer supply container 1, FIG. 29 is a partially sectional view of the developer supply container 1 In this example, the structure is different from that of Embodiment 1 only in the structure of a developer accommodating space, and the other structure is substantially the same. In the description of this embodiment, the same reference numerals as in Embodiment 1 are assigned to the elements having the corresponding functions in this embodiment, and the detailed description thereof is omitted. As shown in FIGS. 27, 28, the developer supply container 1 of this example comprises two components, namely, a portion X including a container body 1a and a pump 2 and a portion Y including a cylindrical portion 14. The structure of the portion X of the developer supply container 1 is substantially the same as that of Embodiment 1, and therefore, detailed description thereof is omitted.

### (Structure of Developer Supply Container)

In the developer supply container 1 of this example, as contrasted to Embodiment 1, the cylindrical portion 14 is connected by a cylindrical portion 14 to a side of the portion X a discharging portion in which a discharge opening 1c is formed).

The cylindrical portion (developer accommodation rotatable portion) 14 has a closed end at one longitudinal end thereof and an open end at the other end which is connected with an opening of the portion X, and the space therebetween is a developer accommodating space 1b. In this example, an inside space of the container body 1a, an inside space of the pump 2 and the inside space of the cylindrical portion 14 are all developer accommodating space 1b, and therefore, a large amount of the developer can be accommodated. In this example, the cylindrical portion 14 as the developer accommodation rotatable portion has a circular cross-sectional configuration, but the circular shape is not restrictive to the present invention. For example, the cross-sectional configuration of the developer accommodation rotatable portion may be of non-circular configuration such as a polygonal configuration as long as the rotational motion is not obstructed during the developer feeding operation.

An inside of the cylindrical portion 14 is provided with a helical feeding projection (feeding portion) 14a, which has a function of feeding the developer accommodated therein toward the portion X (discharge opening 1c) when the cylindrical portion 14 rotates in a direction indicated by an arrow R.

In addition, the inside of the cylindrical portion 14 is provided with a receiving-and-feeding member (feeding portion) 16 for receiving the developer fed by the feeding projection 14a and supplying it to the portion X side by rotation of the cylindrical portion 14 in the direction R (the rotational axis is substantially extends in the horizontal direction), the moving member upstanding from the inside of the cylindrical portion 14. The receiving-and-feeding member 16 is provided with a plate-like portion 16a for scooping the developer up, and inclined projections 16b for feeding (guiding) the developer scooped up by the plate-like portion 16a toward the portion X, the inclined projections 16b being provided on respective sides of the plate-like portion 16a. The plate-like portion 16a is provided with a through-hole 16c for permitting passage of the developer in both directions to improve the stirring property for the developer.

In addition, a gear portion 14b as a drive inputting portion is fixed by bonding on an outer surface at one longitudinal end (with respect to the feeding direction of the developer) of the cylindrical portion 14. When the developer supply container 1 is mounted to the developer replenishing apparatus 8, the gear portion 14b engages with the driving gear 300 functioning as a driving mechanism provided in the developer replenishing apparatus 8. When the rotational force is inputted to the gear portion 14b as the rotational force receiving portion from the driving gear 300, the cylindrical portion 14 rotates in the direction R (FIG. 28). The gear portion 14b is not restrictive to the present invention, but another drive inputting mechanism such as a belt or friction wheel is usable as long as it can rotate the cylindrical portion 14.

As shown in FIG. 29, one longitudinal end of the cylindrical portion 14 (downstream end with respect to the developer feeding direction) is provided with a connecting portion 14c as a connecting tube for connection with portion X. The above-described inclined projection 16b extends to a neighborhood of the connecting portion 14c. Therefore, the developer fed by the inclined projection 16b is prevented as much as possible from falling toward the bottom side of the cylindrical portion 14 again, so that the developer is properly supplied to the connecting portion 14c.

The cylindrical portion 14 rotates as described above, but on the contrary, the container body 1a and the pump 2 are connected to the cylindrical portion 14 through a flange portion 1g so that the container body 1a and the pump 2 are non-rotatable relative to the developer replenishing apparatus 8 (non-rotatable in the rotational axis direction of the cylindrical portion 14 and non-movable in the rotational moving direction), similarly to Embodiment 1. Therefore, the cylindrical portion 14 is rotatable relative to the container body 1a.

A ring-like elastic seal 15 is provided between the cylindrical portion 14 and the container body 1a and is compressed by a predetermined amount between the cylindrical portion 14 and the container body 1a. By this, the developer leakage there is prevented during the rotation of the cylindrical portion 14. In addition, the structure, the hermetical property can be maintained, and therefore, the loosening and discharging effects by the pump 2 are applied to the developer without loss. The developer supply container 1 does not have an opening for substantial fluid communication between the inside and the outside except for the discharge opening 1c.

### (Developer Supplying Step)

A developer supplying step will be described.

When the operator inserts the developer supply container 1 into the developer replenishing apparatus 8, similarly to Embodiment 1, the locking portion 3 of the developer supply container 1 is locked with the locking member 9 of the developer replenishing apparatus 8, and the gear portion 14b of the developer supply container 1 is engaged with the driving gear 300 of the developer replenishing apparatus 8.

Thereafter, the driving gear 300 is rotated by another driving motor (not shown) for rotation, and the locking member 9 is driven in the vertical direction by the above-described driving motor 500. Then, the cylindrical portion 14 rotates in the direction R, by which the developer therein is fed to the receiving-and-feeding member 16 by the feeding projection 14a. In addition, by the rotation of the cylindrical portion 14 in the direction R, the receiving-and-feeding member 16 scoops the developer, and feeds it to the connecting portion 14c. The developer fed into the container body 1a from the connecting portion 14c is discharged from the discharge opening 1c by the expanding-and-contracting operation of the pump 2, similarly to Embodiment 1.

These are a series of the developer supply container 1 mounting steps and developer supplying steps. Hen the developer supply container 1 is exchanged, the operator takes the developer supply container 1 out of the developer replenishing apparatus 8, and a new developer supply container 1 is inserted and mounted.

In the case of a vertical container having a developer accommodating space 1b which is long in the vertical direction, if the volume of the developer supply container 1 is increased to increase the filling amount, the developer results in concentrating to the neighborhood of the discharge opening 1c by the weight of the developer. As a result, the developer adjacent the discharge opening 1c tends to be compacted, leading to difficulty in suction and discharge through the discharge opening 1c. In such a case, in order to loosen the developer compacted by the suction through the discharge opening 1c or to discharge the developer by the discharging, the internal pressure (negative pressure/positive pressure) of the developer accommodating space 1b has to be enhanced by increasing the amount of the change of the pump 2 volume. Then, the driving forces or drive the pump 2 has to be increased, and the load to the main assembly of the image forming apparatus 100 may be excessive.

According to this embodiment, however, container body 1a and the portion X of the pump 2 are arranged in the horizontal direction, and therefore, the thickness of the developer layer above the discharge opening 1c in the container body 1a can be thinner than in the structure of FIG. 9 By doing so, the developer is not easily compacted by the gravity, and therefore, the developer can be stably discharged without load to the main assembly of the image forming apparatus 100.

As described, with the structure of this example, the provision of the cylindrical portion 14 is effective to accomplish a large capacity developer supply container 1 without load to the main assembly of the image forming apparatus.

In this manner, also in this example, one pump is enough to effect both of the suction operation and the discharging operation, and therefore, the structure of the developer discharging mechanism can be simplified.

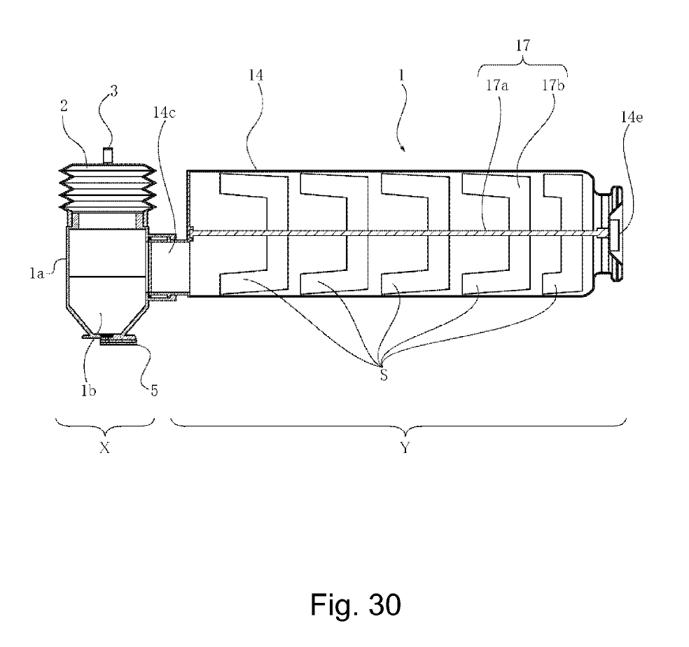

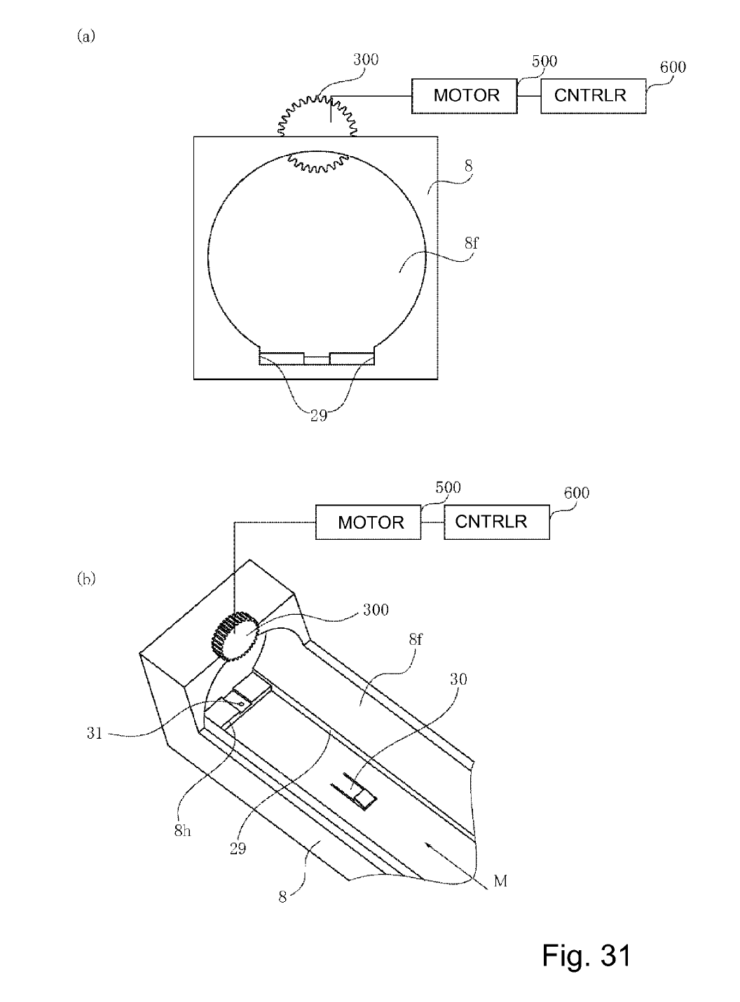

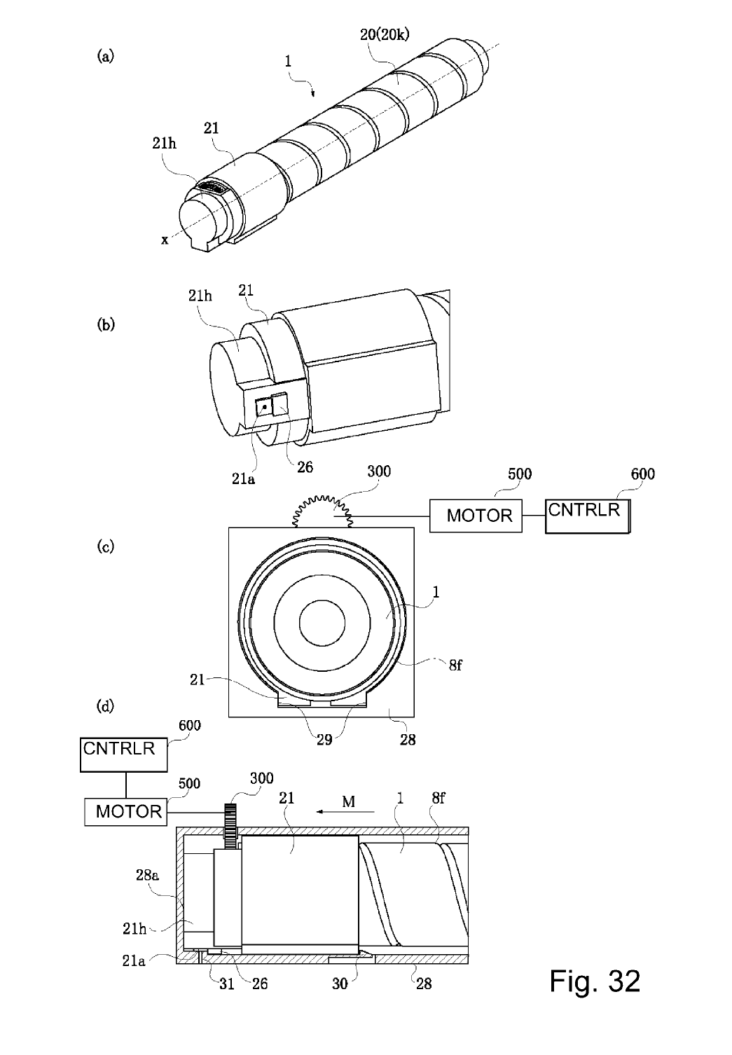

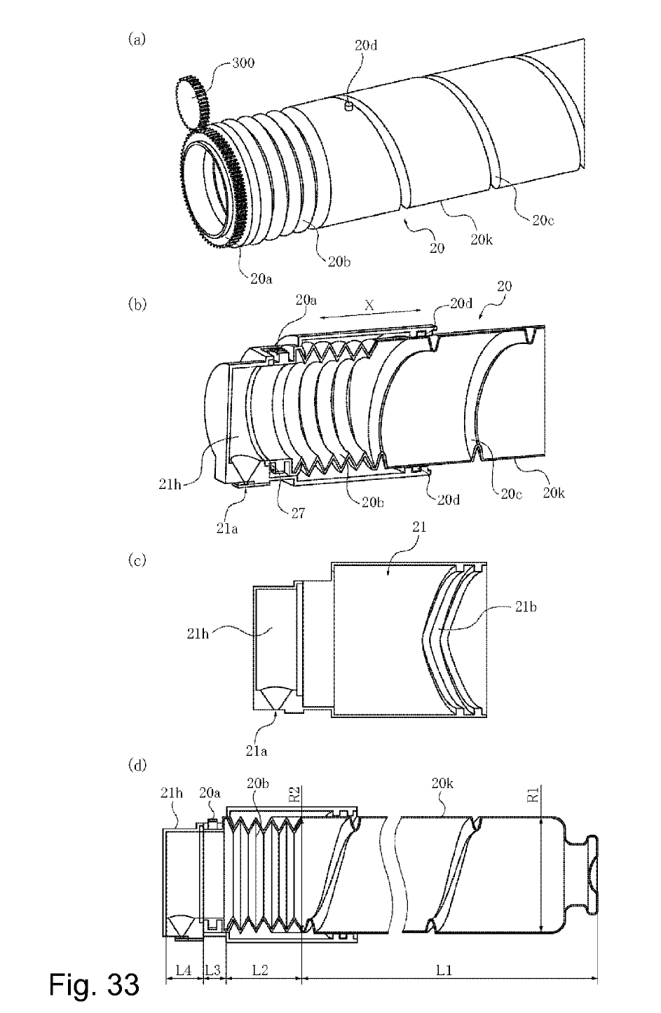

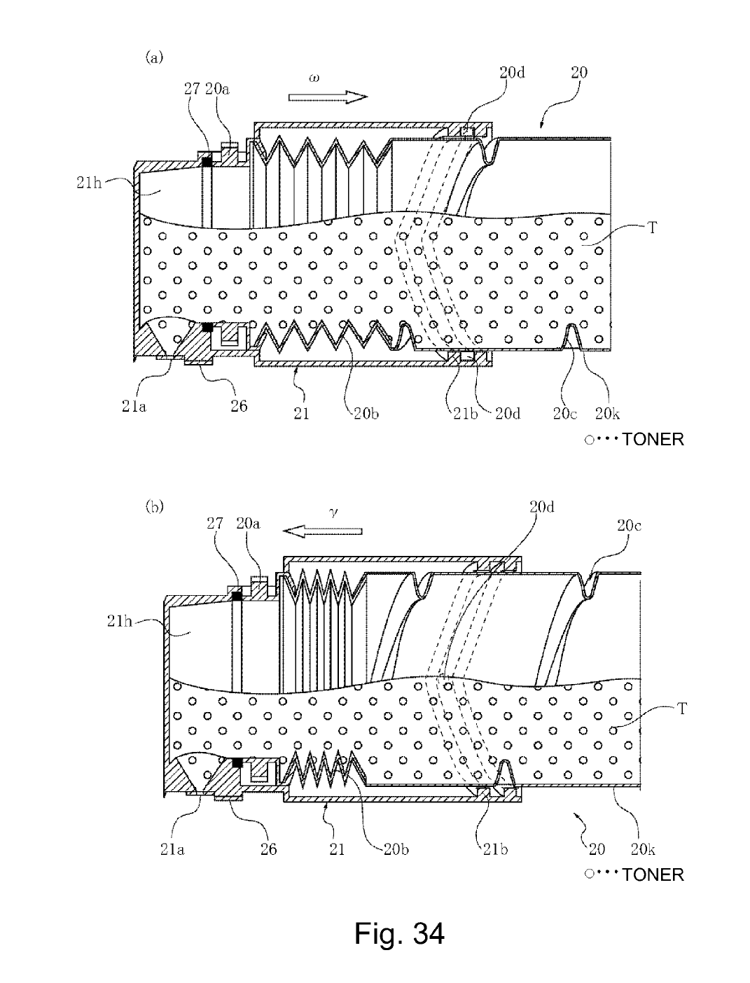

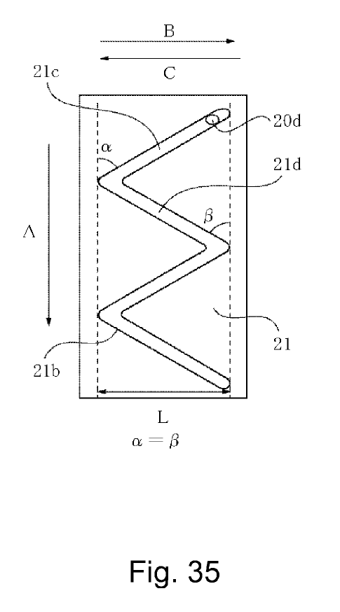

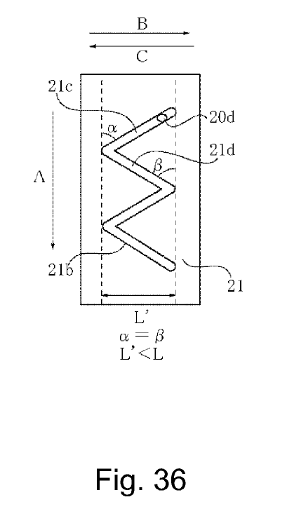

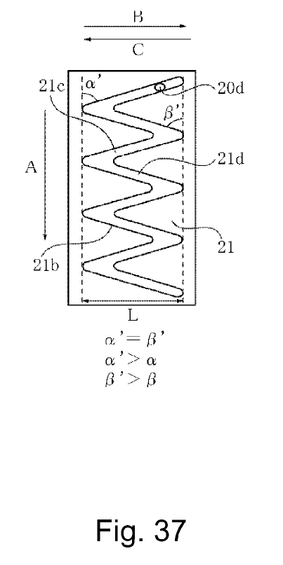

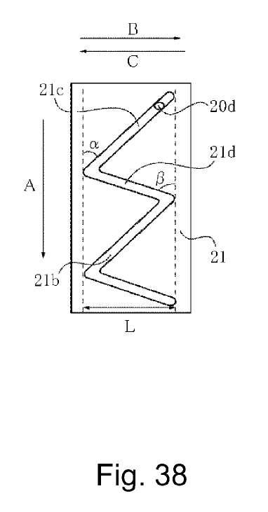

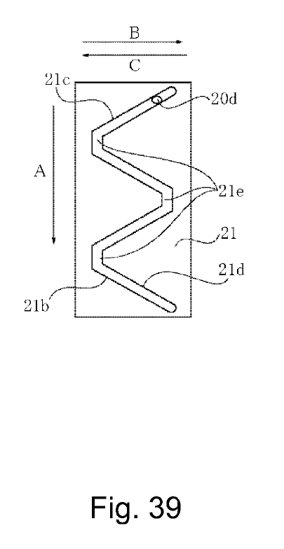

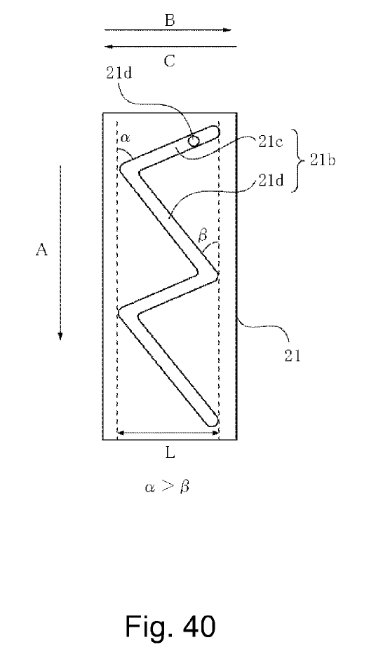

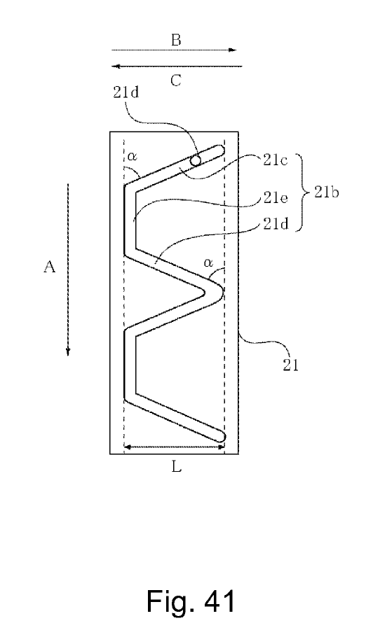

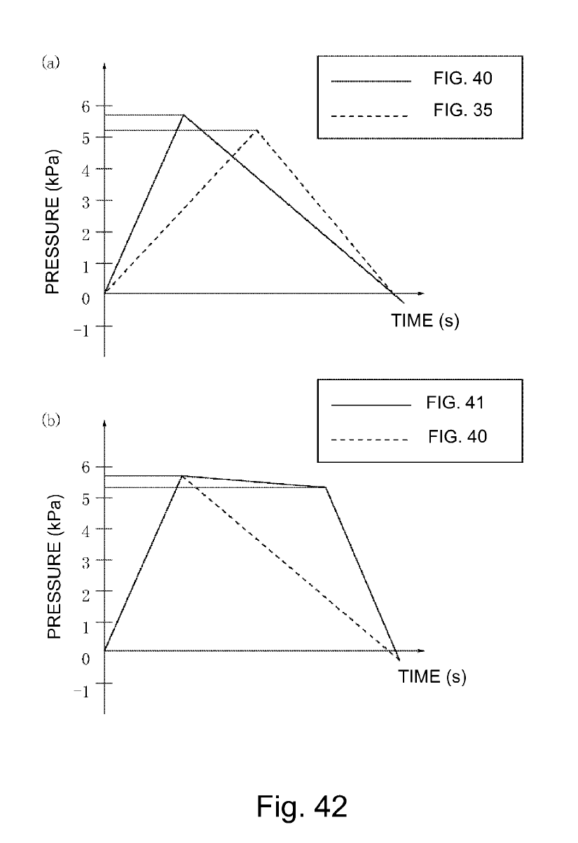

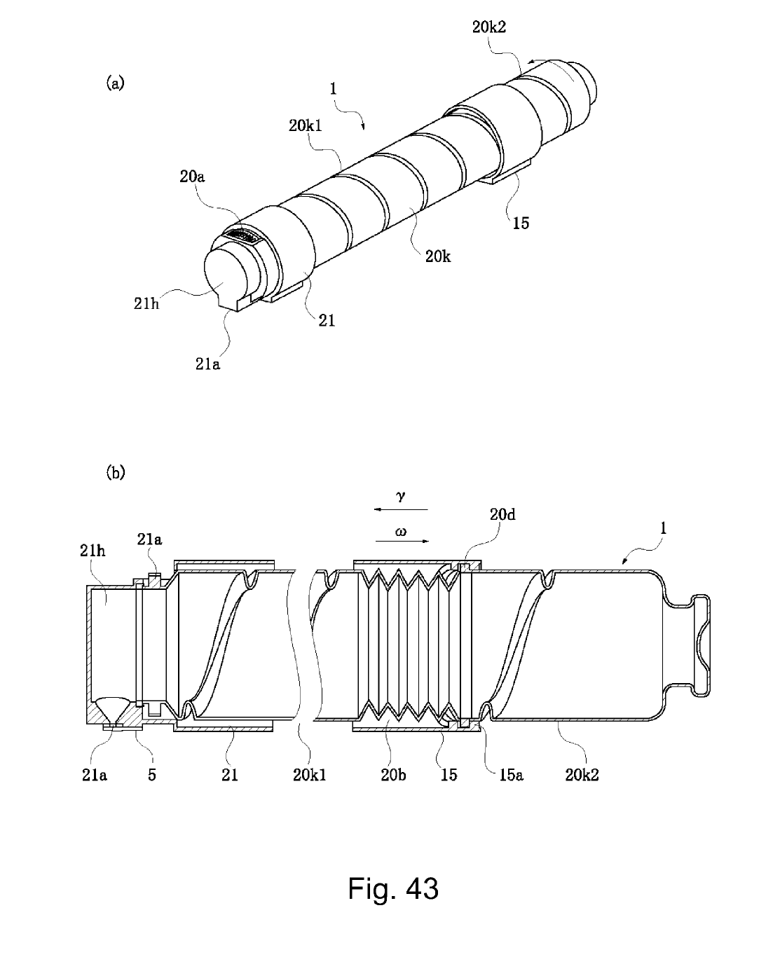

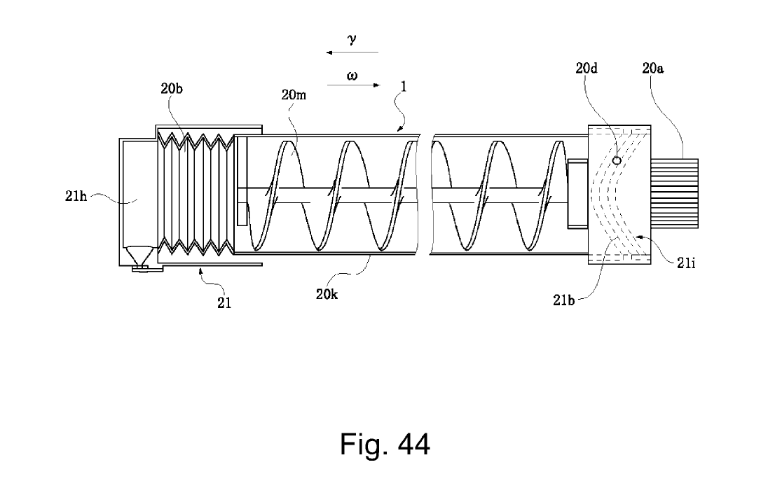

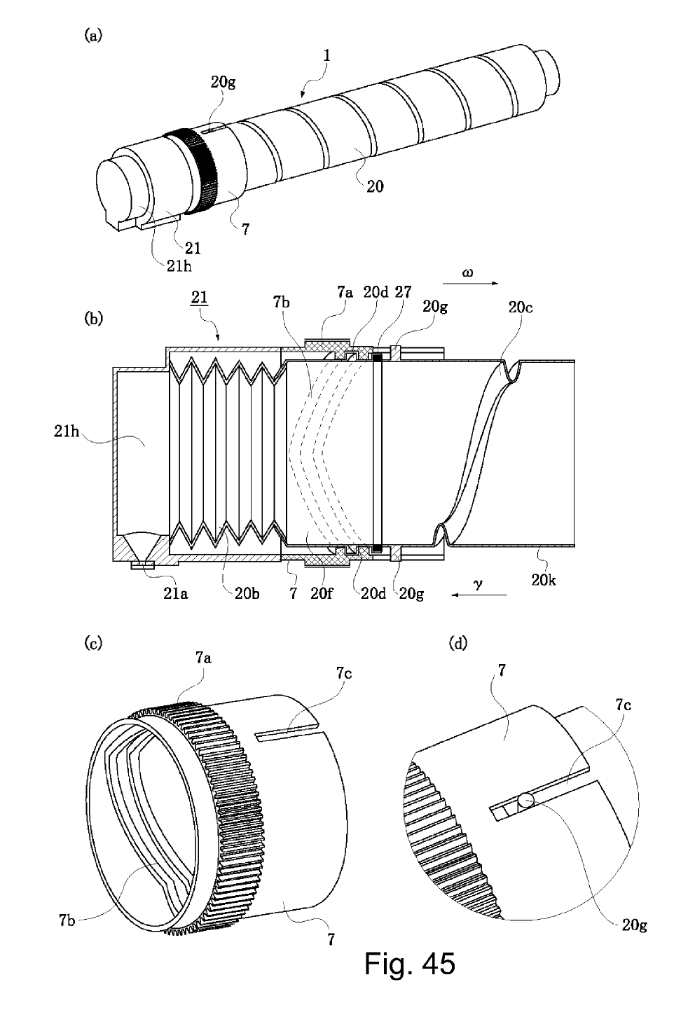

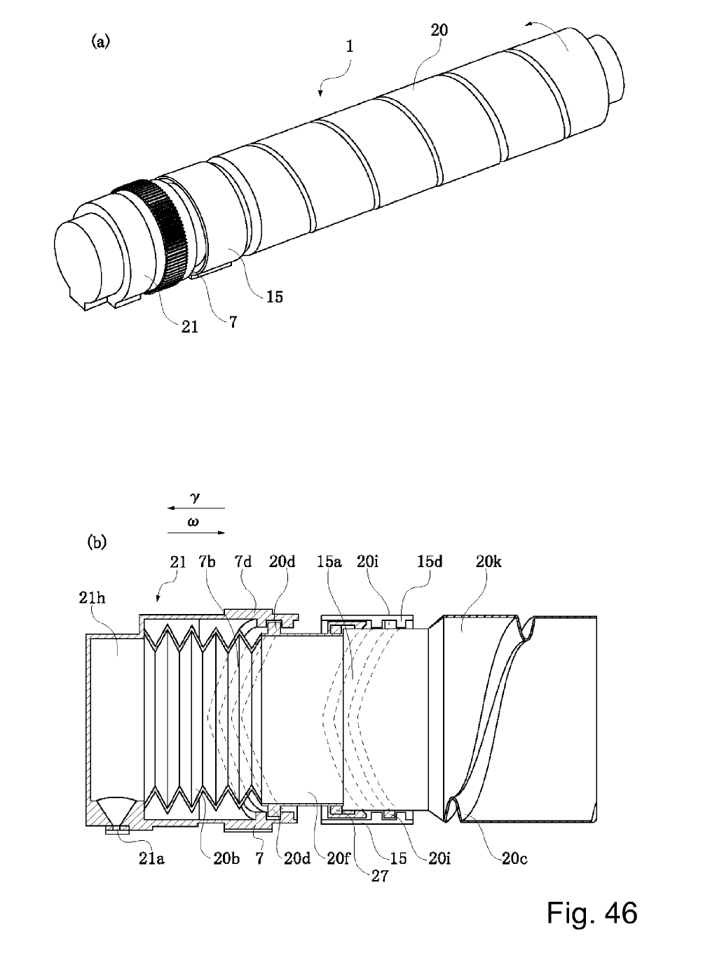

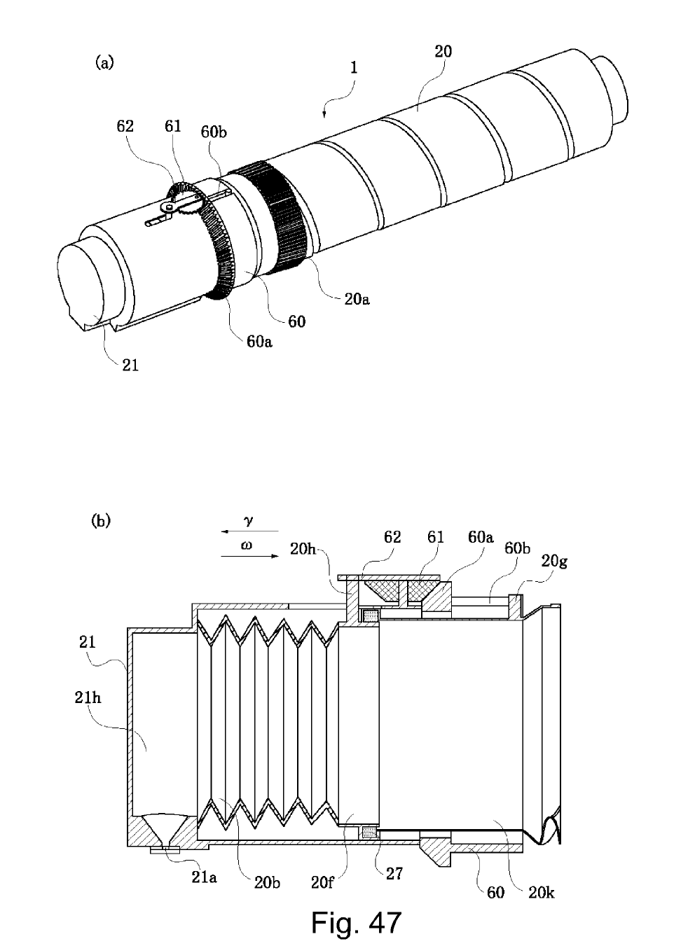

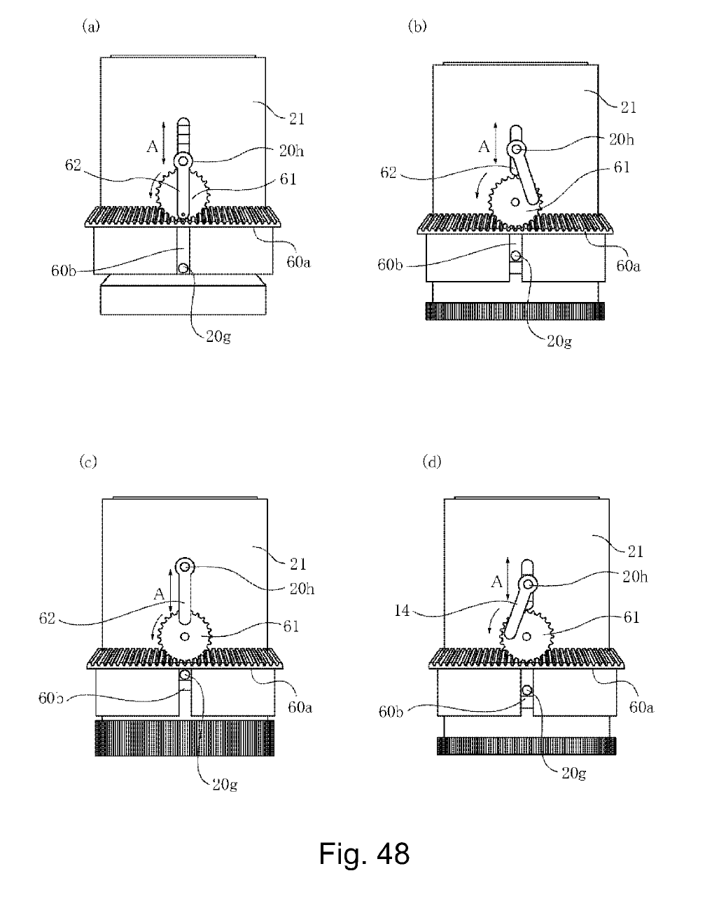

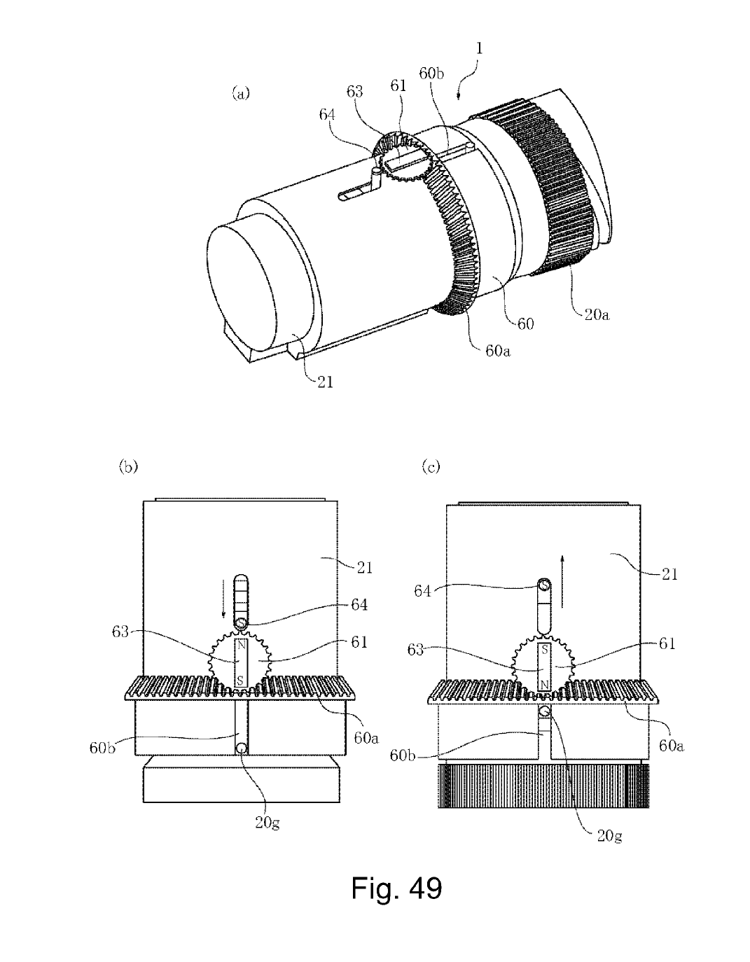

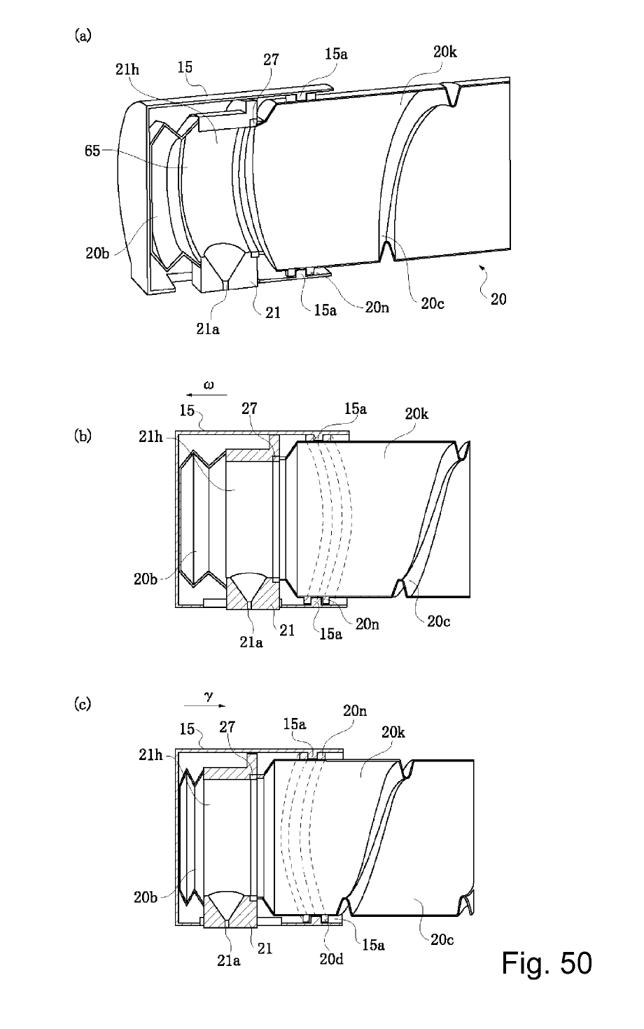

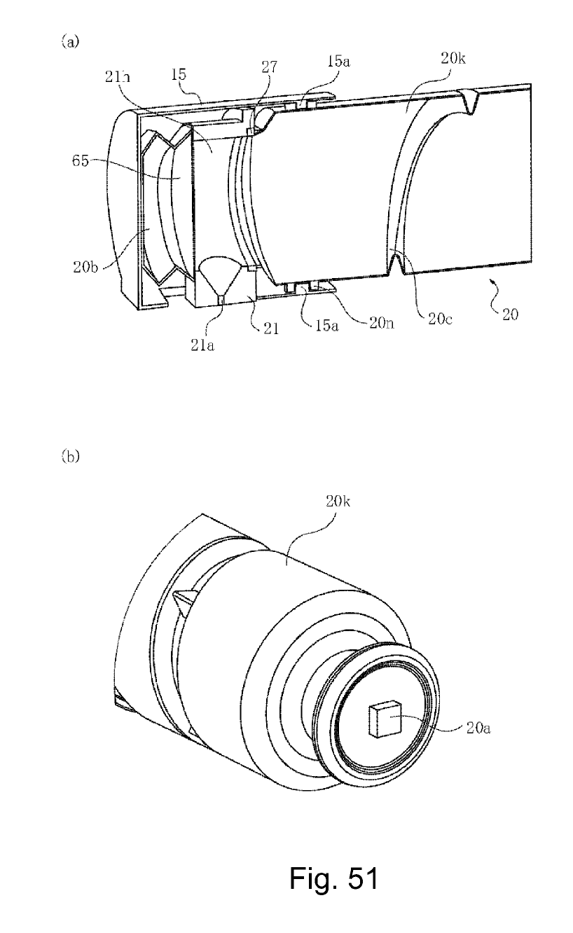

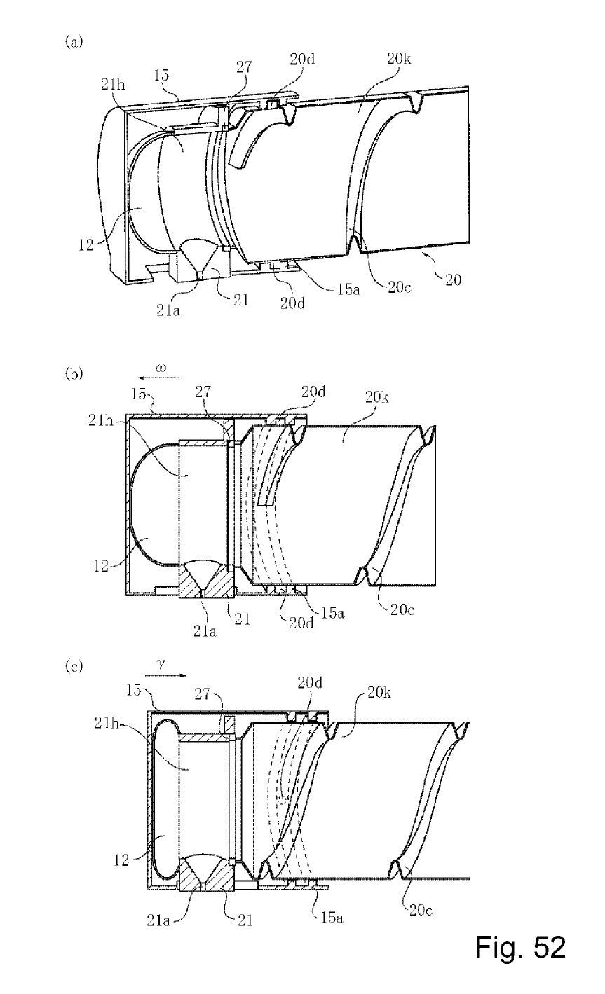

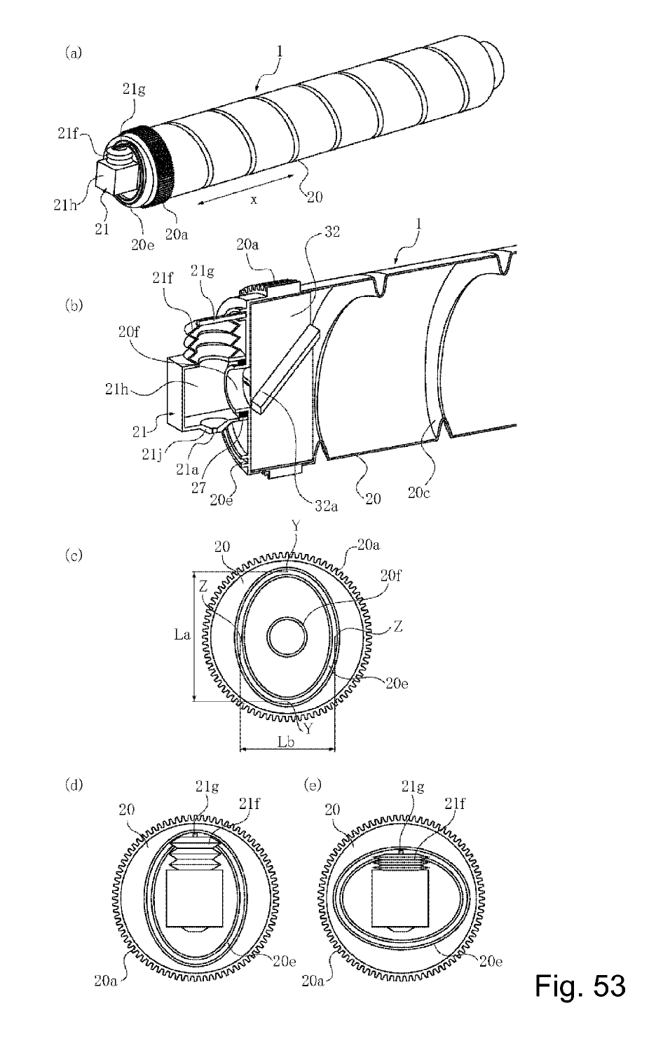

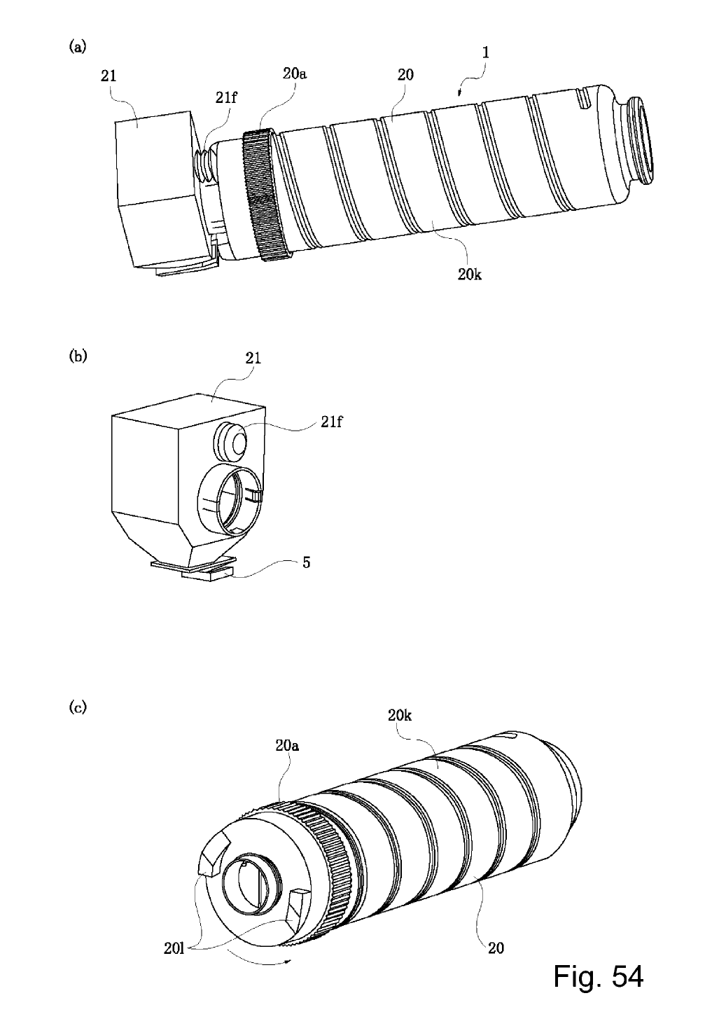

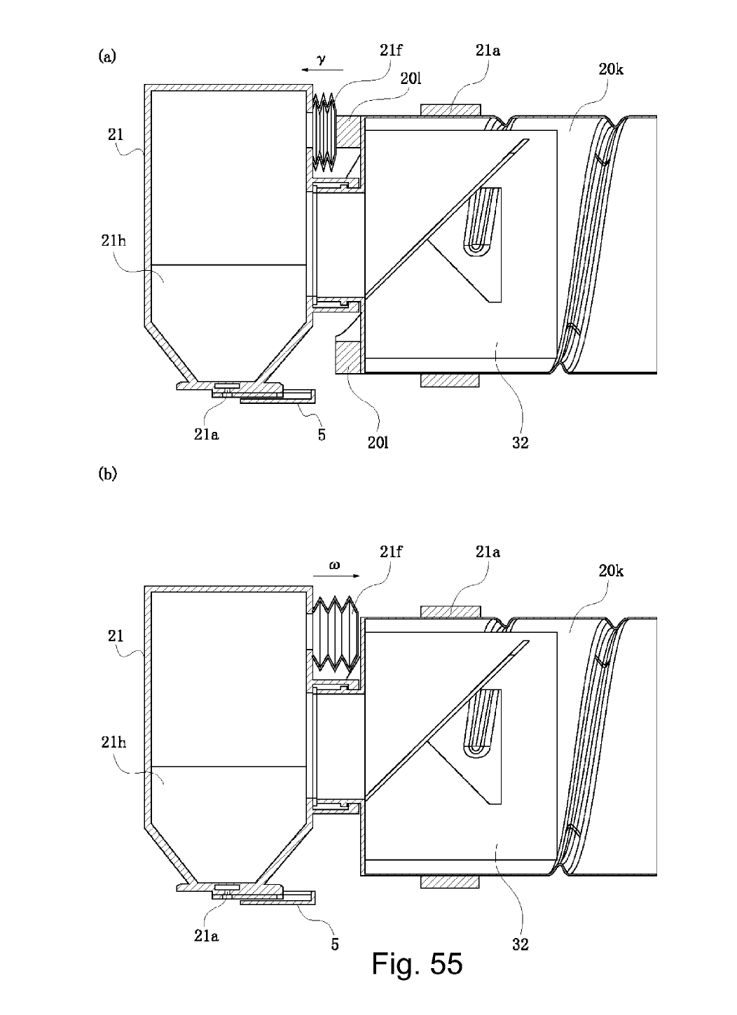

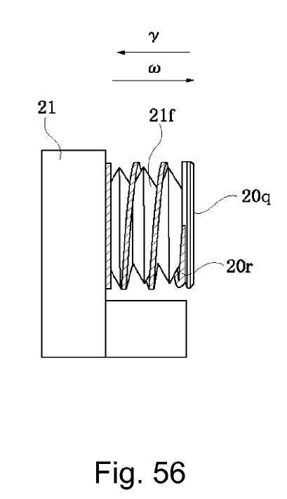

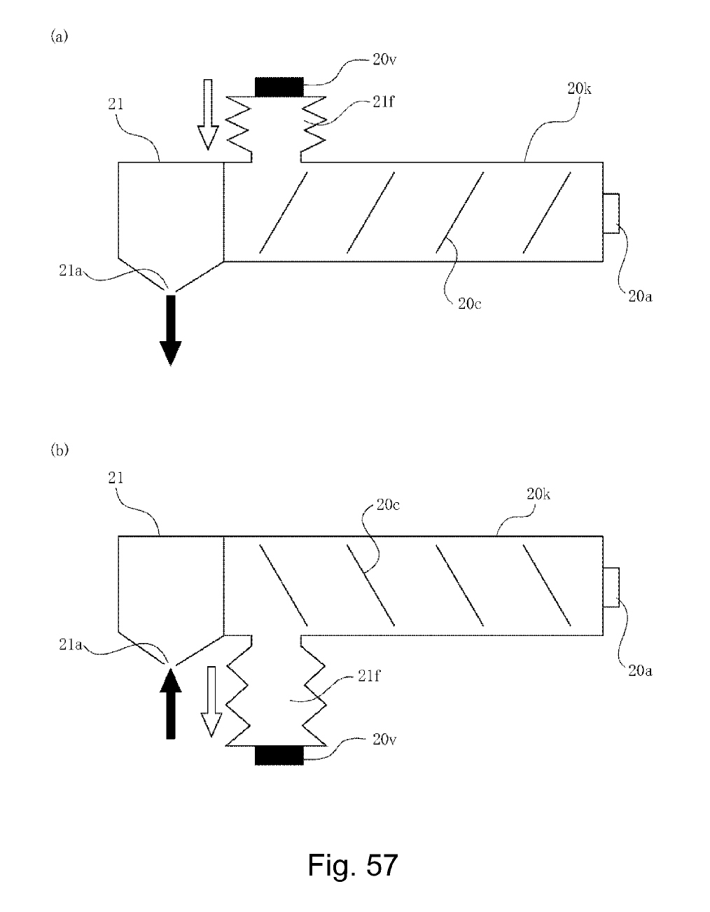

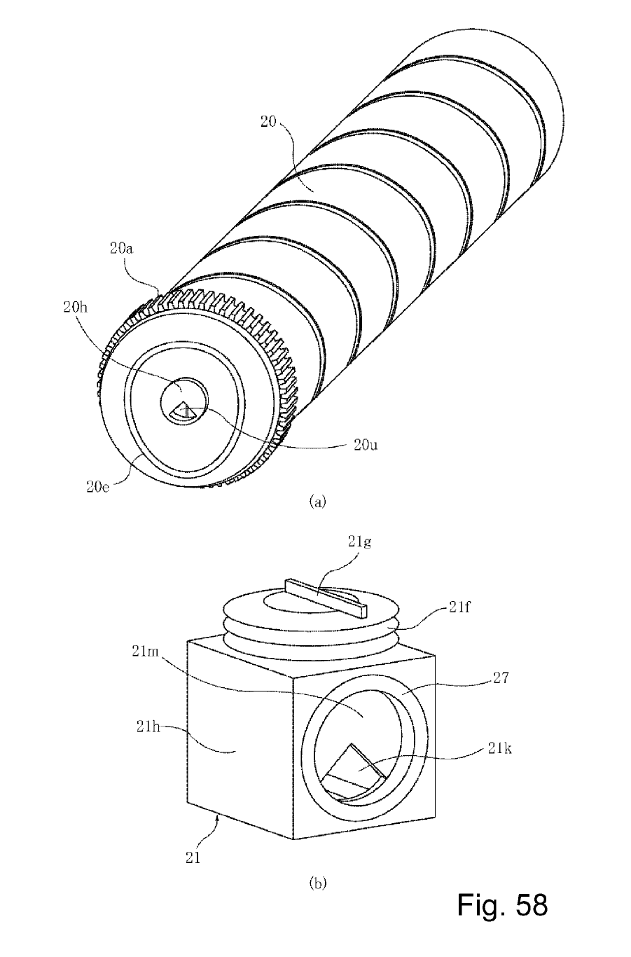

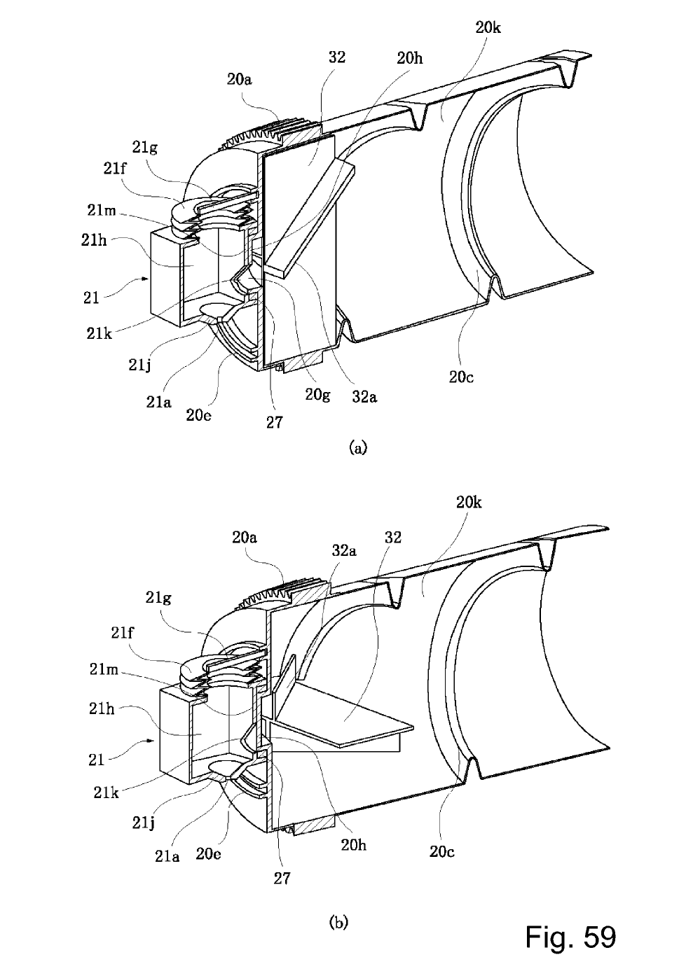

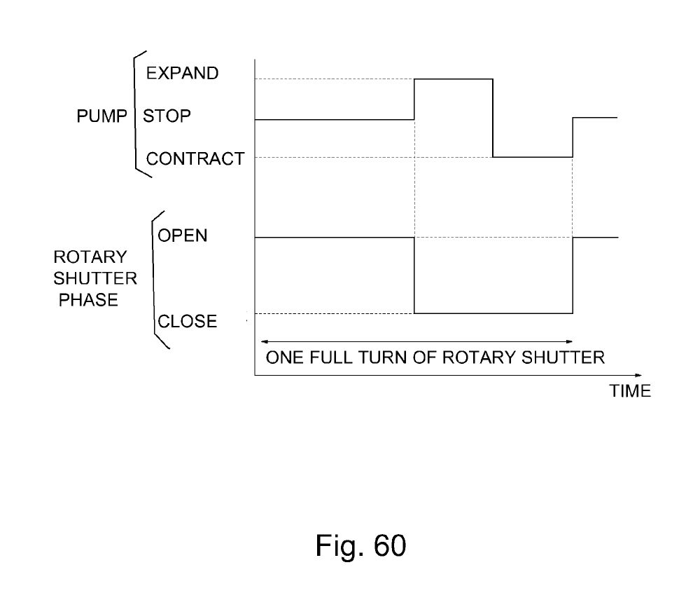

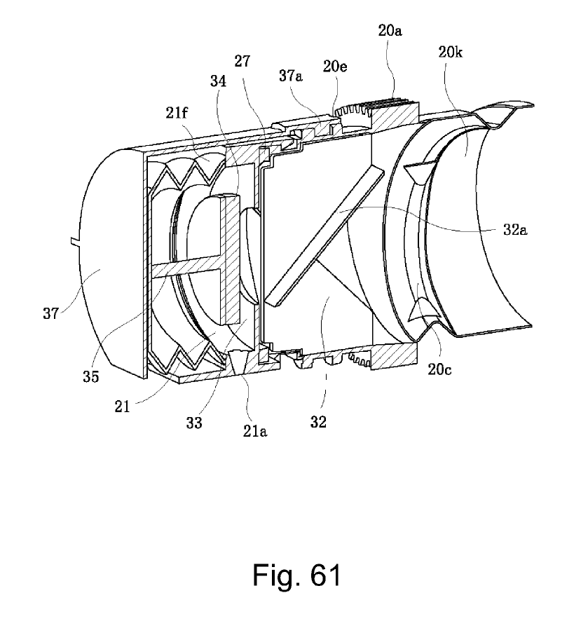

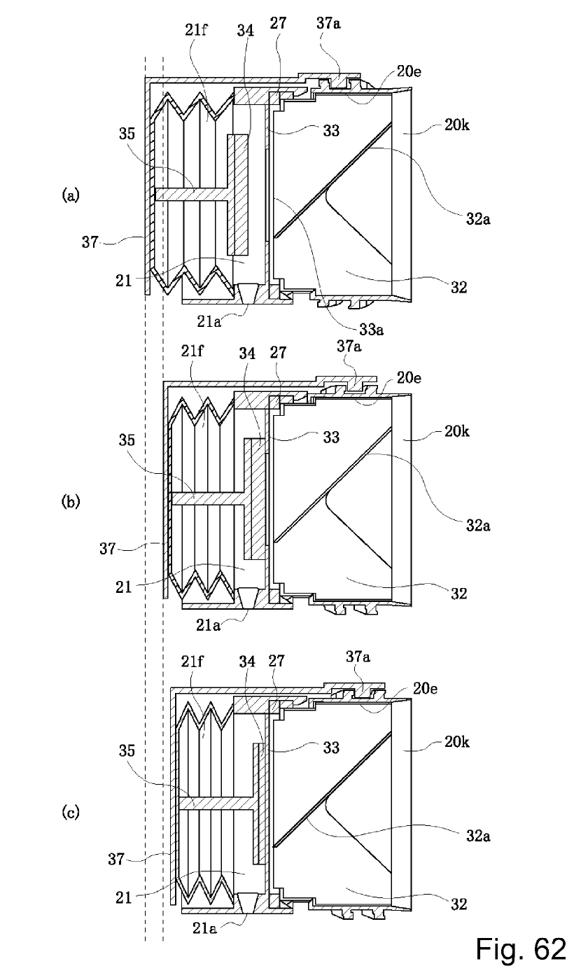

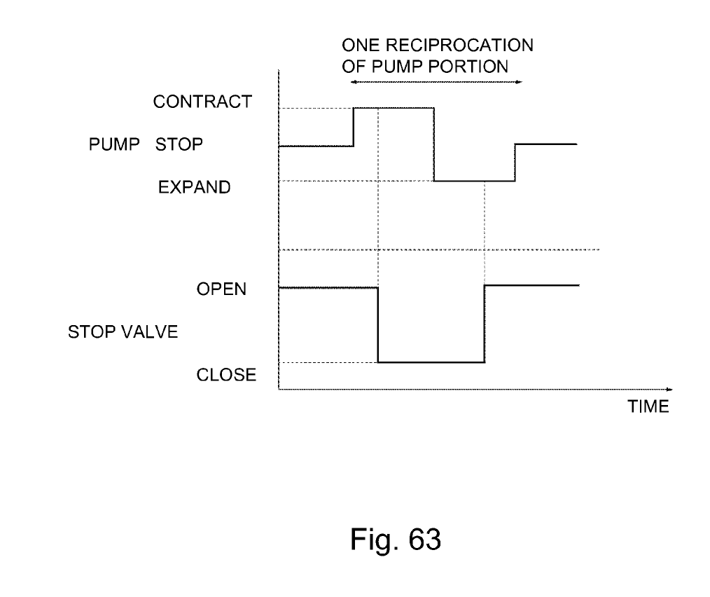

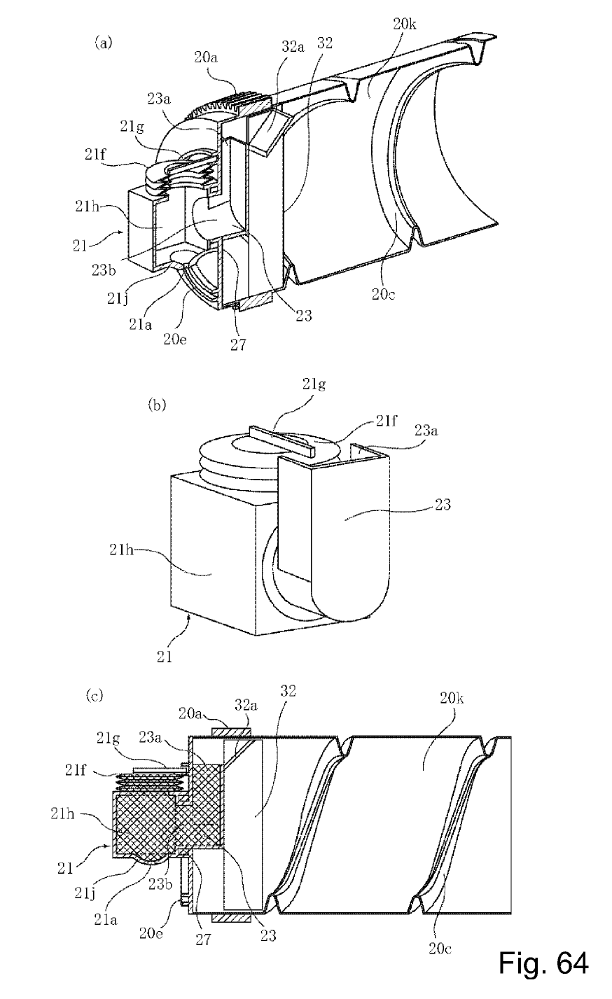

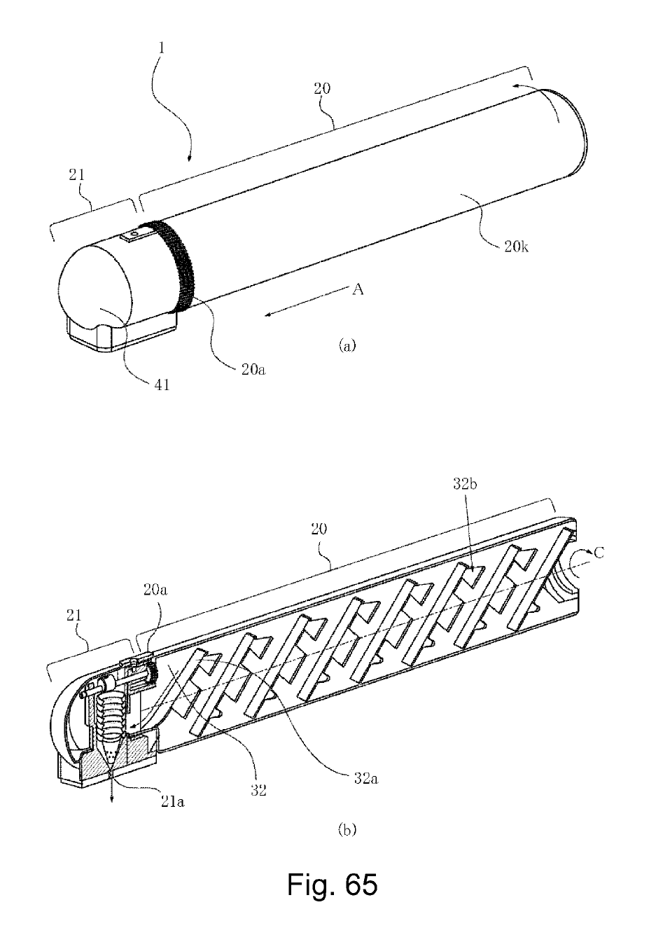

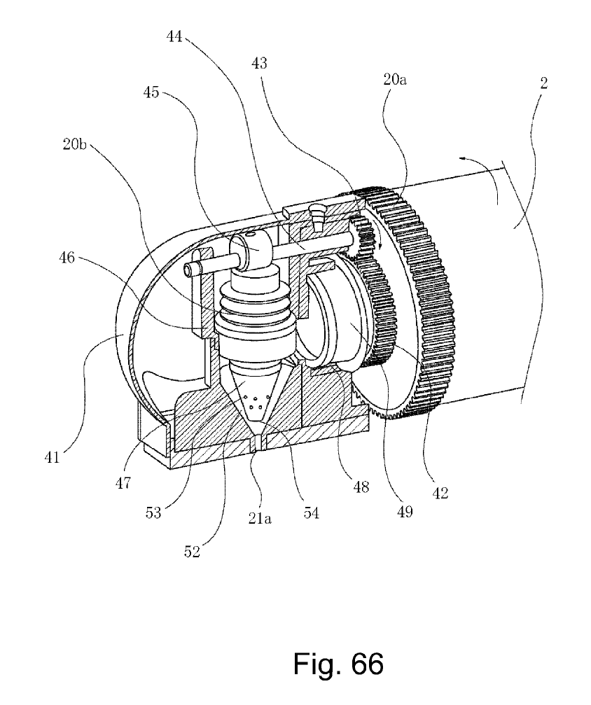

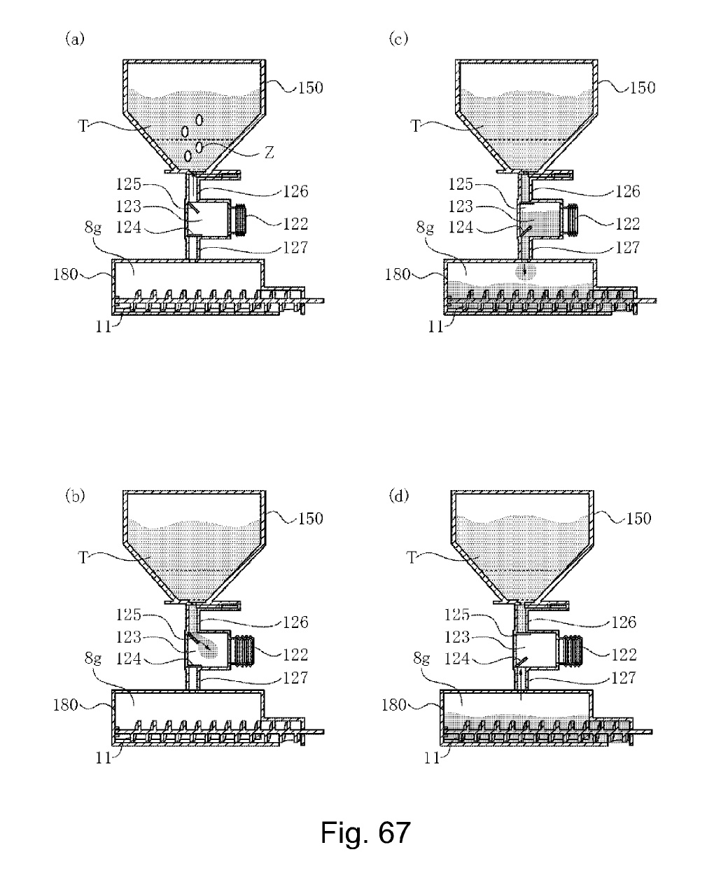

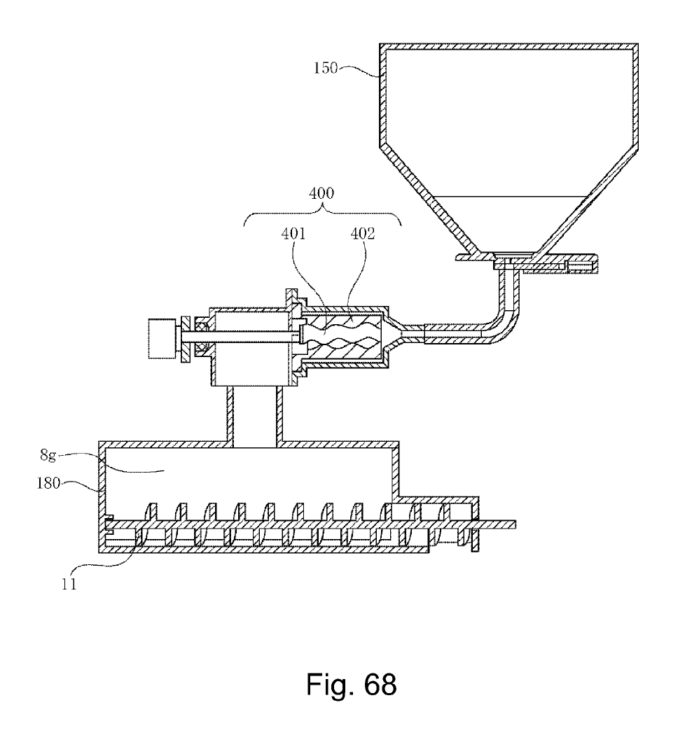

The developer feeding mechanism in the cylindrical portion 14 is not restrictive to the present invention, and the developer supply container 1 may be vibrated or swung, or may be another mechanism. Specifically, the structure of FIG. 30 is usable.

As shown in FIG. 30, the cylindrical portion 14 per se is not movable substantially relative to the developer replenishing apparatus 8 (with slight play), and a feeding member 17 is provided in the cylindrical portion in place of the feeding projection 14a, the feeding member 17 being effective to feed the developer by rotation relative to the cylindrical portion 14.

The feeding member 17 includes a shaft portion 17a and flexible feeding blades 17b fixed to the shaft portion 17a. The feeding blade 17b is provided at a free end portion with an inclined portion S inclined relative to an axial direction of the shaft portion 17a. Therefore, it can feed the developer toward the portion X while stirring the developer in the cylindrical portion 14.

One longitudinal end surface of the cylindrical portion 14 is provided with a coupling portion 14e as the rotational force receiving portion, and the coupling portion 14e is operatively connected with a coupling member (not shown) of the developer replenishing apparatus 8, by which the rotational force can be transmitted. The coupling portion 14e is coaxially connected with the shaft portion 17a of the feeding member 17 to transmit the rotational force to the shaft portion 17a.

By the rotational force applied from the coupling member (not shown) of the developer replenishing apparatus 8, the feeding blade 17b fixed to the shaft portion 17a is rotated, so that the developer in the cylindrical portion 14 is fed toward the portion X while being stirred.

However, with the modified example shown in FIG. 30, the stress applied to the developer in the developer feeding step tends to be large, and the driving torque is also large, and for this reason, the structure of the this embodiment is preferable.

Thus, also in this example, one pump is enough to effect the suction operation and the discharging operation, and therefore, the structure of the developer discharging mechanism can be simplified. In addition, by the suction operation through the discharge opening, a pressure reduction state (negative pressure state) can be provided in the developer supply container, and therefore, the developer can be efficiently loosened.

### Embodiment 5

Referring to FIGS. 31-33, a structure of Embodiment 5 will be described. Part (a) of FIG. 31 is a front view of a developer replenishing apparatus 8, as seen in a mounting direction of a developer supply container 1, and (b) is a perspective view of an inside of the developer replenishing apparatus 8. Part (a) of FIG. 32 is a perspective view of the entire developer supply container 1, (b) is a partial enlarged view of a neighborhood of a discharge opening 21a of the developer supply container 1, and (c)-(d) are a front view and a sectional view illustrating a state that the developer supply container 1 is mounted to a mounting portion 8f. Part (a) of FIG. 33 is a perspective view of the developer accommodating portion 20, (b) is a partially sectional view illustrating an inside of the developer supply container 1, (c) is a sectional view of a flange portion 21, and (d) is a sectional view illustrating the developer supply container 1.

In the above-described Embodiments 1-4, the pump is expanded and contracted by moving the locking member 9 of the developer replenishing apparatus 8 vertically, this example is significantly different in that the developer supply container 1 receives only the rotational force from the developer replenishing apparatus 8. In the other respects, the structure is similar to the foregoing embodiments, and therefore, the same reference numerals as in the foregoing embodiments are assigned to the elements having the corresponding functions in this embodiment, and the detailed description thereof is omitted for simplicity.

Specifically, in this example, the rotational force inputted from the developer replenishing apparatus 8 is converted to the force in the direction of reciprocation of the pump, and the converted force is transmitted to the pump.

In the following, the structure of the developer replenishing apparatus 8 and the developer supply container 1 will be described in detail.

### (Developer Replenishing Apparatus)

Referring to FIG. 31, the developer replenishing apparatus will be first described. The developer replenishing apparatus 8 comprises a mounting portion (mounting space) 8f to which the developer supply container 1 is detachably mountable.

As shown in part (b) of FIG. 31, the developer supply container 1 is mountable in a direction indicated by M to the mounting portion 8f. Thus, a longitudinal direction (rotational axis direction) of the developer supply container 1 is substantially the same as the direction M. The direction M is substantially parallel with a direction indicated by X of part (b) of FIG. 33(b) which will be described hereinafter. In addition, a dismounting direction of the developer supply container 1 from the mounting portion 8f is opposite the direction M.

As shown in part (a) of FIG. 31, the mounting portion 8f is provided with a rotation regulating portion (holding mechanism) 29 for limiting movement of the flange portion 21 in the rotational moving direction by abutting to a flange portion 21 (FIG. 32) of the developer supply container 1 when the developer supply container 1 is mounted. In addition, as shown in part (b) of FIG. 31 a mounting portion 8f is provided with the regulating portion (the holding mechanism) 30 for limiting movement of the flange portion 21 in a rotational axis direction by locking engagement with the flange portion 21 of the developer supply container 1 when the developer supply container 1 is mounted. The regulating portion 30 is a snap locking mechanism of resin material which elastically deforms by interference with the flange portion 21, and thereafter, restores upon being released from the flange portion 21 to lock the flange portion 21.

Furthermore, the mounting portion 8f is provided with a developer receiving port (developer reception hole) 13 for receiving the developer discharged from the developer supply container 1, and the developer receiving port is brought into fluid communication with a discharge opening the discharging port) 21a (FIG. 32) of the developer supply container 1 which will be described hereinafter, when the developer supply container 1 is mounted thereto. The developer is supplied from the discharge opening 21a of the developer supply container 1 to the developing device 8 through the developer receiving port 31. In this embodiment, a diameter φ of the developer receiving port 31 is approx. 2 mm which is the same as that of the discharge opening 21a, for the purpose of preventing as much as possible the contamination by the developer in the mounting portion 8f.

As shown in part (a) of FIG. 31, the mounting portion 8f is provided with a driving gear 300 functioning as a driving mechanism (driver). The driving gear 300 receives a rotational force from a driving motor 500 through a driving gear train, and functions to apply a rotational force to the developer supply container 1 which is set in the mounting portion 8f.

As shown in FIG. 31, the driving motor 500 is controlled by a control device (CPU) 600.

In this example, the driving gear 300 is rotatable unidirectionally to simplify the control for the driving motor 500. The control device 600 controls only ON (operation) and OFF (non-operation) of the driving motor 500. This simplifies the driving mechanism for the developer replenishing apparatus 8 as compared with a structure in which forward and backward driving forces are provided by periodically rotating the driving motor 500 (driving gear 300) in the forward direction and backward direction.

### (Developer Supply Container)

Referring to FIGS. 32 and 33, the structure of the developer supply container 1 which is a constituent-element of the developer supplying system will be described.

As shown in part (a) of FIG. 32, the developer supply container 1 includes a developer accommodating portion 20 (container body) having a hollow cylindrical inside space for accommodating the developer. In this example, a cylindrical portion 20k and the pump portion 20b functions as the developer accommodating portion 20. Furthermore, the developer supply container 1 is provided with a flange portion 21 (non-rotatable portion) at one end of the developer accommodating portion 20 with respect to the longitudinal direction (developer feeding direction). The developer accommodating portion 20 is rotatable relative to the flange portion 21.

In this example, as shown in part (d) of FIG. 33, a total length L1 of the cylindrical portion 20k functioning as the developer accommodating portion is approx. 300 mm, and an outer diameter R1 is approx. 70 mm. A total length L2 of the pump portion 2b (in the state that it is most expanded in the expansible range in use) is approx. 50 mm, and a length L3 of a region in which a gear portion 20a of the flange portion 21 is provided is approx. 20 mm. A length L4 of a region of a discharging portion 21h functioning as a developer discharging portion is approx. 25 mm. A maximum outer diameter R2 (in the state that it is most expanded in the expansible range in use in the diametrical direction) is approx. 65 mm, and a total volume capacity accommodating the developer in the developer supply container 1 is the 1250 cm³. In this example, the developer can be accommodated in the cylindrical portion 20k and the pump portion 20b and in addition the discharging portion 21h, that is, they function as a developer accommodating portion.

As shown in FIGS. 32, 33, in this example, in the state that the developer supply container 1 is mounted to the developer replenishing apparatus 8, the cylindrical portion 20k and the discharging portion 21h are substantially on line along a horizontal direction. That is, the cylindrical portion 20k has a sufficiently long length in the horizontal direction as compared with the length in the vertical direction, and one end part with respect to the horizontal direction is connected with the discharging portion 21h. For this reason, the suction and discharging operations can be carried out smoothly as compared with the case in which the cylindrical portion 20k is above the discharging portion 21h in the state that the developer supply container 1 is mounted to the developer replenishing apparatus 8. This is because the amount of the toner existing above the discharge opening 21a is small, and therefore, the developer in the neighborhood of the discharge opening 21a is less compressed.

As shown in part (b) of FIG. 32, the flange portion 21 is provided with a hollow discharging portion (developer discharging chamber) 21h for temporarily storing the developer having been fed from the inside of the developer accommodating portion (inside of the developer accommodating chamber) 20 (see parts (b) and (c) of FIG. 33 if necessary). A bottom portion of the discharging portion 21h is provided with the small discharge opening 21a for permitting discharge of the developer to the outside of the developer supply container 1, that is, for supplying the developer into the developer replenishing apparatus 8. The size of the discharge opening 21a is as has been described hereinbefore.

An inner shape of the bottom portion of the inner of the discharging portion 21h (inside of the developer discharging chamber) is like a funnel converging toward the discharge opening 21a in order to reduce as much as possible the amount of the developer remaining therein (parts (b) and (c) of FIG. 33, if necessary).

The flange portion 21 is provided with a shutter 26 for opening and closing the discharge opening 21a. The shutter 26 is provided at a position such that when the developer supply container 1 is mounted to the mounting portion 8f, it is abutted to an abutting portion 8h (see part (b) of FIG. 31 if necessary) provided in the mounting portion 8f. Therefore, the shutter 26 slides relative to the developer supply container 1 in the rotational axis direction (opposite from the M direction) of the developer accommodating portion 20 with the mounting operation of the developer supply container 1 to the mounting portion 8f. As a result, the discharge opening 21a is exposed through the shutter 26, thus completing the unsealing operation.

At this time, the discharge opening 21a is positionally aligned with the developer receiving port 31 of the mounting portion 8f, and therefore, they are brought into fluid communication with each other, thus enabling the developer supply from the developer supply container 1.

The flange portion 21 is constructed such that when the developer supply container 1 is mounted to the mounting portion 8f of the developer replenishing apparatus 8, it is stationary substantially.

More particularly, as shown in part (c) of FIG. 32, the flange portion 21 is regulated (prevented) from rotating in the rotational direction about the rotational axis of the developer accommodating portion 20 by a rotational moving direction regulating portion 29 provided in the mounting portion 8f. In other words, the flange portion 21 is retained such that it is substantially non-rotatable by the developer replenishing apparatus 8 (although the rotation within the play is possible).

Furthermore, the flange portion 21 is locked with the rotational axis direction regulating portion 30 provided in the mounting portion 8f with the mounting operation of the developer supply container 1. More particularly, a flange portion 21 is brought into abutment to the rotational axis direction regulating portion 30 in midstream of the mounting operation of the developer supply container 1 to elastically deform the rotational axis direction regulating portion 30. Thereafter, the flange portion 21 abuts to the inner wall portion 28a (part (d) of FIG. 32) which is a stopper provided in the mounting portion 8f, thus completing the mounting step of the developer supply container 1. Substantially simultaneously with the completion of the mounting, the interference with the flange portion 21 is released, so that the elastic deformation of the rotational axis direction regulating portion 30 restores.

As a result, as shown in part (d) of FIG. 32, the rotational axis direction regulating portion 30 is locked with an edge portion of the flange portion 21 (functioning as a locking portion), so that the state in which the movement in the rotational axis direction of the developer accommodating portion 20 is prevented (regulated) substantially is established. At this time, slight negligible movement due to the play is permitted.

As described in the foregoing, in this example, the flange portion 21 is prevented from moving in the rotational axis direction of the developer accommodating portion 20 by the regulating portion 30 of the developer replenishing apparatus 8.

In addition, the flange portion 21 is prevented from rotating in the rotational direction of the developer accommodating portion 20 by the regulating member 29 of the developer replenishing apparatus 8.

When the operator dismounts the developer supply container 1 from the mounting portion 8f, the rotational axis direction regulating portion 30 is elastically deformed by the flange portion 21 to be released from the flange portion 21. The rotational axis direction of the developer accommodating portion 20 is substantially the same as the rotational axis direction of the gear portion 20a (FIG. 33).

Therefore, in the state that the developer supply container 1 is mounted to the developer replenishing apparatus 8, the discharging portion 21h provided in the flange portion 21 is prevented substantially in the movement of the developer accommodating portion 20 both in the rotational axis direction and the rotational moving direction (movement within the play is permitted).

On the other hand, the developer accommodating portion 20 is not limited in the rotational moving direction by the developer replenishing apparatus 8, and therefore, is rotatable in the developer supplying step. However, the developer accommodating portion 20 is substantially prevented in the movement in the rotational axis direction by the flange portion 21 (although the movement within the play is permitted).

### (Pump Portion)

Referring to FIGS. 33 and 34, the description will be made as to the pump portion (reciprocable pump) 20b in which the volume thereof changes with reciprocation. Part (a) of FIG. 34 a sectional view of the developer supply container 1 in which the pump portion 20b is expanded to the maximum extent in operation of the developer supplying step, and part (b) of FIG. 34 is a sectional view of the developer supply container 1 in which the pump portion 20b is compressed to the maximum extent in operation of the developer supplying step.

The pump portion 20b of this example functions as a suction and discharging mechanism for repeating the suction operation and the discharging operation alternately through the discharge opening 21a.

As shown in part (b) of FIG. 33, the pump portion 20b is provided between the discharging portion 21h and the cylindrical portion 20k, and is fixedly connected to the cylindrical portion 20k. Thus, the pump portion 20b is rotatable integrally with the cylindrical portion 20k.

In the pump portion 20b of this example, the developer can be accommodated therein. The developer accommodating space in the pump portion 20b has a significant function of fluidizing the developer in the suction operation, as will be described hereinafter.

In this example, the pump portion 20b is a displacement type pump (bellow-like pump) of resin material in which the volume thereof changes with the reciprocation. More particularly, as shown in (a)-(b) of FIG. 33, the bellow-like pump includes crests and bottoms periodically and alternately. The pump portion 20b repeats the compression and the expansion alternately by the driving force received from the developer replenishing apparatus 8. In this example, the volume change by the expansion and contraction is 15 cm³ (cc). As shown in part (d) of FIG. 33, a total length L2 (most expanded state within the expansion and contraction range in operation) of the pump portion 20b is approx. 50 mm, and a maximum outer diameter (largest state within the expansion and contraction range in operation) R2 of the pump portion 20b is approx. 65 mm.

With use of such a pump portion 20b, the internal pressure of the developer supply container 1 (developer accommodating portion 20 and discharging portion 21h) higher than the ambient pressure and the internal pressure lower than the ambient pressure are produced alternately and repeatedly at a predetermined cyclic period (approx. 0.9 sec in this example). The ambient pressure is the pressure of the ambient condition in which the developer supply container 1 is placed. As a result, the developer in the discharging portion 21h can be discharged efficiently through the small diameter discharge opening 21a (diameter of approx. 2 mm).

As shown in part (b) of FIG. 33, the pump portion 20b is connected to the discharging portion 21h rotatably relative thereto in the state that a discharging portion 21h side end is compressed against a ring-like sealing member 27 provided on an inner surface of the flange portion 21.

By this, the pump portion 20b rotates sliding on the sealing member 27, and therefore, the developer does not leak from the pump portion 20b, and the hermetical property is maintained, during rotation. Thus, in and out of the air through the discharge opening 21a are carries out properly, and the internal pressure of the developer supply container 1 (pump portion 20b, developer accommodating portion 20 and discharging portion 21h) are changed properly, during supply operation.

### (Drive Transmission Mechanism)

The description will be made as to a drive receiving mechanism (drive inputting portion, driving force receiving portion) of the developer supply container 1 for receiving the rotational force for rotating the feeding portion 20c from the developer replenishing apparatus 8.

As shown in part (a) of FIG. 33, the developer supply container 1 is provided with a gear portion 20a which functions as a drive receiving mechanism (drive inputting portion, driving force receiving portion) engageable (driving connection) with a driving gear 300 (functioning as driving mechanism) of the developer replenishing apparatus 8. The gear portion 20a is fixed to one longitudinal end portion of the pump portion 20b. Thus, the gear portion 20a, the pump portion 20b, and the cylindrical portion 20k are integrally rotatable.

Therefore, the rotational force inputted to the gear portion 20a from the driving gear 300 is transmitted to the cylindrical portion 20k (feeding portion 20c) a pump portion 20b.

In other words, in this example, the pump portion 20b functions as a drive transmission mechanism for transmitting the rotational force inputted to the gear portion 20a to the feeding portion 20c of the developer accommodating portion 20.

For this reason, the bellow-like pump portion 20b of this example is made of a resin material having a high property against torsion or twisting about the axis within a limit of not adversely affecting the expanding-and-contracting operation.

In this example, the gear portion 20a is provided at one longitudinal end (developer feeding direction) of the developer accommodating portion 20, that is, at the discharging portion 21h side end, but this is not inevitable, and the gear portion 20a may be provided at the other longitudinal end side of the developer accommodating portion 20, that is, the trailing end portion. In such a case, the driving gear 300 is provided at a corresponding position.

In this example, a gear mechanism is employed as the driving connection mechanism between the drive inputting portion of the developer supply container 1 and the driver of the developer replenishing apparatus 8, but this is not inevitable, and a known coupling mechanism, for example is usable. More particularly, in such a case, the structure may be such that a non-circular recess is provided in a bottom surface of one longitudinal end portion (righthand side end surface of (d) of FIG. 33) as a drive inputting portion, and correspondingly, a projection having a configuration corresponding to the recess as a driver for the developer replenishing apparatus 8, so that they are in driving connection with each other.

### (Drive Converting Mechanism)

A drive converting mechanism (drive converting portion) for the developer supply container 1 will be described.

The developer supply container 1 is provided with the cam mechanism for converting the rotational force for rotating the feeding portion 20c received by the gear portion 20a to a force in the reciprocating directions of the pump portion 20b.

That is, in the example, the description will be made as to an example using a cam mechanism as the drive converting mechanism, but the present invention is not limited to this example, and other structures such as with Embodiments 6 et seqq. are usable.

In this example, one drive inputting portion (gear portion 20a) receives the driving force for driving the feeding portion 20c and the pump portion 20b, and the rotational force received by the gear portion 20a is converted to a reciprocation force in the developer supply container 1 side.

Because of this structure, the structure of the drive inputting mechanism for the developer supply container 1 is simplified as compared with the case of providing the developer supply container 1 with two separate drive inputting portions. In addition, the drive is received by a single driving gear of developer replenishing apparatus 8, and therefore, the driving mechanism of the developer replenishing apparatus 8 is also simplified.

In the case that the reciprocation force is received from the developer replenishing apparatus 8, there is a liability that the driving connection between the developer replenishing apparatus 8 and the developer supply container 1 is not proper, and therefore, the pump portion 20b is not driven. More particularly, when the developer supply container 1 is taken out of the image forming apparatus 100 and then is mounted again, the pump portion 20b may not be properly reciprocated.

For example, when the drive input to the pump portion 20b stops in a state that the pump portion 20b is compressed from the normal length, the pump portion 20b restores spontaneously to the normal length when the developer supply container is taken out. In this case, the position of the drive inputting portion for the pump portion 20b changes when the developer supply container 1 is taken out, despite the fact that a stop position of the drive outputting portion of the image forming apparatus 100 side remains unchanged. As a result, the driving connection is not properly established between the drive outputting portion of the image forming apparatus 100 sides and pump portion 20b drive inputting portion of the developer supply container 1 side, and therefore, the pump portion 20b cannot be reciprocated. Then, the developer supply is not carries out, and sooner or later, the image formation becomes impossible.

Such a problem may similarly arise when the expansion and contraction state of the pump portion 20b is changed by the user while the developer supply container 1 is outside the apparatus.

Such a problem similarly arises when developer supply container 1 is exchanged with a new one.

The structure of this example is substantially free of such a problem. This will be described in detail.

As shown in FIGS. 33 and 34, the outer surface of the cylindrical portion 20k of the developer accommodating portion 20 is provided with a plurality of cam projections 20d functioning as a rotatable portion substantially at regular intervals in the circumferential direction. More particularly, two cam projections 20d are disposed on the outer surface of the cylindrical portion 20k at diametrically opposite positions, that is, approx. 180° opposing positions.

The number of the cam projections 20d may be at least one. However, there is a liability that a moment is produced in the drive converting mechanism and so on by a drag at the time of expansion or contraction of the pump portion 20b, and therefore, smooth reciprocation is disturbed, and therefore, it is preferable that a plurality of them are provided so that the relation with the configuration of the cam groove 21b which will be described hereinafter is maintained.

On the other hand, a cam groove 21b engaged with the cam projections 20d is formed in an inner surface of the flange portion 21 over an entire circumference, and it functions as a follower portion. Referring to FIG. 35, the cam groove 21b will be described. In FIG. 35, an arrow A indicates a rotational moving direction of the cylindrical portion 20k (moving direction of cam projection 20d), an arrow B indicates a direction of expansion of the pump portion 20b, and an arrow C indicates a direction of compression of the pump portion 20b. Here, an angle α is formed between a cam groove 21c and a rotational moving direction A of the cylindrical portion 20k, and an angle β is formed between a cam groove 21d and the rotational moving direction A. In addition, an amplitude (=length of expansion and contraction of pump portion 20b) in the expansion and contracting directions B, C of the pump portion 20b of the cam groove is L.

As shown in FIG. 35 illustrating the cam groove 21b in a developed view, a groove portion 21c inclining from the cylindrical portion 20k side toward the discharging portion 21h side and a groove portion 21d inclining from the discharging portion 21h side toward the cylindrical portion 20k side are connected alternately. In this example, α=β.

Therefore, in this example, the cam projection 20d and the cam groove 21b function as a drive transmission mechanism to the pump portion 20b. More particularly, the cam projection 20d and the cam groove 21b function as a mechanism for converting the rotational force received by the gear portion 20a from the driving gear 300 to the force (force in the rotational axis direction of the cylindrical portion 20k) in the directions of reciprocal movement of the pump portion 20b and for transmitting the force to the pump portion 20b.

More particularly, the cylindrical portion 20k is rotated with the pump portion 20b by the rotational force inputted to the gear portion 20a from the driving gear 300, and the cam projections 20d are rotated by the rotation of the cylindrical portion 20k. Therefore, by the cam groove 21b engaged with the cam projection 20d, the pump portion 20b reciprocates in the rotational axis direction (X direction of FIG. 33) together with the cylindrical portion 20k. The X direction is substantially parallel with the M direction of FIGS. 31 and 32.

In other words, the cam projection 20d and the cam groove 21b convert the rotational force inputted from the driving gear 300 so that the state in which the pump portion 20b is expanded (part (a) of FIG. 34) and the state in which the pump portion 20b is contracted (part (b) of FIG. 34) are repeated alternately.

Thus, in this example, the pump portion 20b rotates with the cylindrical portion 20k, and therefore, when the developer in the cylindrical portion 20k moves in the pump portion 20b, the developer can be stirred (loosened) by the rotation of the pump portion 20b. In this example, the pump portion 20b is provided between the cylindrical portion 20k and the discharging portion 21h, and therefore, stirring action can be imparted on the developer fed to the discharging portion 21h, which is further advantageous.

Furthermore, as described above, in this example, the cylindrical portion 20k reciprocates together with the pump portion 20b, and therefore, the reciprocation of the cylindrical portion 20k can stir (loosen) the developer inside cylindrical portion 20k.

### (Set Conditions of Drive Converting Mechanism)

In this example, the drive converting mechanism effects the drive conversion such that an amount (per unit time) of developer feeding to the discharging portion 21h by the rotation of the cylindrical portion 20k is larger than a discharging amount (per unit time) to the developer replenishing apparatus 8 from the discharging portion 21h by the pump function.

This is, because if the developer discharging power of the pump portion 20b is higher than the developer feeding power of the feeding portion 20c to the discharging portion 21h, the amount of the developer existing in the discharging portion 21h gradually decreases. In other words, it is avoided that the time period required for supplying the developer from the developer supply container 1 to the developer replenishing apparatus 8 is prolonged.

In the drive converting mechanism of this example, the feeding amount of the developer by the feeding portion 20c to the discharging portion 21h is 2.0 g/s, and the discharge amount of the developer by pump portion 20b is 1.2 g/s.

In addition, in the drive converting mechanism of this example, the drive conversion is such that the pump portion 20b reciprocates a plurality of times per one full rotation of the cylindrical portion 20k. This is for the following reasons.

In the case of the structure in which the cylindrical portion 20k is rotated inner the developer replenishing apparatus 8, it is preferable that the driving motor 500 is set at an output required to rotate the cylindrical portion 20k stably at all times. However, from the standpoint of reducing the energy consumption in the image forming apparatus 100 as much as possible, it is preferable to minimize the output of the driving motor 500. The output required by the driving motor 500 is calculated from the rotational torque and the rotational frequency of the cylindrical portion 20k, and therefore, in order to reduce the output of the driving motor 500, the rotational frequency of the cylindrical portion 20k is minimized.

However, in the case of this example, if the rotational frequency of the cylindrical portion 20k is reduced, a number of operations of the pump portion 20b per unit time decreases, and therefore, the amount of the developer (per unit time) discharged from the developer supply container 1 decreases. In other words, there is a possibility that the developer amount discharged from the developer supply container 1 is insufficient to quickly meet the developer supply amount required by the main assembly of the image forming apparatus 100.

If the amount of the volume change of the pump portion 20b is increased, the developer discharging amount per unit cyclic period of the pump portion 20b can be increased, and therefore, the requirement of the main assembly of the image forming apparatus 100 can be met, but doing so gives rise to the following problem.

If the amount of the volume change of the pump portion 20b is increased, a peak value of the internal pressure (positive pressure) of the developer supply container 1 in the discharging step increases, and therefore, the load required for the reciprocation of the pump portion 20b increases.

For this reason, in this example, the pump portion 20b operates a plurality of cyclic periods per one full rotation of the cylindrical portion 20k. By this, the developer discharge amount per unit time can be increased as compared with the case in which the pump portion 20b operates one cyclic period per one full rotation of the cylindrical portion 20k, without increasing the volume change amount of the pump portion 20b. Corresponding to the increase of the discharge amount of the developer, the rotational frequency of the cylindrical portion 20k can be reduced.

Verification experiments were carried out as to the effects of the plural cyclic operations per one full rotation of the cylindrical portion 20k. In the experiments, the developer is filled into the developer supply container 1, and a developer discharge amount and a rotational torque of the cylindrical portion 20k are measured. Then, the output (=rotational torque×rotational frequency) of the driving motor 500 required for rotation a cylindrical portion 20k is calculated from the rotational torque of the cylindrical portion 20k and the preset rotational frequency of the cylindrical portion 20k. The experimental conditions are that the number of operations of the pump portion 20b per one full rotation of the cylindrical portion 20k is two, the rotational frequency of the cylindrical portion 20k is 30 rpm, and the volume change of the pump portion 20b is 15 cm³.

As a result of the verification experiment, the developer discharging amount from the developer supply container 1 is approx. 1.2 g/s. The rotational torque of the cylindrical portion 20k (average torque in the normal state) is 0.64N·m, and the output of the driving motor 500 is approx. 2 W (motor load (W)=0.1047×rotational torque (N·m)×rotational frequency (rpm), wherein 0.1047 is the unit conversion coefficient) as a result of the calculation.

Comparative experiments were carried out in which the number of operations of the pump portion 20b per one full rotation of the cylindrical portion 20k was one, the rotational frequency of the cylindrical portion 20k was 60 rpm, and the other conditions were the same as the above-described experiments. In other words, the developer discharge amount was made the same as with the above-described experiments, i.e. approx. 1.2 g/s.

As a result of the comparative experiments, the rotational torque of the cylindrical portion 20k (average torque in the normal state) is 0.66N·m, and the output of the driving motor 500 is approx. 4 W by the calculation.

From these experiments, it has been confirmed that the pump portion 20b carries out preferably the cyclic operation a plurality of times per one full rotation of the cylindrical portion 20k. In other words, it has been confirmed that by doing so, the discharging performance of the developer supply container 1 can be maintained with a low rotational frequency of the cylindrical portion 20k. With the structure of this example, the required output of the driving motor 500 may be low, and therefore, the energy consumption of the main assembly of the image forming apparatus 100 can be reduced.

### (Position of Drive Converting Mechanism)

As shown in FIGS. 33 and 34, in this example, the drive converting mechanism (cam mechanism constituted by the cam projection 20d and the cam groove 21b) is provided outside of developer accommodating portion 20. More particularly, the drive converting mechanism is disposed at a position separated from the inside spaces of the cylindrical portion 20k, the pump portion 20b and the flange portion 21, so that the drive converting mechanism does not contact the developer accommodated inside the cylindrical portion 20k, the pump portion 20b and the flange portion 21.

By this, a problem which may arise when the drive converting mechanism is provided in the inside space of the developer accommodating portion 20 can be avoided. More particularly, the problem is that by the developer entering portions of the drive converting mechanism where sliding motions occur, the particles of the developer are subjected to heat and pressure to soften and therefore, they agglomerate into masses (coarse particle), or they enter into a converting mechanism with the result of torque increase. The problem can be avoided.

### (Developer Discharging Principle by Pump Portion)

Referring to FIG. 34, a developer supplying step by the pump portion will be described.

In this example, as will be described hereinafter, the drive conversion of the rotational force is carries out by the drive converting mechanism so that the suction step (suction operation through discharge opening 21a) and the discharging step (discharging operation through the discharge opening 21a) are repeated alternately. The suction step and the discharging step will be described.

### (Suction Step)

First, the suction step (suction operation through discharge opening 21a) will be described.

As shown in part (a) of FIG. 34, the suction operation is effected by the pump portion 20b being expanded in a direction indicated by w by the above-described drive converting mechanism (cam mechanism). More particularly, by the suction operation, a volume of a portion of the developer supply container 1 (pump portion 20b, cylindrical portion 20k and flange portion 21) which can accommodate the developer increases.

At this time, the developer supply container 1 is substantially hermetically sealed except for the discharge opening 21a, and the discharge opening 21a is plugged substantially by the developer T. Therefore, the internal pressure of the developer supply container 1 decreases with the increase of the volume of the portion of the developer supply container 1 capable of containing the developer T.

At this time, the internal pressure of the developer supply container 1 is lower than the ambient pressure (external air pressure). For this reason, the air outside the developer supply container 1 enters the developer supply container 1 through the discharge opening 21a by a pressure difference between the inside and the outside of the developer supply container 1.

At this time, the air is taken-in from the outside of the developer supply container 1, and therefore, the developer T in the neighborhood of the discharge opening 21a can be loosened (fluidized). More particularly, the air impregnated into the developer powder existing in the neighborhood of the discharge opening 21a, thus reducing the bulk density of the developer powder T and fluidizing.

Since the air is taken into the developer supply container 1 through the discharge opening 21a as a result, the internal pressure of the developer supply container 1 changes in the neighborhood of the ambient pressure (external air pressure) despite the increase of the volume of the developer supply container 1.

In this manner, by the fluidization of the developer T, the developer T does not pack or clog in the discharge opening 21a, so that the developer can be smoothly discharged through the discharge opening 21a in the discharging operation which will be described hereinafter. Therefore, the amount of the developer T (per unit time) discharged through the discharge opening 21a can be maintained substantially at a constant level for a long term.

### (Discharging Step)

The discharging step (discharging operation through the discharge opening 21a) will be described.

As shown in part (b) of FIG. 34, the discharging operation is effected by the pump portion 20b being compressed in a direction indicated by γ by the above-described drive converting mechanism (cam mechanism). More particularly, by the discharging operation, a volume of a portion of the developer supply container 1 (pump portion 20b, cylindrical portion 20k and flange portion 21) which can accommodate the developer decreases. At this time, the developer supply container 1 is substantially hermetically sealed except for the discharge opening 21a, and the discharge opening 21a is plugged substantially by the developer T until the developer is discharged. Therefore, the internal pressure of the developer supply container 1 rises with the decrease of the volume of the portion of the developer supply container 1 capable of containing the developer T.

Since the internal pressure of the developer supply container 1 is higher than the ambient pressure (the external air pressure), the developer T is pushed out by the pressure difference between the inside and the outside of the developer supply container 1, as shown in part (b) of FIG. 34. That is, the developer T is discharged from the developer supply container 1 into the developer replenishing apparatus 8.

Thereafter, the air in the developer supply container 1 is also discharged with the developer T, and therefore, the internal pressure of the developer supply container 1 decreases.

As described in the foregoing, according to this example, the discharging of the developer can be effected efficiently using one reciprocation type pump, and therefore, the mechanism for the developer discharging can be simplified.

### (Set Condition of Cam Groove)

Referring to FIGS. 36-41, modified examples of the set condition of the cam groove 21b will be described. FIGS. 36-41 are developed views of cam grooves 3b. Referring to the developed views of FIGS. 36-41, the description will be made as to the influence to the operational condition of the pump portion 20b when the configuration of the cam groove 21b is changed.

Here, in each of FIGS. 36-41, an arrow A indicates a rotational moving direction of the developer accommodating portion 20 (moving direction of the cam projection 20d); an arrow B indicates the expansion direction of the pump portion 20b; and an arrow C indicates a compression direction of the pump portion 20b. In addition, a groove portion of the cam groove 21b for compressing the pump portion 20b is indicated as a cam groove 21c, and a groove portion for expanding the pump portion 20b is indicated as a cam groove 21d. Furthermore, an angle formed between the cam groove 21c and the rotational moving direction A of the developer accommodating portion 20 is α; an angle formed between the cam groove 21d and the rotational moving direction A is β; and an amplitude (expansion and contraction length of the pump portion 20b), in the expansion and contracting directions B, C of the pump portion 20b, of the cam groove is L.

First, the description will be made as to the expansion and contraction length L of the pump portion 20b.

When the expansion and contraction length L is shortened, the volume change amount of the pump portion 20b decreases, and therefore, the pressure difference from the external air pressure is reduced. Then, the pressure imparted to the developer in the developer supply container 1 decreases, with the result that the amount of the developer discharged from the developer supply container 1 per one cyclic period (one reciprocation, that is, one expansion and contracting operation of the pump portion 20b) decreases.

From this consideration, as shown in FIG. 36, the amount of the developer discharged when the pump portion 20b is reciprocated once, can be decreased as compared with the structure of FIG. 35, if an amplitude L′ is selected so as to satisfy L′<L under the condition that the angles α and β are constant. On the contrary, if L′>L, the developer discharge amount can be increased.

As regards the angles α and β of the cam groove, when the angles are increased, for example, the movement distance of the cam projection 20d when the developer accommodating portion 20 rotates for a constant time increases if the rotational speed of the developer accommodating portion 20 is constant, and therefore, as a result, the expansion-and-contraction speed of the pump portion 20b increases.

On the other hand, when the cam projection 20d moves in the cam groove 21b, the resistance received from the cam groove 21b is large, and therefore, a torque required for rotating the developer accommodating portion 20 increases as a result.

For this reason, as shown in FIG. 37, if the angle β′ of the cam groove 21d of the cam groove 21d is selected so as to satisfy α′>α and β′>β without changing the expansion and contraction length L, the expansion-and-contraction speed of the pump portion 20b can be increased as compared with the structure of the FIG. 35. As a result, the number of expansion and contracting operations of the pump portion 20b per one rotation of the developer accommodating portion 20 can be increased. Furthermore, since a flow speed of the air entering the developer supply container 1 through the discharge opening 21a increases, the loosening effect to the developer existing in the neighborhood of the discharge opening 21a is enhanced.

On the contrary, if the selection satisfies α′<α and β′<β, the rotational torque of the developer accommodating portion 20 can be decreased. When a developer having a high flowability is used, for example, the expansion of the pump portion 20b tends to cause the air entered through the discharge opening 21a to blow out the developer existing in the neighborhood of the discharge opening 21a. As a result, there is a possibility that the developer cannot be accumulated sufficiently in the discharging portion 21h, and therefore, the developer discharge amount decreases. In this case, by decreasing the expanding speed of the pump portion 20b in accordance with this selection, the blowing-out of the developer can be suppressed, and therefore, the discharging power can be improved.

If, as shown in FIG. 38, the angle of the cam groove 21b is selected so as to satisfy α<β, the expanding speed of the pump portion 20b can be increased as compared with a compressing speed. On the contrary, as shown in FIG. 40, if the angle α>the angle β, the expanding speed of the pump portion 20b can be reduced as compared with the compressing speed.

When the developer is in a highly packed state, for example, the operation force of the pump portion 20b is larger in a compression stroke of the pump portion 20b than in an expansion stroke thereof, with the result that the rotational torque for the developer accommodating portion 20 tends to be higher in the compression stroke of the pump portion 20b. However, in this case, if the cam groove 21b is constructed as shown in FIG. 38, the developer loosening effect in the expansion stroke of the pump portion 20b can be enhanced as compared with the structure of FIG. 35. In addition, the resistance received by the cam projection 20d from the cam groove 21b in the compression stroke is small, and therefore, the increase of the rotational torque in the compression of the pump portion 20b can be suppressed.

As shown in FIG. 39, a cam groove 21e substantially parallel with the rotational moving direction (arrow A in the Figure) of the developer accommodating portion 20 may be provided between the cam grooves 21c, 21d. In this case, the cam does not function while the cam projection 20d is moving in the cam groove 21e, and therefore, a step in which the pump portion 20b does not carry out the expanding-and-contracting operation can be provided.

By doing so, if a process in which the pump portion 20b is at rest in the expanded state is provided, the developer loosening effect is improved, since then in an initial stage of the discharging in which the developer is present always in the neighborhood of the discharge opening 21a, the pressure reduction state in the developer supply container 1 is maintained during the rest period.

On the other hand, in a last part of the discharging, the developer is not stored sufficiently in the discharging portion 21h, because the amount of the developer inside the developer supply container 1 is small and because the developer existing in the neighborhood of the discharge opening 21a is blown out by the air entered through the discharge opening 21a.

In other words, the developer discharge amount tends to gradually decrease, but even in such a case, by continuing to feed the developer by rotating is developer accommodating portion 20 during the rest period with the expanded state, the discharging portion 21h can be filled sufficiently with the developer. Therefore, a stabilization developer discharge amount can be maintained until the developer supply container 1 becomes empty.

In addition, in the structure of FIG. 35, by making the expansion and contraction length L of the cam groove longer, the developer discharging amount per one cyclic period of the pump portion 20b can be increased. However, in this case, the amount of the volume change of the pump portion 20b increases, and therefore, the pressure difference from the external air pressure also increases. For this reason, the driving force required for driving the pump portion 20b also increases, and therefore, there is a liability that a drive load required by the developer replenishing apparatus 8 is excessively large.

Under the circumstances, in order to increase the developer discharge amount per one cyclic period of the pump portion 20b without giving rise to such a problem, the angle of the cam groove 21b is selected so as to satisfy α>β, by which the compressing speed of a pump portion 20b can be increased as compared with the expanding speed, as shown in FIG. 40.

Verification experiments were carried out as to the structure of FIG. 40.

In the experiments, the developer is filled in the developer supply container 1 having the cam groove 21b shown in FIG. 40; the volume change of the pump portion 20b is carried out in the order of the compressing operation and then the expanding operation to discharge the developer; and the discharge amounts are measured. The experimental conditions are that the amount of the volume change of the pump portion 20b is 50 cm³, the compressing speed of the pump portion 20b the 180 cm³/s, and the expanding speed of the pump portion 20b is 60 cm³/s. The cyclic period of the operation of the pump portion 20b is approx. 1.1 seconds.

The developer discharge amounts are measured in the case of the structure of FIG. 35. However, the compressing speed and the expanding speed of the pump portion 20b are 90 cm³/s, and the amount of the volume change of the pump portion 20b and one cyclic period of the pump portion 20b is the same as in the example of FIG. 40.

The results of the verification experiments will be described. Part (a) of FIG. 42 shows the change of the internal pressure of the developer supply container 1 in the volume change of the pump 2b. In part (a) of FIG. 42, the abscissa represents the time, and the ordinate represents a relative pressure in the developer supply container 1 (+ is positive pressure side, is negative pressure side) relative to the ambient pressure (reference (0)). Solid lines and broken lines are for the developer supply container 1 having the cam groove 21b of FIG. 40, and that of FIG. 35, respectively.

In the compressing operation of the pump portion 20b, the internal pressures rise with elapse of time and reach the peaks upon completion of the compressing operation, in both examples. At this time, the pressure in the developer supply container 1 changes within a positive range relative to the ambient pressure (external air pressure), and therefore, the inside developer is pressurized, and the developer is discharged through the discharge opening 21a.

Subsequently, in the expanding operation of the pump portion 20b, the volume of the pump portion 20b increases for the internal pressures of the developer supply container 1 decrease, in both examples. At this time, the pressure in the developer supply container 1 changes from the positive pressure to the negative pressure relative to the ambient pressure (external air pressure), and the pressure continues to apply to the inside developer until the air is taken in through the discharge opening 21a, and therefore, the developer is discharged through the discharge opening 21a.

That is, in the volume change of the pump portion 20b, when the developer supply container 1 is in the positive pressure state, that is, when the inside developer is pressurized, the developer is discharged, and therefore, the developer discharge amount in the volume change of the pump portion 20b increases with a time-integration amount of the pressure.

As shown in part (a) of FIG. 42, the peak pressure at the time of completion of the compressing operation of the pump 2b is 5.7 kPa with the structure of FIG. 40 and is 5.4 kPa with the structure of the FIG. 35, and it is higher in the structure of FIG. 40 despite the fact that the volume change amounts of the pump portion 20b are the same. This is because by increasing the compressing speed of the pump portion 20b, the inside of the developer supply container 1 is pressurized abruptly, and the developer is concentrated to the discharge opening 21a at once, with the result that a discharge resistance in the discharging of the developer through the discharge opening 21a becomes large. Since the discharge openings 3a have small diameters in both examples, the tendency is remarkable. Since the time required for one cyclic period of the pump portion is the same in both examples as shown in (a) of FIG. 42, the time integration amount of the pressure is larger in the example of the FIG. 40.

Following Table 2 shows measured data of the developer discharge amount per one cyclic period operation of the pump portion 20b.

TABLE 2

| | Amount of developer discharge (g) |
|---|---|
| FIG. 35 | 3.4 |
| FIG. 40 | 3.7 |
| FIG. 41 | 4.5 |

As shown in Table 2, the developer discharge amount is 3.7 g in the structure of FIG. 40, and is 3.4 g in the structure of FIG. 35, that is, it is larger in the case of FIG. 40 structure. From these results and, the results of part (a) of the FIG. 42, it has been confirmed that the developer discharge amount per one cyclic period of the pump portion 20b increases with the time integration amount of the pressure.

From the foregoing, the developer discharging amount per one cyclic period of the pump portion 20b can be increased by making the compressing speed of the pump portion 20b higher as compared with the expansion speed and making the peak pressure in the compressing operation of the pump portion 20b higher as shown in FIG. 40.

The description will be made as to another method for increasing the developer discharging amount per one cyclic period of the pump portion 20b.

With the cam groove 21b shown in FIG. 41, similarly to the case of FIG. 39, a cam groove 21e substantially parallel with the rotational moving direction of the developer accommodating portion 20 is provided between the cam groove 21c and the cam groove 21d. However, in the case of the cam groove 21b shown in FIG. 41, the cam groove 21e is provided at such a position that in a cyclic period of the pump portion 20b, the operation of the pump portion 20b stops in the state that the pump portion 20b is compressed, after the compressing operation of the pump portion 20b.

With the structure of the FIG. 41, the developer discharge amount was measured similarly. In the verification experiments for this, the compressing speed and the expanding speed of the pump portion 20b is 180 cm³/s, and the other conditions are the same as with FIG. 40 example.

The results of the verification experiments will be described. Part (b) of the FIG. 42 shows changes of the internal pressure of the developer supply container 1 in the expanding-and-contracting operation of the pump portion 2b. Solid lines and broken lines are for the developer supply container 1 having the cam groove 21b of FIG. 41 and that of FIG. 40, respectively.

Also in the case of FIG. 41, the internal pressure rises with elapse of time during the compressing operation of the pump portion 20b, and reaches the peak upon completion of the compressing operation. At this time, similarly to FIG. 40, the pressure in the developer supply container 1 changes within the positive range, and therefore, the inside developer are discharged. The compressing speed of the pump portion 20b in the example of the FIG. 41 is the same as with FIG. 40 example, and therefore, the peak pressure upon completion of the compressing operation of the pump portion 2b is 5.7 kPa which is equivalent to the FIG. 40 example.

Subsequently, when the pump portion 20b stops in the compression state, the internal pressure of the developer supply container 1 gradually decreases. This is because the pressure produced by the compressing operation of the pump 2b remains after the operation stop of the pump 2b, and the inside developer and the air are discharged by the pressure. However, the internal pressure can be maintained at a level higher than in the case that the expanding operation is started immediately after completion of the compressing operation, and therefore, a larger amount of the developer is discharged during it.

When the expanding operation starts thereafter, similarly to the example of the FIG. 40, the internal pressure of the developer supply container 1 decreases, and the developer is discharged until the pressure in the developer supply container 1 becomes negative, since the inside developer is pressed continuously.

As time integration values of the pressure are compared as shown is part (b) of FIG. 42, it is larger in the case of FIG. 41, because the high internal pressure is maintained during the rest period of the pump portion 20b under the condition that the time durations in unit cyclic periods of the pump portion 20b in these examples are the same.

As shown in Table 2, the measured developer discharge amounts per one cyclic period of the pump portion 20b is 4.5 g in the case of FIG. 41, and is larger than in the case of FIG. 40 (3.7 g). From the results of the Table 2 and the results shown in part (b) of FIG. 42, it has been confirmed that the developer discharge amount per one cyclic period of the pump portion 20b increases with time integration amount of the pressure.

Thus, in the example of FIG. 41, the operation of the pump portion 20b is stopped in the compressed state, after the compressing operation. For this reason, the peak pressure in the developer supply container 1 in the compressing operation of the pump 2b is high, and the pressure is maintained at a level as high as possible, by which the developer discharging amount per one cyclic period of the pump portion 20b can be further increased.

As described in the foregoing, by changing the configuration of the cam groove 21b, the discharging power of the developer supply container 1 can be adjusted, and therefore, the apparatus of this embodiment can respond to a developer amount required by the developer replenishing apparatus 8 and to a property or the like of the developer to use.

In FIGS. 35-41, the discharging operation and the suction operation of the pump portion 20b are alternately carried out, but the discharging operation and/or the suction operation may be temporarily stopped partway, and a predetermined time after the discharging operation and/or the suction operation may be resumed.

For example, it is a possible alternative that the discharging operation of the pump portion 20b is not carried out monotonically, but the compressing operation of the pump portion is temporarily stopped partway, and then, the compressing operation is compressed to effect discharge. The same applies to the suction operation. Furthermore, the discharging operation and/or the suction operation may be multi-step type, as long as the developer discharge amount and the discharging speed are satisfied. Thus, even when the discharging operation and/or the suction operation are divided into multi-steps, the situation is still that the discharging operation and the suction operation are alternately repeated.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

In addition, in this example, the driving force for rotating the feeding portion (helical projection 20c) and the driving force for reciprocating the pump portion (bellow-like pump 2b) are received by a single drive inputting portion (gear portion 20a). Therefore, the structure of the drive inputting mechanism of the developer supply container can be simplified. In addition, by the single driving mechanism (driving gear 300) provided in the developer replenishing apparatus, the driving force is applied to the developer supply container, and therefore, the driving mechanism for the developer replenishing apparatus can be simplified. Furthermore, a simple and easy mechanism can be employed positioning the developer supply container relative to the developer replenishing apparatus.

With the structure of the example, the rotational force for rotating the feeding portion received from the developer replenishing apparatus is converted by the drive converting mechanism of the developer supply container, by which the pump portion can be reciprocated properly. In other words, in a system in which the developer supply container receives the reciprocating force from the developer replenishing apparatus, the appropriate drive of the pump portion is assured.

### Embodiment 6

Referring to FIG. 43 (parts (a) and (b)), structures of the Embodiment 6 will be described. Part (a) of the FIG. 43 is a schematic perspective view of the developer supply container 1, and part (b) of the FIG. 43 is a schematic sectional view illustrating a state in which a pump portion 20b expands. In this example, the same reference numerals as in Embodiment 1 are assigned to the elements having the corresponding functions in this embodiment, and the detailed description thereof is omitted.

In this example, a drive converting mechanism (cam mechanism) is provided together with a pump portion 20b in a position dividing a cylindrical portion 20k with respect to a rotational axis direction of the developer supply container 1, as is significantly different from Embodiment 5. The other structures are substantially similar to the structures of Embodiment 5.

As shown in part (a) of FIG. 43, in this example, the cylindrical portion 20k which feeds the developer toward a discharging portion 21h with rotation comprises a cylindrical portion 20k1 and a cylindrical portion 20k2. The pump portion 20b is provided between the cylindrical portion 20k1 and the cylindrical portion 20k2.

A cam flange portion 15 functioning as a drive converting mechanism is provided at a position corresponding to the pump portion 20b. An inner surface of the cam flange portion 15 is provided with a cam groove 15a extending over the entire circumference as in Embodiment 5. On the other hand, an outer surface of the cylindrical portion 20k2 is provided a cam projection 20d functioning as a drive converting mechanism and is locked with the cam groove 15a.

The developer replenishing apparatus 8 is provided with a portion similar to the rotational moving direction regulating portion 11 (FIG. 31), and is held substantially non-rotatably by this portion. Furthermore, the developer replenishing apparatus 8 is provided with a portion similar to the rotational axis direction regulating portion 30 (FIG. 31), and the flange portion 15 is held substantially non-rotatably by this portion.

Therefore, when a rotational force is inputted to a gear portion 20a, the pump portion 20b reciprocates together with the cylindrical portion 20k2 in the directions ω and γ.

As described in the foregoing, in this example, the suction operation and the discharging operation can be effected by a single pump, and therefore, the structure of the developer discharging mechanism can be simplified. By the suction operation through the suction operation, the decompressed state (negative pressure state) can be provided in the developer supply container, and therefore the developer can be efficiently loosened. In addition, also in the case that the pump portion 20b is disposed at a position dividing the cylindrical portion, the pump portion 20b can be reciprocated by the rotational driving force received from the developer replenishing apparatus 8, as in Embodiment 5.

Here, the structure of Embodiment 5 in which the pump portion 20b is directly connected with the discharging portion 21h is preferable from the standpoint that the pumping action of the pump portion 20b can be efficiently applied to the developer stored in the discharging portion 21h.

In addition, this embodiment requires an additional cam flange portion (drive converting mechanism) which are has to be held substantially stationarily by the developer replenishing apparatus 8. Furthermore, this embodiment requires an additional mechanism, in the developer replenishing apparatus 8, for limiting movement of the cam flange portion 15 in the rotational axis direction of the cylindrical portion 20k. Therefore, in view of such a complication, the structure of Embodiment 5 using the flange portion 21 is preferable.

This is because in Embodiment 5, the flange portion 21 is supported by the developer replenishing apparatus 8 in order to make the position of the discharge opening 21a substantially stationary, and one of the cam mechanisms constituting the drive converting mechanism is provided in the flange portion 21. That is the drive converting mechanism is simplified in this manner.

### Embodiment 7

Referring to FIG. 44, the structures of Embodiment 7 will be described. In this example, the same reference numerals as in the foregoing embodiments are assigned to the elements having the corresponding functions in this embodiment, and the detailed description thereof is omitted.

This example is significantly different from Embodiment 5 in that a drive converting mechanism (cam mechanism) is provided at an upstream end of the developer supply container 1 with respect to the feeding direction for the developer and in that the developer in the cylindrical portion 20k is fed using a stirring member 20m. The other structures are substantially similar to the structures of Embodiment 5.

As shown in FIG. 44, in this example, the stirring member 20m is provided in the cylindrical portion 20k as the feeding portion and rotates relative to the cylindrical portion 20k. The stirring member 20m rotates by the rotational force received by the gear portion 20a, relative to the cylindrical portion 20k fixed to the developer replenishing apparatus 8 non-rotatably, by which the developer is fed in a rotational axis direction toward the discharging portion 21h while being stirred. More particularly, the stirring member 20m is provided with a shaft portion and a feeding blade portion fixed to the shaft portion.

In this example, the gear portion 20a as the drive inputting portion is provided at one longitudinal end portion of the developer supply container 1 (righthand side in FIG. 44), and the gear portion 20a is connected co-axially with the stirring member 20m.

In addition, a hollow cam flange portion 21i which is integral with the gear portion 20a is provided at one longitudinal end portion of the developer supply container (righthand side in FIG. 44) so as to rotate co-axially with the gear portion 20a. The cam flange portion 21i is provided with a cam groove 21b which extends in an inner surface over the entire inner circumference, and the cam groove 21b is engaged with two cam projections 20d provided on an outer surface of the cylindrical portion 20k at substantially diametrically opposite positions, respectively.

One end portion (discharging portion 21h side) of the cylindrical portion 20k is fixed to the pump portion 20b, and the pump portion 20b is fixed to a flange portion 21 at one end portion (discharging portion 21h side) thereof. They are fixed by welding method. Therefore, in the state that it is mounted to the developer replenishing apparatus 8, the pump portion 20b and the cylindrical portion 20k are substantially non-rotatable relative to the flange portion 21.

Also in this example, similarly to the Embodiment 5, when the developer supply container 1 is mounted to the developer replenishing apparatus 8, the flange portion 21 (discharging portion 21h) is prevented from the movements in the rotational moving direction and the rotational axis direction by the developer replenishing apparatus 8.

Therefore, when the rotational force is inputted from the developer replenishing apparatus 8 to the gear portion 20a, the cam flange portion 21i rotates together with the stirring member 20m. As a result, the cam projection 20d is driven by the cam groove 21b of the cam flange portion 21i so that the cylindrical portion 20k reciprocates in the rotational axis direction to expand and contract the pump portion 20b.

In this manner, by the rotation of the stirring member 20m, the developer is fed to the discharging portion 21h, and the developer in the discharging portion 21h is finally discharged through a discharge opening 21a by the suction and discharging operation of the pump portion 20b.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

In addition, in the structure of this example, similarly to the Embodiments 5-6, both of the rotating operation of the stirring member 20m provided in the cylindrical portion 20k and the reciprocation of the pump portion 20b can be performed by the rotational force received by the gear portion 20a from the developer replenishing apparatus 8.

In the case of this example, the stress applied to the developer in the developer feeding step at the cylindrical portion 20k tends to be relatively large, and the driving torque is relatively large, and from this standpoint, the structures of Embodiments 5 and 6 are preferable.

### Embodiment 8

Referring to FIG. 45 (parts (a)-(d)), structures of the Embodiment 8 will be described. Part (a) of FIG. 45 is a schematic perspective view of a developer supply container 1, (b) is an enlarged sectional view of the developer supply container 1, and (c)-(d) are enlarged perspective views of the cam portions. In this example, the same reference numerals as in the foregoing Embodiments are assigned to the elements having the corresponding functions in this embodiment, and the detailed description thereof is omitted.

This example is substantially the same as Embodiment 5 except that the pump portion 20b is made non-rotatable by a developer replenishing apparatus 8.

In this example, as shown in parts (a) and (b) of FIG. 45, relaying portion 20f is provided between a pump portion 20b and a cylindrical portion 20k of a developer accommodating portion 20. The relaying portion 20f is provided with two cam projections 20d on the outer surface thereof at the positions substantially diametrically opposed to each other, and one end thereof (discharging portion 21h side) is connected to and fixed to the pump portion 20b (welding method).

Another end (discharging portion 21h side) of the pump portion 20b is fixed to a flange portion 21 (welding method), and in the state that it is mounted to the developer replenishing apparatus 8, it is substantially non-rotatable.

A sealing member 27 is compressed between the cylindrical portion 20k and the relaying portion 20f, and the cylindrical portion 20k is unified so as to be rotatable relative to the relaying portion 20f. The outer peripheral portion of the cylindrical portion 20k is provided with a rotation receiving portion (projection) 20g for receiving a rotational force from a cam gear portion 7, as will be described hereinafter.

On the other hand, the cam gear portion 7 which is cylindrical is provided so as to cover the outer surface of the relaying portion 20f. The cam gear portion 7 is engaged with the flange portion 21 so as to be substantially stationary (movement within the limit of play is permitted), and is rotatable relative to the flange portion 21.

As shown in part (c) of FIG. 45, the cam gear portion 7 is provided with a gear portion 7a as a drive inputting portion for receiving the rotational force from the developer replenishing apparatus 8, and a cam groove 7b engaged with the cam projection 20d. In addition, as shown in part (d) of FIG. 45, the cam gear portion 7 is provided with a rotational engaging portion (recess) 7c engaged with the rotation receiving portion 20g to rotate together with the cylindrical portion 20k. Thus, by the above-described engaging relation, the rotational engaging portion (recess) 7c is permitted to move relative to the rotation receiving portion 20g in the rotational axis direction, but it can rotate integrally in the rotational moving direction.

The description will be made as to a developer supplying step of the developer supply container 1 in this example.

When the gear portion 7a receives a rotational force from the driving gear 300 of the developer replenishing apparatus 8, and the cam gear portion 7 rotates, the cam gear portion 7 rotates together with the cylindrical portion 20k because of the engaging relation with the rotation receiving portion 20g by the rotational engaging portion 7c. That is, the rotational engaging portion 7c and the rotation receiving portion 20g function to transmit the rotational force which is received by the gear portion 7a from the developer replenishing apparatus 8, to the cylindrical portion 20k (feeding portion 20c).

On the other hand, similarly to Embodiments 5-7, when the developer supply container 1 is mounted to the developer replenishing apparatus 8, the flange portion 21 is non-rotatably supported by the developer replenishing apparatus 8, and therefore, the pump portion 20b and the relaying portion 20f fixed to the flange portion 21 is also non-rotatable. In addition, the movement of the flange portion 21 in the rotational axis direction is prevented by the developer replenishing apparatus 8.

Therefore, when the cam gear portion 7 rotates, a cam function occurs between the cam groove 7b of the cam gear portion 7 and the cam projection 20d of the relaying portion 20f. Thus, the rotational force inputted to the gear portion 7a from the developer replenishing apparatus 8 is converted to the force reciprocating the relaying portion 20f and the cylindrical portion 20k in the rotational axis direction of the developer accommodating portion 20. As a result, the pump portion 20b which is fixed to the flange portion 21 at one end position (left side in part (b) of the FIG. 45) with respect to the reciprocating direction expands and contracts in interrelation with the reciprocation of the relaying portion 20f and the cylindrical portion 20k, thus effecting a pump operation.

In this manner, with the rotation of the cylindrical portion 20k, the developer is fed to the discharging portion 21h by the feeding portion 20c, and the developer in the discharging portion 21h is finally discharged through a discharge opening 21a by the suction and discharging operation of the pump portion 20b.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

In addition, in this example, the rotational force received from the developer replenishing apparatus 8 is transmitted and converted simultaneously to the force rotating the cylindrical portion 20k and to the force reciprocating (expanding-and-contracting operation) the pump portion 20b in the rotational axis direction.

Therefore, also in this example, similarly to Embodiments 5-7, by the rotational force received from the developer replenishing apparatus 8, both of the rotating operation of the cylindrical portion 20k (feeding portion 20c) and the reciprocation of the pump portion 20b can be effected.

### Embodiment 9

Referring to parts (a) and (b) of the FIG. 46, Embodiment 9 will be described. Part (a) of the FIG. 46 is a schematic perspective view of a developer supply container 1, and part (b) is an enlarged sectional view of the developer supply container 1. In this example, the same reference numerals as in the foregoing Embodiments are assigned to the elements having the corresponding functions in this embodiment, and the detailed description thereof is omitted.

This example is significantly different from Embodiment 5 in that a rotational force received from a driving mechanism 300 of a developer replenishing apparatus 8 is converted to a reciprocating force for reciprocating a pump portion 20b, and then the reciprocating force is converted to a rotational force, by which a cylindrical portion 20k is rotated.

In this example, as shown in part (b) of the FIG. 46, a relaying portion 20f is provided between the pump portion 20b and the cylindrical portion 20k. The relaying portion 20f includes two cam projections 20d at substantially diametrically opposite positions, respectively, and one end sides thereof (discharging portion 21h side) are connected and fixed to the pump portion 20b by welding method.

Another end (discharging portion 21h side) of the pump portion 20b is fixed to a flange portion 21 (welding method), and in the state that it is mounted to the developer replenishing apparatus 8, it is substantially non-rotatable.

Between the one end portion of the cylindrical portion 20k and the relaying portion 20f, a sealing member 27 is compressed, and the cylindrical portion 20k is unified such that it is rotatable relative to the relaying portion 20f. An outer periphery portion of the cylindrical portion 20k is provided with two cam projections 20i at substantially diametrically opposite positions, respectively.

On the other hand, a cylindrical cam gear portion 7 is provided so as to cover the outer surfaces of the pump portion 20b and the-relaying portion 20f. The cam gear portion 7 is engaged so that it is non-movable relative to the flange portion 21 in a rotational axis direction of the cylindrical portion 20k but it is rotatable relative thereto. The cam gear portion 7 is provided with a gear portion 7a as a drive inputting portion for receiving the rotational force from the developer replenishing apparatus 8, and a cam groove 7b engaged with the cam projection 20d.

Furthermore, there is provided a cam flange portion 15 covering the outer surfaces of the relaying portion 20f and the cylindrical portion 20k. When the developer supply container 1 is mounted to a mounting portion 8f of the developer replenishing apparatus 8, cam flange portion 15 is substantially non-movable. The cam flange portion 15 is provided with a cam projection 20i and a cam groove 15a.

A developer supplying step in this example will be described.

The gear portion 7a receives a rotational force from a driving gear 300 of the developer replenishing apparatus 8 by which the cam gear portion 7 rotates. Then, since the pump portion 20b and the relaying portion 20f are held non-rotatably by the flange portion 21, a cam function occurs between the cam groove 7b of the cam gear portion 7 and the cam projection 20d of the relaying portion 20f.

More particularly, the rotational force inputted to the gear portion 7a from the developer replenishing apparatus 8 is converted to a reciprocation force the relaying portion 20f in the rotational axis direction of the cylindrical portion 20k. As a result, the pump portion 20b which is fixed to the flange portion 21 at one end with respect to the reciprocating direction the left side of the part (b) of the FIG. 46) expands and contracts in interrelation with the reciprocation of the relaying portion 20f, thus effecting the pump operation.

When the relaying portion 20f reciprocates, a cam function works between the cam groove 15a of the cam flange portion 15 and the cam projection 20i by which the force in the rotational axis direction is converted to a force in the rotational moving direction, and the force is transmitted to the cylindrical portion 20k. As a result, the cylindrical portion 20k (feeding portion 20c) rotates. In this manner, with the rotation of the cylindrical portion 20k, the developer is fed to the discharging portion 21h by the feeding portion 20c, and the developer in the discharging portion 21h is finally discharged through a discharge opening 21a by the suction and discharging operation of the pump portion 20b.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

In addition, in this example, the rotational force received from the developer replenishing apparatus 8 is converted to the force reciprocating the pump portion 20b in the rotational axis direction (expanding-and-contracting operation), and then the force is converted to a force rotation the cylindrical portion 20k and is transmitted.

Therefore, also in this example, similarly to Embodiments 5-8, by the rotational force received from the developer replenishing apparatus 8, both of the rotating operation of the cylindrical portion 20k (feeding portion 20c) and the reciprocation of the pump portion 20b can be effected.

However, in this example, the rotational force inputted from the developer replenishing apparatus 8 is converted to the reciprocating force and then is converted to the force in the rotational moving direction with the result of complicated structure of the drive converting mechanism, and therefore, Embodiments 5-8 in which the re-conversion is unnecessary are preferable.

### Embodiment 10

Referring to parts (a)-(b) of FIG. 47 and parts (a)-(d) of FIG. 48, Embodiment 10 will be described. Part (a) of FIG. 47 is a schematic perspective view of a developer supply container, part (b) is an enlarged sectional view of the developer supply container 1, and parts (a)-(d) of FIG. 48 are enlarged views of a drive converting mechanism. In parts (a)-(d) of FIG. 48, a gear ring 60 and a rotational engaging portion 8b are shown as always taking top positions for better illustration of the operations thereof. In this example, the same reference numerals as in the foregoing embodiments are assigned to the elements having the corresponding functions in this embodiment, and the detailed description thereof is omitted.

In this example, the drive converting mechanism employs a bevel gear, as is contrasted to the foregoing examples.

As shown in part (b) of FIG. 47, a relaying portion 20f is provided between a pump portion 20b and a cylindrical portion 20k. The relaying portion 20f is provided with an engaging projection 20h engaged with a connecting portion 62 which will be described hereinafter.

Another end (discharging portion 21h side) of the pump portion 20b is fixed to a flange portion 21 (welding method), and in the state that it is mounted to the developer replenishing apparatus 8, it is substantially non-rotatable.

A sealing member 27 is compressed between the discharging portion 21h side end of the cylindrical portion 20k and the relaying portion 20f, and the cylindrical portion 20k is unified so as to be rotatable relative to the relaying portion 20f. An outer periphery portion of the cylindrical portion 20k is provided with a rotation receiving portion (projection) 20g for receiving a rotational force from the gear ring 60 which will be described hereinafter.

On the other hand, a cylindrical gear ring 60 is provided so as to cover the outer surface of the cylindrical portion 20k. The gear ring 60 is rotatable relative to the flange portion 21.

As shown in parts (a) and (b) of FIG. 47, the gear ring 60 includes a gear portion 60a for transmitting the rotational force to the bevel gear 61 which will be described hereinafter and a rotational engaging portion (recess) 60b for engaging with the rotation receiving portion 20g to rotate together with the cylindrical portion 20k. By the above-described engaging relation, the rotational engaging portion (recess) 60b is permitted to move relative to the rotation receiving portion 20g in the rotational axis direction, but it can rotate integrally in the rotational moving direction.

On the outer surface of the flange portion 21, the bevel 61 is provided so as to be rotatable relative to the flange portion 21. Furthermore, the bevel 61 and the engaging projection 20h are connected by a connecting portion 62.

A developer supplying step of the developer supply container 1 will be described.

When the cylindrical portion 20k rotates by the gear portion 20a of the developer accommodating portion 20 receiving the rotational force from the driving gear 300 of the developer replenishing apparatus 8, gear ring 60 rotates with the cylindrical portion 20k since the cylindrical portion 20k is in engagement with the gear ring 60 by the receiving portion 20g. That is, the rotation receiving portion 20g and the rotational engaging portion 60b function to transmit the rotational force inputted from the developer replenishing apparatus 8 to the gear portion 20a to the gear ring 60.

On the other hand, when the gear ring 60 rotates, the rotational force is transmitted to the bevel gear 61 from the gear portion 60a so that the bevel gear 61 rotates. The rotation of the bevel gear 61 is converted to reciprocating motion of the engaging projection 20h through the connecting portion 62, as shown in parts (a)-(d) of the FIG. 48. By this, the relaying portion 20f having the engaging projection 20h is reciprocated. As a result, the pump portion 20b expands and contracts in interrelation with the reciprocation of the relaying portion 20f to effect a pump operation.

In this manner, with the rotation of the cylindrical portion 20k, the developer is fed to the discharging portion 21h by the feeding portion 20c, and the developer in the discharging portion 21h is finally discharged through a discharge opening 21a by the suction and discharging operation of the pump portion 20b.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

Therefore, also in this example, similarly to Embodiments 5-9, by the rotational force received from the developer replenishing apparatus 8, both of the rotating operation of the cylindrical portion 20k (feeding portion 20c) and the reciprocation of the pump portion 20b can be effected.

In the case of the drive converting mechanism using the bevel gear, the number of the parts increases, and therefore, the structures of Embodiments 5-9 are preferable.

### Embodiment 11

Referring to FIG. 49 (parts (a)-(c)), structures of the Embodiment 11 will be described. Part (a) of FIG. 49 is an enlarged perspective view of a drive converting mechanism, and (b)-(c) are enlarged views thereof as seen from the top. In this example, the same reference numerals as in the foregoing embodiments are assigned to the elements having the corresponding functions in this embodiment, and the detailed description thereof is omitted. In parts (b) and (c) of FIG. 49, a gear ring 60 and a rotational engaging portion 60b are schematically shown as being at the top for the convenience of illustration of the operation.

In this embodiment, the drive converting mechanism includes a magnet (magnetic field generating means) as is significantly different from Embodiments.

As shown in FIG. 49 (FIG. 48 if necessary), the bevel gear 61 is provided with a rectangular parallelepiped shape magnet, and an engaging projection 20h of a relaying portion 20f is provided with a bar-like magnet 64 having a magnetic pole directed to the magnet 63. The rectangular parallelepiped shape magnet 63 has an N pole at one longitudinal end thereof and an S pole as the other end, and the orientation thereof changes with the rotation of the bevel gear 61. The bar-like magnet 64 has an S pole at one longitudinal end adjacent an outside of the container and an N pole at the other end, and it is movable in the rotational axis direction. The magnet 64 is non-rotatable by an elongated guide groove formed in the outer peripheral surface of the flange portion 21.

With such a structure, when the magnet 63 is rotated by the rotation of the bevel gear 61, the magnetic pole facing the magnet and exchanges, and therefore, attraction and repelling between the magnet 63 and the magnet 64 are repeated alternately. As a result, a pump portion 20b fixed to the relaying portion 20f is reciprocated in the rotational axis direction.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

As described in the foregoing, similarly to Embodiments 5-10, the rotating operation of the feeding portion 20c (cylindrical portion 20k) and the reciprocation of the pump portion 20b are both effected by the rotational force received from the developer replenishing apparatus 8, in this embodiment.

In this example, the bevel gear 61 is provided with the magnet, but this is not inevitable, and another way of use of magnetic force (magnetic field) is applicable.

From the standpoint of certainty of the drive conversion, Embodiments 5-10 are preferable. In the case that the developer accommodated in the developer supply container 1 is a magnetic developer (one component magnetic toner, two component magnetic carrier), there is a liability that the developer is trapped in an inner wall portion of the container adjacent to the magnet. Then, an amount of the developer remaining in the developer supply container 1 may be large, and from this standpoint, the structures of Embodiments 5-10 are preferable.

### Embodiment 12

Referring to parts (a)-(b) of FIG. 50 and parts (a)-(b) of FIG. 51, Embodiment 6 will be described. Part (a) of the FIG. 50 is a schematic view illustrating an inside of a developer supply container 1, (b) is a sectional view in a state that the pump portion 20b is expanded to the maximum in the developer supplying step, showing (c) is a sectional view of the developer supply container 1 in a state that the pump portion 20b is compressed to the maximum in the developer supplying step. Part (a) of FIG. 51 is a schematic view illustrating an inside of the developer supply container 1, and (b) is a perspective view of a rear end portion of the cylindrical portion 20k. In this example, the same reference numerals as in Embodiments are assigned to the elements having the corresponding functions in this embodiment, and the detailed description thereof is omitted.

This embodiment is significantly different from the structures of the above-described embodiments in that the pump portion 20b is provided at a leading end portion of the developer supply container 1 and in that the pump portion 20b does not have the functions of transmitting the rotational force received from the driving gear 300 to the cylindrical portion 20k. More particularly, the pump portion 20b is provided outside a drive conversion path of the drive converting mechanism, that is, outside a drive transmission path extending from the coupling portion 20a (part (b) of FIG. 51) received the rotational force from the driving gear 300 to the cam groove 20n.

This structure is employed in consideration of the fact that with the structure of Embodiment 5, after the rotational force inputted from the driving gear 300 is transmitted to the cylindrical portion 20k through the pump portion 20b, it is converted to the reciprocation force, and therefore, the pump portion 20b receives the rotational moving direction always in the developer supplying step operation. Therefore, there is a liability that in the developer supplying step the pump portion 20b is twisted in the rotational moving direction with the results of deterioration of the pump function. This will be described in detail.

As shown in part (a) of FIG. 50, an opening portion of one end portion (discharging portion 21h side) of the pump portion 20b is fixed to a flange portion 21 (welding method), and when the container is mounted to the developer replenishing apparatus 8, the pump portion 20b is substantially non-rotatable with the flange portion 21.

On the other hand, a cam flange portion 15 is provided covering the outer surface of the flange portion 21 and/or the cylindrical portion 20k, and the cam flange portion 15 functions as a drive converting mechanism. As shown in FIG. 50, the inner surface of the cam flange portion 15 is provided with two cam projections 15a at diametrically opposite positions, respectively. In addition, the cam flange portion 15 is fixed to the closed side (opposite the discharging portion 21h side) of the pump portion 20b.

On the other hand, the outer surface of the cylindrical portion 20k is provided with a cam groove 20n functioning as the drive converting mechanism, the cam groove 20n extending over the entire circumference, and the cam projection 15a is engaged with the cam groove 20n.

Furthermore, in this embodiment, as is different from Embodiment 5, as shown in part (b) of the FIG. 51, one end surface of the cylindrical portion 20k (upstream side with respect to the feeding direction of the developer) is provided with a non-circular (rectangular in this example) male coupling portion 20a functioning as the drive inputting portion. On the other hand, the developer replenishing apparatus 8 includes non-circular (rectangular) female coupling portion) for driving connection with the male coupling portion 20a to apply a rotational force. The female coupling portion, similarly to Embodiment 5, is driven by a driving motor 500.

In addition, the flange portion 21 is prevented, similarly to Embodiment 5, from moving in the rotational axis direction and in the rotational moving direction by the developer replenishing apparatus 8. On the other hand, the cylindrical portion 20k is connected with the flange portion 21 through a seal portion 27, and the cylindrical portion 20k is rotatable relative to the flange portion 21. The seal portion 27 is a sliding type seal which prevents incoming and outgoing leakage of air (developer) between the cylindrical portion 20k and the flange portion 21 within a range not influential to the developer supply using the pump portion 20b and which permits rotation of the cylindrical portion 20k.

The developer supplying step of the developer supply container 1 will be described.

The developer supply container 1 is mounted to the developer replenishing apparatus 8, and then the cylindrical portion 20k receptions the rotational force from the female coupling portion of the developer replenishing apparatus 8, by which the cam groove 20n rotates.

Therefore, the cam flange portion 15 reciprocates in the rotational axis direction relative to the flange portion 21 and the cylindrical portion 20k by the cam projection 15a engaged with the cam groove 20n, while the cylindrical portion 20k and the flange portion 21 are prevented from movement in the rotational axis direction by the developer replenishing apparatus 8.

Since the cam flange portion 15 and the pump portion 20b are fixed with each other, the pump portion 20b reciprocates with the cam flange portion 15 (ω direction and γ direction). As a result, as shown in parts (b) and (c) of FIG. 50, the pump portion 20b expands and contracts in interrelation with the reciprocation of the cam flange portion 15, thus effecting a pumping operation.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

In addition, also in this example, similar to the above-described Embodiments 5-11, the rotational force received from the developer replenishing apparatus 8 is converted a force operating the pump portion 20b, in the developer supply container 1, so that the pump portion 20b can be operated properly.

In addition, the rotational force received from the developer replenishing apparatus 8 is converted to the reciprocation force without using the pump portion 20b, by which the pump portion 20b is prevented from being damaged due to the torsion in the rotational moving direction. Therefore, it is unnecessary to increase the strength of the pump portion 20b, and the thickness of the pump portion 20b may be small, and the material thereof may be an inexpensive one.

Furthermore, in the structure of the this example, the pump portion 20b is not provided between the discharging portion 21h and the cylindrical portion 20k as in Embodiments 5-11, but is disposed at a position away from the cylindrical portion 20k of the discharging portion 21h, and therefore, the amount of the developer remaining in the developer supply container 1 can be reduced.

As shown in (a) of FIG. 51, it is a usable alternative that the internal space of the pump portion 20b is not uses as a developer accommodating space, and the filter 65 partitions between the pump portion 20b and the discharging portion 21h. Here, the filter has such a property that the air is easily passed, but the toner is not passed substantially.

With such a structure, when the pump portion 20b is compressed, the developer in the recessed portion of the bellow portion is not stressed. However, the structure of parts (a)-(c) of FIG. 50 is preferable from the standpoint that in the expanding stroke of the pump portion 20b, an additional developer accommodating space can be formed, that is, an additional space through which the developer can move is provided, so that the developer is easily loosened.

### Embodiment 13

Referring to FIG. 52 (parts (a)-(c)), structures of the Embodiment 13 will be described. Parts (a)-(c) of FIG. 52 are enlarged sectional views of a developer supply container 1. In parts (a)-(c) of FIG. 52, the structures except for the pump are substantially the same as structures shown in FIGS. 50 and 51, and therefore, the detailed description there of is omitted.

In this example, the pump does not have the alternating peak folding portions and bottom folding portions, but it has a film-like pump 12 capable of expansion and contraction substantially without a folding portion, as shown in FIG. 52.

In this embodiment, the film-like pump 12 is made of rubber, but this is not inevitable, and flexible material such as resin film is usable.

With such a structure, when the cam flange portion 15 reciprocates in the rotational axis direction, the film-like pump 12 reciprocates together with the cam flange portion 15. As a result, as shown in parts (b) and (c) of FIG. 52, the film-like pump 12 expands and contracts interrelated with the reciprocation of the cam flange portion 15 in the directions of w and y, thus effecting a pumping operation.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

Also in this embodiment, similarly to Embodiments 5-12, the rotational force received from the developer replenishing apparatus 8 is converted to a force effective to operate the pump portion 12 in the developer supply container 1, and therefore, the pump portion 12 can be properly operated.

### Embodiment 14

Referring to FIG. 53 (parts (a)-(e)), structures of the Embodiment 14 will be described. Part (a) of FIG. 53 is a schematic perspective view of the developer supply container 1, and (b) is an enlarged sectional view of the developer supply container 1, and (c)-(e) are schematic enlarged views of a drive converting mechanism. In this example, the same reference numerals as in the foregoing embodiments are assigned to the elements having the corresponding functions in this embodiment, and the detailed description thereof is omitted.

In this example, the pump portion is reciprocated in a direction perpendicular to a rotational axis direction, as is contrasted to the foregoing embodiments.

### (Drive Converting Mechanism)

In this example, as shown in parts (a)-(e) of FIG. 53, at an upper portion of the flange portion 21, that is, the discharging portion 21h, a pump portion 21f of bellow type is connected. In addition, to a top end portion of the pump portion 21f, a cam projection 21g functioning as a drive converting portion is fixed by bonding. On the other hand, at one longitudinal end surface of the developer accommodating portion 20, a cam groove 20e engageable with a cam projection 21g is formed and it function as a drive converting portion.

As shown in part (b) of FIG. 53, the developer accommodating portion 20 is fixed so as to be rotatable relative to discharging portion 21h in the state that a discharging portion 21h side end compresses a sealing member 27 provided on an inner surface of the flange portion 21.

Also in this example, with the mounting operation of the developer supply container 1, both sides of the discharging portion 21h (opposite end surfaces with respect to a direction perpendicular to the rotational axis direction X) are supported by the developer replenishing apparatus 8. Therefore, during the developer supply operation, the discharging portion 21h is substantially non-rotatable.

In addition, with the mounting operation of the developer supply container 1, a projection 21j provided on the outer bottom surface portion of the discharging portion 21h is locked by a recess provided in a mounting portion 8f. Therefore, during the developer supply operation, the discharging portion 21h is fixed so as to be substantially non-rotatable in the rotational axis direction.

Here, the configuration of the cam groove 20e is elliptical configuration as shown in (c)-(e) of FIG. 53, and the cam projection 21g moving along the cam groove 20e changes in the distance from the rotational axis of the developer accommodating portion 20 (minimum distance in the diametrical direction).

As shown in (b) of FIG. 53, a plate-like partition wall 32 is provided and is effective to feed, to the discharging portion 21h, a developer fed by a helical projection (feeding portion) 20c from the cylindrical portion 20k. The partition wall 32 divides a part of the developer accommodating portion 20 substantially into two parts and is rotatable integrally with the developer accommodating portion 20. The partition wall 32 is provided with an inclined projection 32a slanted relative to the rotational axis direction of the developer supply container 1. The inclined projection 32a is connected with an inlet portion of the discharging portion 21h.

Therefore, the developer fed from the feeding portion 20c is scooped up by the partition wall 32 in interrelation with the rotation of the cylindrical portion 20k. Thereafter, with a further rotation of the cylindrical portion 20k, the developer slide down on the surface of the partition wall 32 by the gravity, and is fed to the discharging portion 21h side by the inclined projection 32a. The inclined projection 32a is provided on each of the sides of the partition wall 32 so that the developer is fed into the discharging portion 21h every one half rotation of the cylindrical portion 20k.

### (Developer Supplying Step)

The description will be made as to developer supplying step from the developer supply container 1 in this example.

When the operator mounts the developer supply container 1 to the developer replenishing apparatus 8, the flange portion 21 (discharging portion 21h) is prevented from movement in the rotational moving direction and in the rotational axis direction by the developer replenishing apparatus 8. In addition, the pump portion 21f and the cam projection 21g are fixed to the flange portion 21, and are prevented from movement in the rotational moving direction and in the rotational axis direction, similarly.

And, by the rotational force inputted from a driving gear 300 (FIGS. 32 and 33) to a gear portion 20a, the developer accommodating portion 20 rotates, and therefore, the cam groove 20e also rotates. On the other hand, the cam projection 21g which is fixed so as to be non-rotatable receives the force through the cam groove 20e, so that the rotational force inputted to the gear portion 20a is converted to a force reciprocating the pump portion 21f substantially vertically.

Here, part (d) of FIG. 53 illustrates a state in which the pump portion 21f is most expanded, that is, the cam projection 21g is at the intersection between the ellipse of the cam groove 20e and the major axis La (point Y in (c) of FIG. 53). Part (e) of FIG. 53 illustrates a state in which the pump portion 21f is most contracted, that is, the cam projection 21g is at the intersection between the ellipse of the cam groove 20e and the minor axis La (point Z in (c) of FIG. 53).

The state of (d) of FIG. 53 and the state of (e) of FIG. 53 are repeated alternately at predetermined cyclic period so that the pump portion 21f effects the suction and discharging operation. That is the developer is discharged smoothly.

With such rotation of the cylindrical portion 20k, the developer is fed to the discharging portion 21h by the feeding portion 20c and the inclined projection 32a, and the developer in the discharging portion 21h is finally discharged through the discharge opening 21a by the suction and discharging operation of the pump portion 21f.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

In addition, also in this example, similarly to Embodiments 5-13, by the gear portion 20a receiving the rotational force from the developer replenishing apparatus 8, both of the rotating operation of the feeding portion 20c (cylindrical portion 20k) and the reciprocation of the pump portion 21f can be effected.

Since, in this example, the pump portion 21f is provided at a top of the discharging portion 21h (in the state that the developer supply container 1 is mounted to the developer replenishing apparatus 8), the amount of the developer unavoidably remaining in the pump portion 21f can be minimized as compared with Embodiment 5.

In this example, the pump portion 21f is a bellow-like pump, but it may be replaced with a film-like pump described in Embodiment 13.

In this example, the cam projection 21g as the drive transmitting portion is fixed by an adhesive material to the upper surface of the pump portion 21f, but the cam projection 21g is not necessarily fixed to the pump portion 21f. For example, a known snap hook engagement is usable, or a round rod-like cam projection 21g and a pump portion 21f having a hole engageable with the cam projection 21g may be used in combination. With such a structure, the similar advantageous effects can be provided.

### Embodiment 15

Referring to FIGS. 54-56, the description will be made as to structures of Embodiment 11. Part of (a) of FIG. 54 is a schematic perspective view of a developer supply container 1, (b) is a schematic perspective view of a flange portion 21, (c) is a schematic perspective view of a cylindrical portion 20k, part (a)-(b) of FIG. 55 are enlarged sectional views of the developer supply container 1, and FIG. 56 is a schematic view of a pump portion 21f. In this example, the same reference numerals as in the foregoing embodiments are assigned to the elements having the corresponding functions in this embodiment, and the detailed description thereof is omitted.

In this example, a rotational force is converted to a force for forward operation of the pump portion 21f without converting the rotational force to a force for backward operation of the pump portion, as is contrasted to the foregoing embodiments.

In this example, as shown in FIGS. 54-56, a bellow type pump portion 21f is provided at a side of the flange portion 21 adjacent the cylindrical portion 20k. An outer surface of the cylindrical portion 20k is provided with a gear portion 20a which extends on the full circumference. At an end of the cylindrical portion 20k adjacent a discharging portion 21h, two compressing projections 2l for compressing the pump portion 21f by abutting to the pump portion 21f by the rotation of the cylindrical portion 20k are provided at diametrically opposite positions, respectively. A configuration of the compressing projection 20l at a downstream side with respect to the rotational moving direction is slanted to gradually compress the pump portion 21f so as to reduce the impact upon abutment to the pump portion 21f. On the other hand, a configuration of the compressing projection 20l at the upstream side with respect to the rotational moving direction is a surface perpendicular to the end surface of the cylindrical portion 20k to be substantially parallel with the rotational axis direction of the cylindrical portion 20k so that the pump portion 21f instantaneously expands by the restoring elastic force thereof.

Similarly to Embodiment 10, the inside of the cylindrical portion 20k is provided with a plate-like partition wall 32 for feeding the developer fed by a helical projection 20c to the discharging portion 21h.

The description will be made as to developer supplying step from the developer supply container 1 in this example.

After the developer supply container 1 is mounted to the developer replenishing apparatus 8, cylindrical portion 20k which is the developer accommodating portion 20 rotates by the rotational force inputted from the driving gear 300 to the gear portion 20a, so that the compressing projection 2l rotates. At this time, when the compressing projections 2l abut to the pump portion 21f, the pump portion 21f is compressed in the direction of an arrow y, as shown in part (a) of FIG. 55, so that a discharging operation is effected.

On the other hand, when the rotation of the cylindrical portion 20k continues until the pump portion 21f is released from the compressing projection 2l, the pump portion 21f expands in the direction of an arrow w by the self-restoring force, as shown in part (b) of FIG. 55, so that it restores to the original shape, by which the suction operation is effected.

The states shown in (a) and (b) of FIG. 55 are alternately repeated, by which the pump portion 21f effects the suction and discharging operations. That is, the developer is discharged smoothly.

With the rotation of the cylindrical portion 20k in this manner, the developer is fed to the discharging portion 21h by the helical projection (feeding portion) 20c and the inclined projection (feeding portion) 32a (FIG. 53). The developer in the discharging portion 21h is finally discharged through the discharge opening 21a by the discharging operation of the pump portion 21f.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened. In addition, in this example, similarly to Embodiments 5-14, the rotational force received from the developer replenishing apparatus 8, both of the rotating operation of developer supply container 1 and the reciprocation of the pump portion 21f can be effected.

In this example, the pump portion 21f is compressed by the contact to the compressing projection 20l, and expands by the self-restoring force of the pump portion 21f when it is released from the compressing projection 2l, but the structure may be opposite.

More particularly, when the pump portion 21f is contacted by the compressing projection 2l, they are locked, and with the rotation of the cylindrical portion 20k, the pump portion 21f is forcedly expanded. With further rotation of the cylindrical portion 20k, the pump portion 21f is released, by which the pump portion 21f restores to the original shape by the self-restoring force (restoring elastic force). Thus, the suction operation and the discharging operation are alternately repeated.

In the case of this example, the self restoring power of the pump 21f is likely to be deteriorated by repetition of the expansion and contraction of the pump portion 21f for a long term, and from this standpoint, the structures of Embodiments 5-14 are preferable. Or, by employing the structure of FIG. 56, the likelihood can be avoided. As shown in FIG. 56, compression plate 20q is fixed to an end surface of the pump portion 21f adjacent the cylindrical portion 20k. Between the outer surface of the flange portion 21 and the compression plate 20q, a spring 20r functioning as a urging member is provided covering the pump portion 21f. With such a structure, the self restoration of the pump portion 21f at the time when the contact between the compression projection 20l and the pump position is released can be assisted, the suction operation can be carried out assuredly even when the expansion and contraction of the pump portion 21f is repeated for a long term.

In this example, two compressing projections 201 functioning as the drive converting mechanism are provided at the diametrically opposite positions, but this is not inevitable, and the number thereof may be one or three, for example. In addition, in place of one compressing projection, the following structure may be employed as the drive converting mechanism. For example, the configuration of the end surface opposing the pump portion 21f of the cylindrical portion 20k is not a perpendicular surface relative to the rotational axis of the cylindrical portion 20k as in this example, but is a surface inclined relative to the rotational axis. In this case, the inclined surface acts on the pump portion to be equivalent to the compressing projection. In another alternative, a shaft portion is extended from a rotation axis at the end surface of the cylindrical portion 20k opposed to the pump portion 21f toward the pump portion 21f in the rotational axis direction, and a swash plate (disk) inclined relative to the rotational axis of the shaft portion is provided. In this case, the swash plate acts on the pump portion 21f, and therefore, it is equivalent to the compressing projection.

### Embodiment 16

Referring to FIG. 57 (parts (a) and (b)), structures of the Embodiment 16 will be described. Parts (a) and (b) of FIG. 57 are sectional views schematically illustrating a developer supply container 1.

In this example, the pump portion 21f is provided at the cylindrical portion 20k, and the pump portion 21f rotates together with the cylindrical portion 20k. In addition, in this example, the pump portion 21f is provided with a weight 20v, by which the pump portion 21f reciprocates with the rotation. The other structures of this example are similar to those of Embodiment 14 (FIG. 53), and the detailed description thereof is omitted by assigning the same reference numerals to the corresponding elements.

As shown in part (a) of FIG. 57, the cylindrical portion 20k, the flange portion 21 and the pump portion 21f function as a developer accommodating space of the developer supply container 1. The pump portion 21f is connected to an outer periphery portion of the cylindrical portion 20k, and the action of the pump portion 21f works to the cylindrical portion 20k and the discharging portion 21h.

A drive converting mechanism of this example will be described.

One end surface of the cylindrical portion 20k with respect to the rotational axis direction is provided with coupling portion (rectangular configuration projection) 20a functioning as a drive inputting portion, and the coupling portion 20a receives a rotational force from the developer replenishing apparatus 8. On the top of one end of the pump portion 21f with respect to the reciprocation direction, the weight 20v is fixed. In this example, the weight 20v functions as the drive converting mechanism.

Thus, with the integral rotation of the cylindrical portion 20k and the pump 21f, the pump portion 21f expands and contract in the up and down directions by the gravitation to the weight 20v.

More particularly, in the state of part (a) of FIG. 57, the weight takes a position upper than the pump portion 21f, and the pump portion 21f is contracted by the weight 20v in the direction of the gravitation (white arrow). At this time, the developer is discharged through the discharge opening 21a (black arrow).

On the other hand, in the state of part of FIG. 57, weight takes a position lower than the pump portion 21f, and the pump portion 21f is expanded by the weight 20v in the direction of the gravitation (white arrow). At this time, the suction operation is effected through the discharge opening 21a (black arrow), by which the developer is loosened.

As described in the foregoing, also in this embodiment, one pump is enough to effect the suction operation and the discharging operation, and therefore, the structure of the developer discharging mechanism can be simplified. Furthermore, by the suction operation through the discharge opening, the decompressed state (negative pressure state) can be provided in the developer supply container, and therefore, the developer can be efficiently loosened.

Thus, in this example, similarly to Embodiments 5-15, the rotational force received from the developer replenishing apparatus 8, both of the rotating operation of developer supply container 1 and the reciprocation of the pump portion 21f can be effected.

In the case of this example, the pump portion 21f rotates about the cylindrical portion 20k, and therefore, the space of the mounting portion 8f of developer replenishing apparatus 8 is large, with the result of upsizing of the device, and from this standpoint, the structures of Embodiment 5-15 are preferable.

### Embodiment 17

Referring to FIGS. 58-60, the description will be made as to structures of Embodiment 17. Part (a) of FIG. 58 is a perspective view of a cylindrical portion 20k, and (b) is a perspective view of a flange portion 21. Parts (a) and (b) of FIG. 59 are partially sectional perspective views of a developer supply container 1, and (a) shows a state in which a rotatable shutter is open, and (b) shows a state in which the rotatable shutter is closed. FIG. 60 is a timing chart illustrating a relation between operation timing of the pump 21f and timing of opening and closing of the rotatable shutter. In FIG. 60, contraction is a discharging step of the pump portion 21f, expansion is a suction step of the pump portion 21f.

In this example, a mechanism for separating between a discharging chamber 21h and the cylindrical portion 20k during the expanding-and-contracting operation of the pump portion 21f is provided, as is contrasted to the foregoing embodiments. In this example, the separation is provided between the cylindrical portion 20k and the discharging portion 21h so that the pressure variation is produced selectively in the discharging portion 21h when the volume of the pump portion 21f of the cylindrical portion 20k and the discharging portion 21h changes. The inside of the discharging portion 21h functions as a developer accommodating portion for receiving the developer fed from the cylindrical portion 20k as will be described hereinafter. The structures of this example in the other respects are substantially the same as those of Embodiment 14 (FIG. 53), and the description thereof is omitted by assigning the same reference numerals to the corresponding elements.

As shown in part (a) of FIG. 58, one longitudinal end surface of the cylindrical portion 20k functions as a rotatable shutter. More particularly, said one longitudinal end surface of the cylindrical portion 20k is provided with a communication opening 20u for discharging the developer to the flange portion 21, and is provided with a closing portion 20h. The communication opening 20u has a sector-shape.

On the other hand, as shown in part (b) of FIG. 58, the flange portion 21 is provided with a communication opening 21k for receiving the developer from the cylindrical portion 20k. The communication opening 21k has a sector-shape configuration similar to the communication opening 20u, and the portion other than that is closed to provide a closing portion 21m.

Parts (a)-(b) of FIG. 59 illustrate a state in which the cylindrical portion 20k shown in part (a) of FIG. 58 and the flange portion 21 shown in part (b) of FIG. 58 have been assembled. The communication opening 20u and the outer surface of the communication opening 21k are connected with each other so as to compress the sealing member 27, and the cylindrical portion 20k is rotatable relative to the stationary flange portion 21.

With such a structure, when the cylindrical portion 20k is rotated relatively by the rotational force received by the gear portion 20a, the relation between the cylindrical portion 20k and the flange portion 21 are alternately switched between the communication state and the non-passage continuing state.

That is, rotation of the cylindrical portion 20k, the communication opening 20u of the cylindrical portion 20k becomes aligned with the communication opening 21k of the flange portion 21 (part (a) of FIG. 59). With a further rotation of the cylindrical portion 20k, the communication opening 20u of the cylindrical portion 20k becomes out of alignment with the communication opening 21k of the flange portion 21 so that the situation is switched to a non-communication state (part (b) of FIG. 59) in which the flange portion 21 is separated to substantially seal the flange portion 21.

Such a partitioning mechanism (rotatable shutter) for isolating the discharging portion 21h at least in the expanding-and-contracting operation of the pump portion 21f is provided for the following reasons.

The discharging of the developer from the developer supply container 1 is effected by making the internal pressure of the developer supply container 1 higher than the ambient pressure by contracting the pump portion 21f. Therefore, if the partitioning mechanism is not provided as in foregoing Embodiments 5-15, the space of which the internal pressure is changed is not limited to the inside space of the flange portion 21 but includes the inside space of the cylindrical portion 20k, and therefore, the amount of volume change of the pump portion 21f has to be made eager.

This is because a ratio of a volume of the inside space of the developer supply container 1 immediately after the pump portion 21f is contracted to its end to the volume of the inside space of the developer supply container 1 immediately before the pump portion 21f starts the contraction is influenced by the internal pressure.

However, when the partitioning mechanism is provided, there is no movement of the air from the flange portion 21 to the cylindrical portion 20k, and therefore, it is enough to change the pressure of the inside space of the flange portion 21. That is, under the condition of the same internal pressure value, the amount of the volume change of the pump portion 21f may be smaller when the original volume of the inside space is smaller.

In this example, more specifically, the volume of the discharging portion 21h separated by the rotatable shutter is 40 cm³, and the volume change of the pump portion 21f (reciprocation movement distance) is 2 cm³ (it is 15 cm³ in Embodiment 5). Even with such a small volume change, developer supply by a sufficient suction and discharging effect can be effected, similarly to Embodiment 5.

As described in the foregoing, in this example, as compared with the structures of Embodiments 5-16, the volume change amount of the pump portion 21f can be minimized. As a result, the pump portion 21f can be downsized. In addition, the distance through which the pump portion 21f is reciprocated (volume change amount) can be made smaller. The provision of such a partitioning mechanism is effective particularly in the case that the capacity of the cylindrical portion 20k is large in order to make the filled amount of the developer in the developer supply container 1 is large.

Developer supplying steps in this example will be described.

In the state that developer supply container 1 is mounted to the developer replenishing apparatus 8 and the flange portion 21 is fixed, drive is inputted to the gear portion 20a from the driving gear 300, by which the cylindrical portion 20k rotates, and the cam groove 20e rotates. On the other hand, the cam projection 21g fixed to the pump portion 21f non-rotatably supported by the developer replenishing apparatus 8 with the flange portion 21 is moved by the cam groove 20e. Therefore, with the rotation of the cylindrical portion 20k, the pump portion 21f reciprocates in the up and down directions.

Referring to FIG. 60, the description will be made as to the timing of the pumping operation (suction operation and discharging operation of the pump portion 21f and the timing of opening and closing of the rotatable shutter, in such a structure. FIG. 60 is a timing chart when the cylindrical portion 20k rotates one full turn. In FIG. 60, contraction means the contracting operation of the pump portion (discharging operation of the pump portion), expansion means the expanding operation of the pump portion (suction operation by the pump portion), and rest means non-operation of the pump portion. In addition, opening means the opening state of the rotatable shutter, and close means the closing state of the rotatable shutter.

As shown in FIG. 60, when the communication opening 21k and the communication opening 20u are aligned with each other, the drive converting mechanism converts the rotational force inputted to the gear portion 20a so that the pumping operation of the pump portion 21f stops. More specifically, in this example, the structure is such that when the communication opening 21k and the communication opening 20u are aligned with each other, a radius distance from the rotation axis of the cylindrical portion 20k to the cam groove 20e is constant so that the pump portion 21f does not operate even when the cylindrical portion 20k rotates.

At this time, the rotatable shutter is in the opening position, and therefore, the developer is fed from the cylindrical portion 20k to the flange portion 21. More particularly, with the rotation of the cylindrical portion 20k, the developer is scooped up by the partition wall 32, and thereafter, it slides down on the inclined projection 32a by the gravity, so that the developer moves via the communication opening 20u and the communication opening 21k to the flange 3.

As shown in FIG. 60, when the non-communication state in which the communication opening 21k and the communication opening 20u are out of alignment is established, the drive converting mechanism converts the rotational force inputted to the gear portion 20b so that the pumping operation of the pump portion 21f is effected.

That is, with further rotation of the cylindrical portion 20k, the rotational phase relation between the communication opening 21k and the communication opening 20u changes so that the communication opening 21k is closed by the stop portion 20h with the result that the inside space of the flange 3 is isolated (non-communication state).

At this time, with the rotation of the cylindrical portion 20k, the pump portion 21f is reciprocated in the state that the non-communication state is maintained the rotatable shutter is in the closing position). More particularly, by the rotation of the cylindrical portion 20k, the cam groove 20e rotates, and the radius distance from the rotation axis of the cylindrical portion 20k to the cam groove 20e changes. By this, the pump portion 21f effects the pumping operation through the cam function.

Thereafter, with further rotation of the cylindrical portion 20k, the rotational phases are aligned again between the communication opening 21k and the communication opening 20u, so that the communicated state is established in the flange portion 21.

The developer supplying step from the developer supply container 1 is carried out while repeating these operations.

As described in the foregoing, also in this embodiment, one pump is enough to effect the suction operation and the discharging operation, and therefore, the structure of the developer discharging mechanism can be simplified. Furthermore, by the suction operation through the discharge opening 21a, the decompressed state (negative pressure state) can be provided in the developer supply container, and therefore, the developer can be efficiently loosened.

In addition, also in this example, by the gear portion 20a receiving the rotational force from the developer replenishing apparatus 8, both of the rotating operation of the cylindrical portion 20k and the suction and discharging operation of the pump portion 21f can be effected.

Further, according to the structure of the this example, the pump portion 21f can be downsized. Furthermore, the volume change amount (reciprocation movement distance) can be reduced, and as a result, the load required to reciprocate the pump portion 21f can be reduced.

Moreover, in this example, no additional structure is used to receive the driving force for rotating the rotatable shutter from the developer replenishing apparatus 8, but the rotational force received for the feeding portion (cylindrical portion 20k, helical projection 20c) is used, and therefore, the partitioning mechanism is simplified.

As described above, the volume change amount of the pump portion 21f does not depend on the all volume of the developer supply container 1 including the cylindrical portion 20k, but it is selectable by the inside volume of the flange portion 21. Therefore, for example, in the case that the capacity (the diameter of the cylindrical portion 20k is changed when manufacturing developer supply containers having different developer filling capacity, a cost reduction effect can be expected. That is, the flange portion 21 including the pump portion 21f may be used as a common unit, which is assembled with different kinds of cylindrical portions 2k. By doing so, there is no need of increasing the number of kinds of the metal molds, thus reducing the manufacturing cost. In addition, in this example, during the non-communication state between the cylindrical portion 20k and the flange portion 21, the pump portion 21f is reciprocated by one cyclic period, but similarly to Embodiment 5, the pump portion 21f may be reciprocated by a plurality of cyclic periods.

Furthermore, in this example, throughout the contracting operation and the expanding operation of the pump portion, the discharging portion 21h is isolated, but this is not inevitable, and the following in an alternative. If the pump portion 21f can be downsized, and the volume change amount (reciprocation movement distance) of the pump portion 21f can be reduced, the discharging portion 21h may be opened slightly during the contracting operation and the expanding operation of the pump portion.

### Embodiment 18

Referring to FIGS. 61-63, the description will be made as to structures of Embodiment 18. FIG. 61 is a partly sectional perspective view of a developer supply container 1. Parts (a)-(c) of FIG. 62 are a partial section illustrating an operation of a partitioning mechanism (stop valve 35). FIG. 63 is a timing chart showing timing of a pumping operation (contracting operation and expanding operation) of the pump portion 20b and opening and closing timing of the stop valve which will be described hereinafter. In FIG. 63, contraction means contracting operation of the pump portion 20b the discharging operation of the pump portion 20b), expansion means the expanding operation of the pump portion 20b (suction operation of the pump portion 20b). In addition, stop means a rest state of the pump portion 20b. In addition, opening means an open state of the stop valve 35 and close means a state in which the stop valve 35 is closed.

This example is significantly different from the above-described embodiments in that the stop valve 35 is employed as a mechanism for separating between a discharging portion 21h and a cylindrical portion 20k in an expansion and contraction stroke of the pump portion 20b. The structures of this example in the other respects are substantially the same as those of Embodiment 12 (FIGS. 50 and 51), and the description thereof is omitted by assigning the same reference numerals to the corresponding elements. In this example, in the structure of the Embodiment 12 shown in FIG. 50, a plate-like partition wall 32 shown in FIG. 53 of Embodiment 14 is provided.

In the above-described Embodiment 17, a partitioning mechanism (rotatable shutter) using a rotation of the cylindrical portion 20k is employed, but in this example, a partitioning mechanism (stop valve) using reciprocation of the pump portion 20b is employed. The description will be made in detail.

As shown in FIG. 61, a discharging portion 21h is provided between the cylindrical portion 20k and the pump portion 20b. A wall portion 33 is provided at a cylindrical portion 20k side of the discharging portion 21h, and a discharge opening 21a is provided lower at a left part of the wall portion 33 in the Figure. A stop valve 35 and an elastic member (seal) 34 as a partitioning mechanism for opening and closing a communication port 33a (FIG. 62) formed in the wall portion 33 are provided. The stop valve 35 is fixed to one internal end of the pump portion 20b (opposite the discharging portion 21h), and reciprocates in a rotational axis direction of the developer supply container 1 with expanding-and-contracting operations of the pump portion 20b. The seal 34 is fixed to the stop valve 35, and moves with the movement of the stop valve 35.

Referring to parts (a)-(c) of the FIG. 62 (FIG. 63 if necessary), operations of the stop valve 35 in a developer supplying step will be described.

FIG. 62 illustrates in (a) a maximum expanded state of the pump portion 20b in which the stop valve 35 is spaced from the wall portion 33 provided between the discharging portion 21h and the cylindrical portion 20k. At this time, the developer in the cylindrical portion 20k is fed into the discharging portion 21h through the communication port 33a by the inclined projection 32a with the rotation of the cylindrical portion 20k.

Thereafter, when the pump portion 20b contracts, the state becomes as shown in (b) of the FIG. 62. At this time, the seal 34 is contacted to the wall portion 33 to close the communication port 33a. That is, the discharging portion 21h becomes isolated from the cylindrical portion 20k.

When the pump portion 20b contracts further, the pump portion 20b becomes most contracted as shown in part (c) of FIG. 62.

During period from the state shown in part (b) of FIG. 62 to the state shown in part (c) of FIG. 62, the seal 34 remains contacting to the wall portion 33, and therefore, the discharging portion 21h is pressurized to be higher than the ambient pressure (positive pressure) so that the developer is discharged through the discharge opening 21a.

Thereafter, during expanding operation of the pump portion 20b from the state shown in (c) of FIG. 62 to the state shown in (b) of FIG. 62, the seal 34 remains contacting to the wall portion 33, and therefore, the internal pressure of the discharging portion 21h is reduced to be lower than the ambient pressure (negative pressure). Thus, the suction operation is effected through the discharge opening 21a.

When the pump portion 20b further expands, it returns to the state shown in part (a) of FIG. 62. In this example, the foregoing operations are repeated to carry out the developer supplying step. In this manner, in this example, the stop valve 35 is moved using the reciprocation of the pump portion, and therefore, the stop valve is opening during an initial stage of the contracting operation (discharging operation) of the pump portion 20b and in the final stage of the expanding operation (suction operation) thereof.

The seal 34 will be described in detail. The seal 34 is contacted to the wall portion 33 to assure the sealing property of the discharging portion 21h, and is compressed with the contracting operation of the pump portion 20b, and therefore, it is preferable to have both of sealing property and flexibility. In this example, as a sealing material having such properties, the use is made with polyurethane foam the available from Kabushiki Kaisha INOAC Corporation, Japan (tradename is MOLTOPREN, SM-55 having a thickness of 5 mm). The thickness of the sealing material in the maximum contraction state of the pump portion 20b is 2 mm the compression amount of 3 mm).

As described in the foregoing, the volume variation (pump function) for the discharging portion 21h by the pump portion 20b is substantially limited to the duration after the seal 34 is contacted to the wall portion 33 until it is compressed to 3 mm, but the pump portion 20b works in the range limited by the stop valve 35. Therefore, even when such a stop valve 35 is used, the developer can be stably discharged.

As described in the foregoing, also in this embodiment, one pump is enough to effect the suction operation and the discharging operation, and therefore, the structure of the developer discharging mechanism can be simplified. Furthermore, by the suction operation through the discharge opening 21a, the decompressed state (negative pressure state) can be provided in the developer supply container, and therefore, the developer can be efficiently loosened.

In this manner, in this example, similarly to Embodiments 5-17, by the gear portion 20a receiving the rotational force from the developer replenishing apparatus 8, both of the rotating operation of the cylindrical portion 20k and the suction and discharging operation of the pump portion 20b can be effected.

Furthermore, similarly to Embodiment 17, the pump portion 20b can be downsized, and the volume change volume of the pump portion 20b can be reduced. The cost reduction advantage by the common structure of the pump portion can be expected.

In addition, in this embodiment, no additional structure is used to receive the driving force for operating the stop valve 35 from the developer replenishing apparatus 8 is used, but the use is made with the reciprocation force of the pump portion 20b, and therefore, the partitioning mechanism can be simplified.

### Embodiment 19

Referring to parts (a)-(c) of FIG. 64, the structures of Embodiment 19 will be described. Part (a) of FIG. 64 is a partially sectional perspective view of the developer supply container 1, and (b) is a perspective view of the flange portion 21, and (c) is a sectional view of the developer supply container.

This example is significantly different from the foregoing embodiments in that a buffer portion 23 is provided as a mechanism separating between discharging chamber 21h and the cylindrical portion 20k. In the other respects, the structures are substantially the same as those of Embodiment 14 (FIG. 53), and therefore, the detailed description is omitted by assigning the same reference numerals to the corresponding elements.

As shown in part (b) of FIG. 64, a buffer portion 23 is fixed to the flange portion 21 non-rotatably. The buffer portion 23 is provided with a receiving port 23a which opens upward and a supply port 23b which is in fluid communication with a discharging portion 21h.

As shown in part (a) and (c) of FIG. 64, such a flange portion 21 is mounted to the cylindrical portion 20k such that the buffer portion 23 is in the cylindrical portion 20k. The cylindrical portion 20k is connected to the flange portion 21 rotatably relative to the flange portion 21 immovably supported by the developer replenishing apparatus 8. The connecting portion is provided with a ring seal to prevent leakage of air or developer.

In addition, in this example, as shown in part (a) of FIG. 64, an inclined projection 32a is provided on the partition wall 32 to feed the developer toward the receiving port 23a of the buffer portion 23.

In this example, until the developer supplying operation of the developer supply container 1 is completed, the developer in the developer accommodating portion 20 is fed through the opening 23a into the buffer portion 23 by the partition wall 32 and the inclined projection 32a with the rotation of the developer supply container 1

Therefore, as shown in part (c) of FIG. 64, the inside space of the buffer portion 23 is maintained full of the developer.

As a result, the developer filling the inside space of the buffer portion 23 substantially blocks the movement of the air toward the discharging portion 21h from the cylindrical portion 20k, so that the buffer portion 23 functions as a partitioning mechanism.

Therefore, when the pump portion 21f reciprocates, at least the discharging portion 21h can be isolated from the cylindrical portion 20k, and for this reason, the pump portion can be downsized, and the volume change of the pump portion can be reduced.

As described in the foregoing, also in this embodiment, one pump is enough to effect the suction operation and the discharging operation, and therefore, the structure of the developer discharging mechanism can be simplified. Furthermore, by the suction operation through the discharge opening 21a, the decompressed state (negative pressure state) can be provided in the developer supply container, and therefore, the developer can be efficiently loosened.

In this manner, in this example, similarly to Embodiments 17-18, by the rotational force received from the developer replenishing apparatus 8, both of the rotating operation of the feeding portion 20c (cylindrical portion 20k) and the reciprocation of the pump portion 21f can be effected.

Furthermore, similarly to Embodiments 17-18, the pump portion can be downsized, and the volume change amount of the pump portion can be reduced. Also, the pump portion can be made common, by which the cost reduction advantage is provided.

Moreover, in this example, the developer is used as the partitioning mechanism, and therefore, the partitioning mechanism can be simplified.

### Embodiment 20

Referring to FIGS. 65-66, the structures of Embodiment 20 will be described. Part (a) of FIG. 65 is a perspective view of a developer supply container 1, and (b) is a sectional view of the developer supply container 1, and FIG. 66 is a sectional perspective view of a nozzle portion 47.

In this example, the nozzle portion 47 is connected to the pump portion 20b, and the developer once sucked in the nozzle portion 47 is discharged through the discharge opening 21a, as is contrasted to the foregoing embodiments. In the other respects, the structures are substantially the same as in Embodiment 14, and the detailed description thereof is omitted by assigning the same reference numerals to the corresponding elements.

As shown in part (a) of FIG. 65, the developer supply container 1 comprises a flange portion 21 and a developer accommodating portion 20. The developer accommodating portion 20 comprises a cylindrical portion 20k.

In the cylindrical portion 20k, as shown in (b) of FIG. 65, a partition wall 32 functioning as a feeding portion extends over the entire area in the rotational axis direction. One end surface of the partition wall 32 is provided with a plurality of inclined projections 32a at different positions in the rotational axis direction, and the developer is fed from one end with respect to the rotational axis direction to the other end (the side adjacent the flange portion 21). The inclined projections 32a are provided on the other end surface of the partition wall 32 similarly. In addition, between the adjacent inclined projections 32a, a through-opening 32b for permitting passing of the developer is provided. The through-opening 32b functions to stir the developer. The structure of the feeding portion may be a combination of the helical projection 20c in the cylindrical portion 20k and a partition wall 32 for feeding the developer to the flange portion 21, as in the foregoing embodiments.

The flange portion 21 including the pump portion 20b will be described.

The flange portion 21 is connected to the cylindrical portion 20k rotatably through a small diameter portion 49 and a sealing member 48. In the state that the container is mounted to the developer replenishing apparatus 8, the flange portion 21 is immovably held by the developer replenishing apparatus 8 (rotating operation and reciprocation is not permitted).

In addition, as shown in FIG. 66, in the flange portion 21, there is provided a supply amount adjusting portion (flow rate adjusting portion) 52 which receives the developer fed from the cylindrical portion 20k. In the supply amount adjusting portion 52, there is provided a nozzle portion 47 which extends from the pump portion 20b toward the discharge opening 21a. Therefore, with the volume change of the pump 20b, the nozzle portion 47 sucks the developer in the supply amount adjusting portion 52, and discharges it through discharge opening 21a.

The structure for drive transmission to the pump portion 20b in this example will be described.

As described in the foregoing, the cylindrical portion 20k rotates when the gear portion 20a provided on the cylindrical portion 20k receives the rotation force from the driving gear 300. In addition, the rotation force is transmitted to the gear portion 43 through the gear portion 42 provided on the small diameter portion 49 of the cylindrical portion 20k. Here, the gear portion 43 is provided with a shaft portion 44 integrally rotatable with the gear portion 43.

One end of shaft portion 44 is rotatably supported by the housing 46. The shaft 44 is provided with an eccentric cam 45 at a position opposing the pump portion 20b, and the eccentric cam 45 is rotated along a track with a changing distance from the rotation axis of the shaft 44 by the rotational force transmitted thereto, so that the pump portion 20b is pushed down (reduced in the volume). By this, the developer in the nozzle portion 47 is discharged through the discharge opening 21a.

When the pump portion 20b is released from the eccentric cam 45, it restores to the original position by its restoring force (the volume expands). By the restoration of the pump portion (increase of the volume), suction operation is effected through the discharge opening 21a, and the developer existing in the neighborhood of the discharge opening 21a can be loosened.

By repeating the operations, the developer is efficiently discharged by the volume change of the pump portion 20b. As described in the foregoing, the pump portion 20b may be provided with an urging member such as a spring to assist the restoration (or pushing down).

The hollow conical nozzle portion 47 will be described. The nozzle portion 47 is provided with an opening 53 in a outer periphery thereof, and the nozzle portion 47 is provided at its free end with an ejection outlet 54 for ejecting the developer toward the discharge opening 21a.

In the developer supplying step, at least the opening 53 of the nozzle portion 47 can be in the developer layer in the supply amount adjusting portion 52, by which the pressure produced by the pump portion 20b can be efficiently applied to the developer in the supply amount adjusting portion 52.

That is, the developer in the supply amount adjusting portion 52 (around the nozzle 47) functions as a partitioning mechanism relative to the cylindrical portion 20k, so that the effect of the volume change of the pump 20b is applied to the limited range, that is, within the supply amount adjusting portion 52.

With such structures, similarly to the partitioning mechanisms of Embodiments 17-19, the nozzle portion 47 can provide similar effects.

As described in the foregoing, also in this embodiment, one pump is enough to effect the suction operation and the discharging operation, and therefore, the structure of the developer discharging mechanism can be simplified. Furthermore, by the suction operation through the discharge opening 21a, the decompressed state (negative pressure state) can be provided in the developer supply container, and therefore, the developer can be efficiently loosened.

In addition, in this example, similarly to Embodiments 5-19, by the rotational force received from the developer replenishing apparatus 8, both of the rotating operations of the developer accommodating portion 20 (cylindrical portion 20k) and the reciprocation of the pump portion 20b are effected. Similarly to Embodiments 17-19, the pump portion 20b and/or flange portion 21 may be made common to the advantages.

According to this example, the developer and the partitioning mechanism are not in sliding relation as in Embodiments 17-18, and therefore, the damage to the developer can be suppressed.

### Comparison Example

Referring to FIG. 67, a comparison example will be described. Part (a) of FIG. 67 is a sectional view illustrating a state in which the air is fed into a developer supply container 150, part (b) of FIG. 67 is a sectional view illustrating a state in which the air (developer) is discharged from the developer supply container 150. Part (c) of FIG. 67 is a sectional view illustrating a state in which the developer is fed into a hopper 8g from a containing portion 123, and part (d) of FIG. 67 is a sectional view illustrating a state in which the air is taken into the containing portion 123 from the hopper 8g. In the comparison example, the same reference numerals as in the foregoing embodiments are assigned to the elements having the similar functions in this example, and the detailed description thereof is omitted for simplicity.

In this comparison example, a pump for suction and discharging, more particularly a displacement type pump 122 is provided on the developer replenishing apparatus 180 side.

The developer supply container 150 of this comparison example is not provided with the pump 2 and the locking portion 3 of the developer supply container 1 shown in FIG. 9 of Embodiment 1, and in place thereof, the upper surface of the container body 1a which is the connecting portion with the pump 2 is closed. In other words, the developer supply container 150 includes the container body 1a, the discharge opening 1c, the flange portion 1g, the sealing member 4 and the shutter 5 (omitted in FIG. 67). the developer replenishing apparatus 180 of this comparison example is not provided with locking member 9 and the mechanism for driving the locking member 9 of the developer replenishing apparatus 8 shown in FIGS. 3, 5 of Embodiment 1, and in place thereof, a pump, a containing portion, a valve mechanism and so on which will be described hereinafter are added.

More particularly, the developer replenishing apparatus 180 is provided with a bellow-like pump 122 of a displacement type for suction and discharging, and a containing portion 123 provided between the developer supply container 150 and the hopper 8g to temporarily accumulate the developer discharged from the developer supply container 150.

To the containing portion 123, a supply pipe portion 126 for connection with the developer supply container 150 and a supply pipe portion 127 for connection with the hopper 8g are connected. For the pump 122, reciprocation (expanding-and-contracting operation) is effected by a pump driving mechanism provided on the developer replenishing apparatus 180.

The developer replenishing apparatus 180 is includes a valve 125 provided in a connecting portion between the containing portion 123 and the developer supply container 150 side supply pipe portion 126, and a valve 124 provided in a connecting portion between the containing portion 123 and the hopper 8g side supply pipe portion 127. These valves 124, 125 are opened and closed by solenoid valves as valve driving mechanisms provided in the developer replenishing apparatus 180.

Developer discharging steps in the structure of the comparison example including the pump 122 in the developer replenishing apparatus 180 side will be described.

As shown in part (a) of FIG. 67, the valve driving mechanisms are actuated to close the valve 124 and open the valve 125. In this state, the pump 122 is contracted by the pump driving mechanism. At this time, the contracting operation of the pump 122 increases an internal pressure of the containing portion 123, so that the air is fed into the developer supply container 150 from the containing portion 123. As a result, the developer adjacent to the discharge opening 1c in the developer supply container 150 is loosened.

While keeping the state in which the valve 124 is closed, and the valve 125 is opened as shown in part (b) of FIG. 67, the pump 122 is expanded by the pump driving mechanism. At this time, by the expanding operation of the pump 122, the internal pressure of the containing portion 123 decreases, and the pressure of the air layer in the developer supply container 150 increases relatively. By the pressure difference between the containing portion 123 and the developer supply container 150, the air in the developer supply container 150 is discharged into the containing portion 123. By this, the developer is discharged with the air through the discharge opening 1c of the developer supply container 150, and is temporarily accumulated in the containing portion 123.

As shown in part (c) of FIG. 67, the valve driving mechanisms are operated to open the valve 124 and to close the valve 125. In this state, the pump 122 is contracted by the pump driving mechanism. At the, by the contracting operation of the pump 122, the internal pressure of the containing portion 123 increases, and the developer in the containing portion 123 is fed into the hopper 8g.

Then, while keeping the state in which the valve 124 is opened, and the valve 125 is closed, as shown in part (d) of FIG. 67, the pump 122 is expanded by the pump driving mechanism. At this time, by the expanding operation of the pump 122, the internal pressure of the containing portion 123 decreases, and the air is taken into the containing portion 123 from the hopper 8g.

By repeating the steps of parts (a)-(d) of FIG. 67 described above, the developer can be discharged through the discharge opening 1c of the developer supply container 150 while fluidizing the developer in the developer supply container 150. However, with the structure of the comparison example, the valves 124, 125 and the valve driving mechanisms for controlling opening and closing of the valves, as shown in parts (a)-(d) of FIG. 67 are required. Thus, the control for the opening and closing of the valve is complicated in the structure of the comparison example. In addition, there is a high possibility that the developer may be bitten between the valve and the seat to which the valve abuts, with the result of a stress to the developer and therefore agglomerated mass. In such a state, the opening and closing operation of the valves cannot be properly performed, and as a result, no stable discharging of the developer for a long term cannot be expected.

In addition, in the comparison example, the internal pressure of the developer supply container 150 becomes positive by the air supply from the outside of the developer supply container 150 with the result of agglomeration of the developer, and therefore, the developer loosening effect is very slight as demonstrated in the above-described verification experiment (comparison between FIG. 20 and FIG. 21). Thus, the foregoing Embodiments 1-20 of the present invention is preferable since the developer can be sufficiently loosened and discharged from the developer supply container.

As shown in FIG. 68, it would be considered that the suction and discharging is effected by forward and backward rotations of a rotor 401 of a single shaft eccentric pump 400 used in place of the pump 122. However, in such a case, the developer discharged from the developer supply container 150 is subjected to a stress due to the rubbing between the rotor 401 and the stator 402, with the result of production of an agglomeration mass, which may adversely affect the image quality.

As described in the foregoing, the structure of the embodiments of the present invention in which the pump for the suction and discharging is provided in the developer supply container 1 is advantageous in that the developer discharging mechanism is simplified using the air than in the comparison example. In the structures of the foregoing embodiments of the present invention, the stress applied to the developer is smaller than in the comparison example of FIG. 68.

### INDUSTRIAL APPLICABILITY

According to the first and second inventions, the developer in the developer supply container C2 loosened by making the internal pressure of the developer supply container a negative pressure by the pump portion.

According to the third and fourth inventions, the developer in the developer supply container can be properly loosened by a suction operation through the discharge opening of the developer supply container by the pump portion.

According to the fifth and sixth inventions, the developer in the developer supply container can be properly loosened by producing inward and outward flows through the pin hole by the air flow producing mechanism.

1. A developer supply container detachably mountable to a developer replenishing apparatus, said developer supply container comprising:
a developer accommodating portion for accommodating a developer;
a discharge opening for permitting discharging of the developer from said developer accommodating portion;
a drive inputting portion for receiving a driving force from said the developer replenishing apparatus; and
a pump portion capable of being driven by the driving force received by said drive inputting portion to alternately change an internal pressure of said developer accommodating portion between a pressure lower than an ambient pressure and a pressure higher than the ambient pressure.

2. A developer supply container according to claim 1, wherein the developer in said developer supply container has a fluidity energy of not less than 4.3×10⁻⁴ kg·cm²/s² and not more than 4.14×10⁻³ kg·cm²/s², and
wherein said discharge opening has an area not more than 12.6 mm².

3. A developer supply container according to claim 1, wherein said pump portion includes a displacement type pump having a volume changing with reciprocation.

4. A developer supply container according to claim 3, wherein with increase of a volume of a chamber of said pump, the pressure in the developer accommodating portion becomes lower than the ambient pressure to substantially clog said discharge opening with the developer.

5. A developer supply container according to claim 1, wherein said pump portion includes a flexible bellow-like pump.

6. A developer supply container according to claim 3, wherein said drive inputting portion is capable of receiving a rotational force, and
wherein said developer supply container further comprises:
a feeding portion for feeding the developer accommodated in said developer accommodating portion toward said discharge opening by a rotational force received by said drive inputting portion, and
a drive converting portion for converting the rotational force received by said drive inputting portion to a force for operating said pump portion.

7. A developer supplying system comprising:
a developer replenishing apparatus; and
a developer supply container detachably mountable to said developer replenishing apparatus,
wherein said developer replenishing apparatus includes:
a mounting portion for demountably mounting said developer supply container,
a developer receiving portion for receiving the developer from said developer supply container, and
a driver for applying a driving force to said developer supply container, and
wherein said developer supply container includes:
a developer accommodating portion accommodating developer,
a discharge opening for permitting discharging of the developer from said developer accommodating portion toward said developer receiving portion,
a drive inputting portion, engageable with said driver, for receiving the driving force, and
a pump portion for alternately changing an internal pressure of said developer accommodating portion between a pressure higher than an ambient pressure and a pressure lower than the ambient pressure.

8. A system according to claim 7, wherein the developer in said developer supply container has a fluidity energy of not less than 4.3×10⁻⁴ kg·cm²/s² and not more than 4.14×10⁻³ kg·cm²/s², and
wherein said discharge opening has an area not more than 12.6 mm².

9. A system according to claim 7, wherein said pump portion includes a displacement type pump having a volume changing with reciprocation.

10. A system according to claim 9, wherein with increase of a volume of a chamber of said pump, the pressure in the developer accommodating portion becomes lower than the ambient pressure to substantially clog said discharge opening with the developer.

11. A system according to claim 7, wherein said pump portion includes a flexible bellow-like pump.

12. A system according to claim 9, wherein said driver applies a rotational force to said drive inputting portion, and
wherein said developer supply container includes:
a feeding portion for feeding the developer accommodated in said developer accommodating portion toward said discharge opening by a rotational force received by said drive inputting portion, and
a drive converting portion for converting the rotational force received by said drive inputting portion to a force for reciprocating said pump portion.

13. A developer supply container detachably mountable to a developer replenishing apparatus, said developer supply container comprising:
a developer accommodating portion for accommodating a developer;
a discharge opening for permitting discharging of the developer from said developer accommodating portion;
a drive inputting portion for receiving a driving force from said the developer replenishing apparatus; and
a pump portion capable of being driven by the driving force received by said drive inputting portion to alternately repeat suction and delivery actions through said discharge opening.

14. A developer supply container according to claim 13, wherein the developer in said developer supply container has a fluidity energy of not less than 4.3×10⁻⁴ kg·cm²/s² and not more than 4.14×10⁻³ kg·cm²/s², and
wherein said discharge opening has an area not more than 12.6 mm².

15. A developer supply container according to claim 13, wherein said pump portion includes a displacement type pump having a volume changing with reciprocation.

16. A developer supply container according to claim 15, wherein with increase of a volume of a chamber of said pump, the pressure in the developer accommodating portion becomes lower than an ambient pressure to substantially clog said discharge opening with the developer.

17. A developer supply container according to claim 13, wherein said pump portion includes a flexible bellow-like pump.

18. A developer supply container according to claim 15, wherein said drive inputting portion is capable of receiving a rotational force, and
wherein said developer supply container further comprises:
a feeding portion for feeding the developer accommodated in said developer accommodating portion toward said discharge opening by the rotational force received by said drive inputting portion, and
a drive converting portion for converting the received force by said drive inputting portion to a force for operating said pump portion.

19. A developer supplying system comprising:
a developer replenishing apparatus; and
a developer supply container detachably mountable to said developer replenishing apparatus,
wherein said developer replenishing apparatus includes:
a mounting portion for demountably mounting said developer supply container,
a developer receiving portion for receiving a developer from said developer supply container, and
a driver for applying a driving force to said developer supply container, and
wherein said developer supply container includes:
a developer accommodating portion for accommodating the developer,
a discharge opening for permitting discharging of the developer from said developer accommodating portion toward said developer receiving portion,
a drive inputting portion for receiving the driving force, and
a pump portion for alternately repeating suction and delivery actions through said discharge opening.

20. A system according to claim 19, wherein the developer in said developer supply container has a fluidity energy of not less than 4.3×10⁻⁴ kg·cm²/s² and not more than 4.14×10⁻³ kg·cm²/s², and
wherein said discharge opening has an area not more than 12.6 mm².

21. A system according to claim 19, wherein said pump portion includes a displacement type pump having a volume changing with reciprocation.

22. A system according to claim 21, wherein with increase of a volume of a chamber of said pump, the pressure in the developer accommodating portion becomes lower than an ambient pressure to substantially clog said discharge opening with the developer.

23. A system according to claim 19, wherein said pump portion includes a flexible bellow-like pump.

24. A system according to claim 21, wherein said driver applies a rotational force to said drive inputting portion, and
wherein said developer supply container includes:
a feeding portion for feeding the developer accommodated in said developer accommodating portion toward said discharge opening by a rotational force received by said drive inputting portion, and
a drive converting portion for converting the rotational force received by said drive inputting portion to a force for reciprocating said pump portion.

25. A developer supply container detachably mountable to a developer replenishing apparatus, said developer supply container comprising:
a developer accommodating portion for accommodating a developer having a fluidity energy of not less than 4.3×10⁻⁴ kg·cm²/s² and not more than 4.14×10⁻³ kg·cm²/s²;
a pin hole for permitting discharge of the developer out of said developer accommodating portion, said pin hole having an area not more than 12.6 mm²;
a drive inputting portion for receiving a driving force from the developer replenishing apparatus; and
an air flow generating mechanism for generating repeated and alternating inward and outward air flow through said pin hole.

26. A developer supplying system comprising:
a developer replenishing apparatus; and
a developer supply container detachably mountable to said developer replenishing apparatus,
wherein said developer replenishing apparatus includes:
a mounting portion for demountably mounting said developer supply container,
a developer receiving portion for receiving a developer from said developer supply container, and
a driver for applying a driving force to said developer supply container, and
wherein said developer supply container includes:
a developer accommodating portion for accommodating the developer having a fluidity energy of not less than 4.3×10⁻⁴ kg·cm²/s² and not more than 4.14×10⁻³ kg·cm²/s²;
a pin hole for permitting discharge of the developer out of said developer accommodating portion, said pin hole having an area not more than 12.6 mm²;
a drive inputting portion for receiving the driving force; and
an air flow generating mechanism for generating repeated and alternating inward and outward air flow through said pin hole.
